(19) United States
(12) Patent Application Publication
(10) Pub. No.: US 2012/0207321 A1
(43) Pub. Date: Aug. 16, 2012

(54) SPEAKER DEVICE

(75) Inventors: Kenichi Oshima, Tendo-shi (JP); Shinichi Hayasaka, Tendo-shi (JP); Yoji Ogata, Tendo-shi (JP); Kodai Nagasawa, Tendo-shi (JP); Minoru Horigome, Tendo-shi (JP); Hiroyuki Kobayashi, Tendo-shi (JP); Shunichi Takahashi, Tendo-shi (JP); Yasuhisa Abe, Tendo-shi (JP); Yasuhiro Saso, Tendo-shi (JP); Toshihiro Hikichi, Tendo-shi (JP); Takuei Nagasawa, Tendo-shi (JP); Tempei Katsuta, Tendo-shi (JP)

(73) Assignees: TOHOKU PIONEER CORPORATION, Yamagata-Ken (JP); PIONEER CORPORATION, Kawasaki-shi, Kanagawa (JP)

(21) Appl. No.: 13/502,253

(22) PCT Filed: Oct. 1, 2010
(86) PCT No.: PCT/JP2010/067290

§ 371 Date: Apr. 16, 2012

(30) Foreign Application Priority Data
Oct. 15, 2009 (JP) 2009-238688

(51) Int. Cl. H04R 1/02; H04R 1/00

(52) U.S. Cl. 381/86; 381/186; 381/182

(57) ABSTRACT

A speaker device includes a static part, a driving part and a vibrating body. The vibrating body includes a plurality of diaphragms supported by the static part. A vibration direction converter part is provided between a first diaphragm and a second diaphragm facing each other in a plurality of the diaphragms, and connects the first diaphragm with the second diaphragm such that the first diaphragm and the second diaphragm synchronously move toward and away from each other. A part of the vibration direction converter part disposed in the proximity of the static part is supported by the static part, and a part of the vibration direction converter part disposed in the proximity of the driving part is supported by the driving part.

### FIELD OF THE INVENTION

The present invention relates to a speaker device.

### BACKGROUND OF THE INVENTION

A dynamic speaker device is known as a typical speaker device (for example, see patent literature 1). The dynamic speaker device, for example, as shown in FIG. 1, includes a frame 3J, a cone-shaped diaphragm 21J, an edge 4J through which the diaphragm 21J is supported by the frame 3J, a voice coil bobbin 610J applied to the inner periphery part of the diaphragm 21J, a damper 7J through which the voice coil bobbin 610J is supported by the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by a Lorentz force developed in the voice coil 611J in the magnetic gap and the diaphragm 21J is driven by the vibration.
[Patent literature 1] Publication of unexamined patent application H8-149596 (FIG. 1)

The typical dynamic type speaker device as described above is configured such that the voice coil 611J is disposed opposite to the sound emission side of the diaphragm 21J and the vibration directions of the voice coil 611J and the voice coil bobbin 610J are the same as the vibration direction of the diaphragm 21J, for example, as shown in FIG. 1. In the speaker device as configured above, a region for vibration of the diaphragm 21J, a region for vibration of the voice coil bobbin 610J, and a region for arranging the magnetic circuit, etc. are necessarily formed in the vibration direction (sound emission direction) of the diaphragm 21J. Accordingly, the total height of the speaker device necessarily becomes comparatively large.

Specifically, as shown in FIG. 1, the dimension of the above-mentioned speaker device in the vibration direction of the diaphragm 21J includes (a) the total height of the cone-shaped diaphragm 21J in the vibration direction and the edge 4J through which the diaphragm 21J is supported by the frame 3J, (b) the height of the voice coil bobbin from the connecting part of the diaphragm 21J and the voice coil bobbin 610J to the upper end of the voice coil 611J, (c) the total height of the voice coil, (d) the height mainly of the magnet of the magnetic circuit, corresponding to the height from the lower end of the voice coil 611J to the upper end of the yoke 51J, (e) the thickness mainly of the yoke 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to secure a sufficient electromagnetic force. Accordingly, particularly in a speaker device adapted to a large sound volume, the total height of the speaker device inevitably becomes large.

Since the vibration direction of the voice coil bobbin 610J is the same as that of the diaphragm 21J in the conventional speaker device as described above, the total height of the speaker device inevitably becomes large to secure a vibration stroke of the voice coil bobbin 610J, when seeking a large volume sound with large amplitude of vibration of the diaphragm 21J. Thus, it becomes difficult to make a thin device. In other words, the problem is that making a thin device and securing a loud sound are contradictory to each other.

Further, in the conventional speaker device, when a speaker unit is arranged in the cabinet, it is required to provide a large depth of the cabinet on the rear side of the speaker unit corresponding to total height of the speaker unit, when securing a sufficient space volume on the rear side of the speaker unit. As such, the speaker device as a whole including the cabinet becomes large, and thereby there is a problem of limiting installation space for the speaker device. In particular, the installation space for the speaker device is limited specifically in an in-car speaker, etc., and thereby there is a problem that the speaker unit may not be arranged in the cabinet having a sufficient volume.

It is an object of one or more embodiments of the present invention to overcome the problem described above. That is, an object of one or more embodiments of the present invention is to provide a thin speaker device capable of emitting a reproduced sound at large volume, a thin speaker device capable of efficiently transmitting the vibration of the voice coil to the diaphragm by direction-converting a vibration produced by the voice coil, enabling the whole speaker device including the cabinet to be thin, while providing preferable acoustic performance of the speaker unit by securing a sufficient volume in the cabinet, etc.

### SUMMARY OF THE INVENTION

A speaker device according to one or more embodiments of the present invention has at least a configuration according to the following independent claims.

In one aspect, a speaker device includes a static part, a driving part and a vibrating body, wherein said vibrating body includes a plurality of diaphragms supported by said static part, and a vibration direction converter part wherein, said vibration direction converter part is provided between a first diaphragm and a second diaphragm facing each other in the plurality of said diaphragms, and connects said first diaphragm with said second diaphragm such that said first diaphragm and said second diaphragm synchronously move toward and away from each other, a part of said vibration direction converter part disposed in the proximity of said static part is supported by said static part, and a part of said vibration direction converter part disposed in the proximity of said driving part is supported by said driving part.

In another aspect, a speaker device includes a plurality of speaker units, a cabinet mounting said speaker unit, and a space surrounded by said cabinet and said speaker unit, wherein said speaker unit includes a diaphragm, a static part supporting said diaphragm, and a driving part, and said driving part includes: a magnetic circuit having a magnetic gap, and a voice coil vibrating in the direction different from a vibration direction of said diaphragm and a vibration direction convert part, wherein said vibration direction converter part is connected to said voice coil and said diaphragm directly or via other member, sound emission faces of said plurality of speaker units face different directions from each other, and said sound emission faces of said speaker units face the outside.

### BRIEF DESCRIPTION OF THE DRAWINGS

FIG. 1 is a view illustrating a speaker device of a prior art;

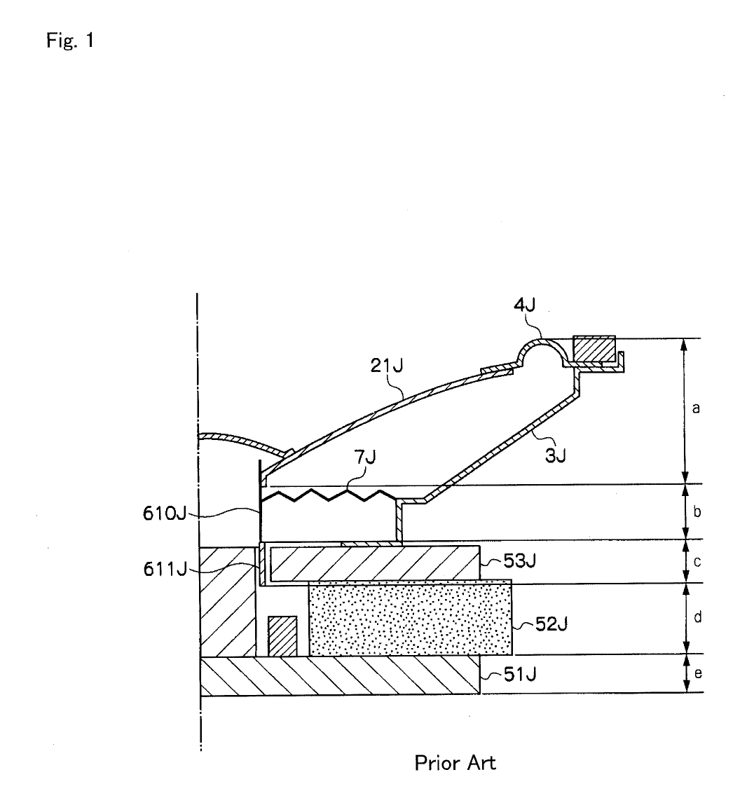

FIG. 2 is a view illustrating a basic configuration of the speaker device according to an embodiment of the present invention (FIG. 2(a) is a cross-sectional view taken along X-axis direction and FIG. 2(b) is a view illustrating an operation of the driving part);

FIGS. 3(a)-(c) are views illustrating a configuration example and an operation of a vibration direction converter part;

FIGS. 4(a)-(c) are views illustrating a configuration example and an operation of the vibration direction converter part;

FIG. 5 is a view illustrating a formation example of the vibration direction converter part (FIG. 5(a) is a side view, FIG. 5(b) is a perspective view and FIG. 5(c) is an enlarged view of part A);

FIGS. 6(a)-(c) are views illustrating a formation example of the vibration direction converter part;

FIG. 7 is a view illustrating a speaker device adopting the vibration direction converter part (FIG. 7(a) is a cross-sectional view taken along X-axis direction and FIG. 7(b) is a view illustrating an operation of the driving part);

FIG. 8 is a view illustrating a speaker device adopting the vibration direction converter part (FIG. 8(a) is a cross-sectional view taken along X-axis direction and FIG. 8(b) is a view illustrating an operation of the driving part);

FIGS. 9(a) and (b) are views illustrating a specific vibration direction converter part;

FIGS. 10(a) and (b) are views illustrating a specific vibration direction converter part;

FIGS. 11(a) and (b) are views illustrating another example of the vibration direction converter part;

FIG. 12 is a view illustrating another example of the vibration direction converter part;

FIGS. 13(a)-(c) are views illustrating another example of the vibration direction converter part;

FIGS. 14(a) and (b) are views illustrating another example of the vibration direction converter part;

FIGS. 15(a) and (b) are views illustrating a power feed structure of the speaker unit according to an embodiment of the present invention;

FIG. 16 is a view illustrating a power feed structure of the speaker unit according to an embodiment of the present invention;

FIG. 17 is a view illustrating a power feed structure of the speaker unit according to an embodiment of the present invention;

FIG. 18 is a view illustrating a power feed structure of the speaker unit according to an embodiment of the present invention;

FIG. 19 is a view illustrating a power feed structure of the speaker unit according to an embodiment of the present invention;

FIG. 20 is a view illustrating a power feed structure of the speaker unit according to an embodiment of the present invention;

FIG. 21 is a view illustrating an attachment structure of a voice coil of the speaker unit according to an embodiment of the present invention;

FIGS. 22(a)-(c) are views illustrating a power feed structure of the speaker unit according to an embodiment of the present invention;

FIGS. 23(a)-(d) are views illustrating a configuration example of a cabinet applied to the speaker device according to an embodiment of the present invention;

FIG. 24 is a view illustrating a configuring example of a cabinet applied for a speaker device according to an embodiment of the present invention and an example of the arrangement of a speaker unit in the cabinet of the speaker device;

FIGS. 25(a) and (b) are views illustrating an example of the arrangement of a speaker unit in the cabinet of a speaker device according to the embodiment of the present invention;

FIGS. 26(a) and (b) are views illustrating an example of the arrangement of a speaker unit in the cabinet of a speaker device according to the embodiment of the present invention;

FIG. 27 is a view illustrating an example of a speaker device 1 including a cabinet in a speaker device according to the embodiment of the present invention;

FIGS. 28(a)-(c) are views illustrating an entire configuration of a speaker device according to an embodiment of the present invention;

FIGS. 29(a)-(c) are views illustrating a variation of a speaker device according to an embodiment of the present invention;

FIG. 30 is a view illustrating an example a mid-high frequency reproduction speaker unit used for an embodiment of the present invention;

FIGS. 31(a) and (b) are views illustrating the directional characteristic of a speaker device according to an embodiment of the present invention;

FIGS. 32(a) and (b) are views illustrating the acoustic characteristic of a speaker device according to an embodiment of the present invention;

FIG. 33 is a view illustrating the acoustic characteristic of a speaker device (both with and without a baffle board) according to an embodiment of the present invention;

FIG. 34 is a view (an entire cross-sectional view) illustrating a speaker device (or a speaker unit) according to another embodiment of the present invention;

FIG. 35 is a view (an entire planar perspective view) illustrating a speaker device (or a speaker unit) according to another embodiment of the present invention;

FIG. 36 is a view (an internal structure illustration) illustrating a speaker device (or a speaker unit) according to another embodiment of the present invention;

FIG. 37 is a view (an entire cross-sectional view) illustrating a speaker device (or a speaker unit) according to another embodiment of the present invention;

FIG. 38 is a view (an entire cross-sectional view) illustrating a speaker device according to another embodiment of the present invention;

FIG. 39 is a view (a partially cross-sectional view) illustrating a speaker device according to another embodiment of the present invention;

FIG. 40 is a view illustrating a speaker device according to another embodiment of the present invention (a cross-sectional view illustrating a configuration example of a mid-high frequency reproduction speaker unit (tweeter));

FIG. 41 is a view (an attachment view of accessories) illustrating a speaker device according to another embodiment of the present invention;

FIG. 42 is a view (an external view) illustrating a speaker device according to another embodiment of the present invention;

FIGS. 43(a) and (b) are views illustrating an example of an on-board speaker device according to an embodiment of the present invention;

FIGS. 44(a)-(c) are views illustrating an example of an on-board speaker device according to an embodiment of the present invention;

FIGS. 45(a) and (b) are views illustrating an example of an on-board speaker device according to an embodiment of the present invention; and

FIGS. 46(a) and (b) are views illustrating an example of an on-board speaker device according to an embodiment of the present invention.

### DETAILED DESCRIPTION OF THE INVENTION

Hereinafter, an embodiment according to the present invention is described with reference to the drawings. The embodiment according to the present invention includes what is shown in the drawings, but is not limited to this alone. In the description hereinafter, the same symbol is applied to the same part as the part that has already been described, and thus a part of the same description may not be repeated.

### [Whole Structure of Speaker Device]

A speaker device according to an embodiment of the present invention includes a speaker unit and a cabinet on or in which the speaker unit is mounted. And, the cabinet forms a prescribed space between the cabinet and the speaker unit.

The speaker unit, which is described hereinafter, includes a diaphragm, a static part supporting the diaphragm vibratably in the vibration direction and a driving part provided at the static part to vibrate the diaphragm in response to an audio signal. The driving part includes a magnetic circuit forming a magnetic gap, a voice coil vibrating in a direction different from the vibration direction of the diaphragm upon the inputted audio signal and a rigid vibration direction converter part direction-converting the vibration of the voice coil and transmitting the vibration to the diaphragm. The vibration direction converter part is arranged such that one end is angle-variably coupled to the voice coil directly or via other member, while another end is angle-variably coupled to the diaphragm directly or via other member. And the vibration direction converter part is obliquely disposed with respect to the vibration direction of the diaphragm and the vibration direction of the voice coil respectively.

Further, the speaker unit includes a diaphragm, a static part supporting the diaphragm vibratably in the vibration direction and a driving part provided on the static part to vibrate the diaphragm in response to an audio signal. The driving part includes a magnetic circuit forming a magnetic gap in a direction different from the vibration direction of the diaphragm, a voice coil vibrating along the magnetic gap and a vibration direction converter part direction-converting the vibration of the voice coil and transmitting the vibration to the diaphragm. The vibration direction converter part includes a link body angle-converting a link part that is formed between the voice coil and the diaphragm.

In the speaker device that includes a configuration described above a large amplitude of vibration of the voice coil in the speaker unit] has little direct effect on the thickness of the speaker unit in sound emission direction, since vibration direction converter part direction-converts the vibration produced by the voice coil and transmits the vibration to the diaphragm. Therefore, it is possible to make the speaker unit thin while achieving the speaker unit making a louder sound. The cabinet, at which the speaker unit described above is placed, may be configured to have a large volume in a space between the cabinet and the speaker unit even when the speaker unit is housed in the cabinet having a small depth, since the speaker unit may be made thin. As such, the whole speaker device including the cabinet may be made thin, and thus an improved installation space for the speaker device may be secured. In addition, the speaker unit may provide a preferable acoustic performance with a space having a sufficient volume, which is made on the rear side of the speaker unit in the cabinet. If a space volume in the cabinet is small, air in the cabinet, which is subject to repeated contraction and expansion, acts as a spring preventing vibration of the diaphragm, thereby degrading acoustic performance. However, in the embodiment according to the present invention, it is possible to restrain such degradation of acoustic performance by securing a sufficient space volume in the cabinet even if the cabinet has a short depth.

### [Speaker Unit]

### (Basic Configuration)

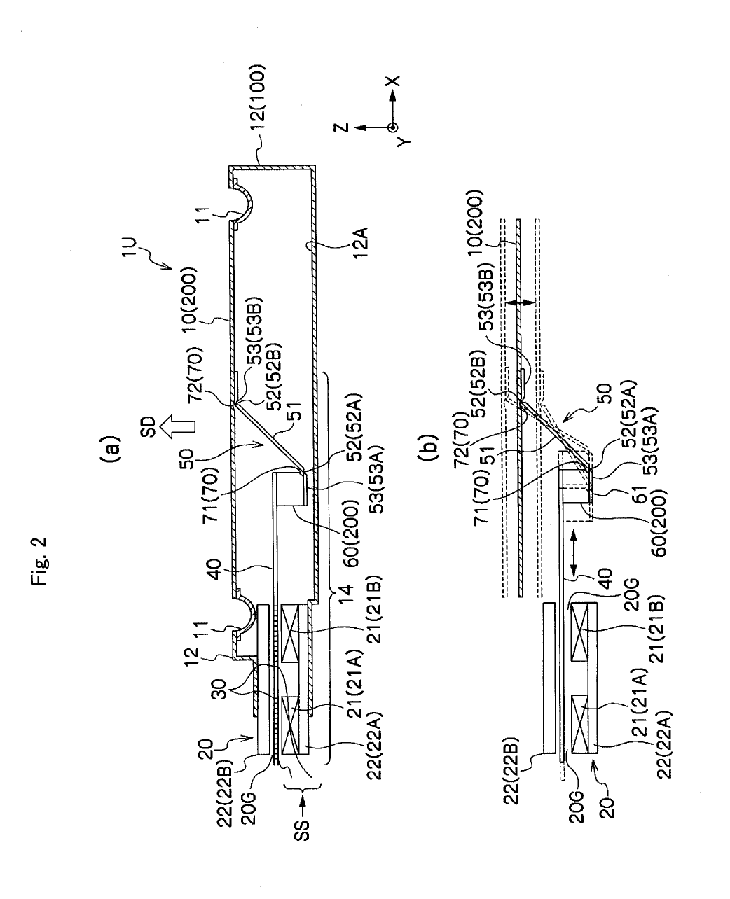

FIG. 2 is a view illustrating a basic configuration of the speaker device according to an embodiment of the present invention (FIG. 2(a) is a cross-sectional view taken along X-axis direction and FIG. 2(b) is a view illustrating an operation of the driving part). The speaker unit 1U includes a diaphragm 10, a static part 100 supporting the diaphragm 10 vibratably in the vibration direction and a driving part 14 arranged at the static part 100 to vibrate the diaphragm 10 in response to an audio signal. The driving part 14 includes a magnetic circuit 20 forming a magnetic gap 20G, a voice coil 30 vibrating in a direction different from the vibration direction of the diaphragm 10 upon the inputted audio signal and a vibration direction converter part 50 direction-converting the vibration produced by the voice coil 30 and transmit the vibration to the diaphragm 10. The voice coil 30 itself may connect with the vibration direction converter part 50, while the voice coil 30 is supported by a voice coil support part 40 as shown in the drawings. In this embodiment, the vibration direction of the voice coil 30 is X-axis direction and two directions orthogonal to X-axis direction are Y-axis direction and Z-axis direction respectively.

The diaphragm 10 may be formed substantially in a rectangular shape, a circular shape, an ellipsoidal shape or other shapes in the plan view. Further, the cross-sectional shape of the diaphragm 10 may be formed in a prescribed shape, for example, such as a tabular shape, a dome shape, a cone shape, etc. The cross-sectional shape of the diaphragm 10 is planar as shown in the drawings, however it may be formed in a curved shape. Further, the speaker unit 1U may be made thin by making the total height of the diaphragm 10 comparatively small as necessary.

The static part 100 is a collective term for those that support vibrations of the diaphragm 10, the driving part 14, etc., which includes the frame 12 and those that have also a function of the frame 12 such as an after-mentioned yoke, a mounting unit, etc. The static part 100 is, however, not necessarily completely static. The whole static part 100 may vibrate subject to vibration of the driving part 14 or other force. The outer periphery part of the diaphragm 10 is supported via an edge 11 by the frame 12 as the static part 100.

The driving part 14 has the magnetic circuit 20, the voice coil 30 (driving member) and the vibration direction converter part 50. The voice coil 30 vibrates in one axis direction along the magnetic gap 20G of the magnetic circuit 20 and the vibration direction converter part 50 direction-converts the vibration and transmits the vibration to the diaphragm 10. The voice coil 30 vibrates in X-axis direction and the diaphragm 10 is vibratably arranged in Z-axis direction orthogonal to X-axis direction as shown in the drawings. The vibration direction converter part 50 converts the vibration of the voice coil 30 in X-axis direction into a vibration at obliquely disposed angle of its own displacement, and thus vibrating the diaphragm 10 in Z-axis direction.

The magnetic circuit 20 has a magnet 21 (21A, 21B) and a magnetic pole member (yoke) 22 (22A, 22B) such that a plurality of the magnetic gaps 20G are arranged in vibration direction of the voice coil 30, for example, in X-axis direction. In this embodiment, the magnetic pole direction of the magnet 21 (21A, 21B) is set such that magnetic field directions of a pair of the magnetic gaps 20G are opposite to each other (±Z-axis direction). The voice coil 30 made up of a wound conducting member is arranged such that currents flow in directions opposite to each other (+Y-axis direction) in the magnetic gap 20G having magnetic fields in directions opposite to each other. Thereby, a driving force (Lorentz force, electromagnetic force) may be developed in the voice coil 30 in directions (±X-axis directions) along the magnetic gap 20G. Relationship of arrangement between the magnet 21 and the magnetic pole member (yoke) 22 is not limited to the example shown in the drawings. Rigidity (bending rigidity, torsional rigidity included) may be added to the voice coil 30 as a whole by forming the voice coil support part 40 with, for example, a tabular insulating member.

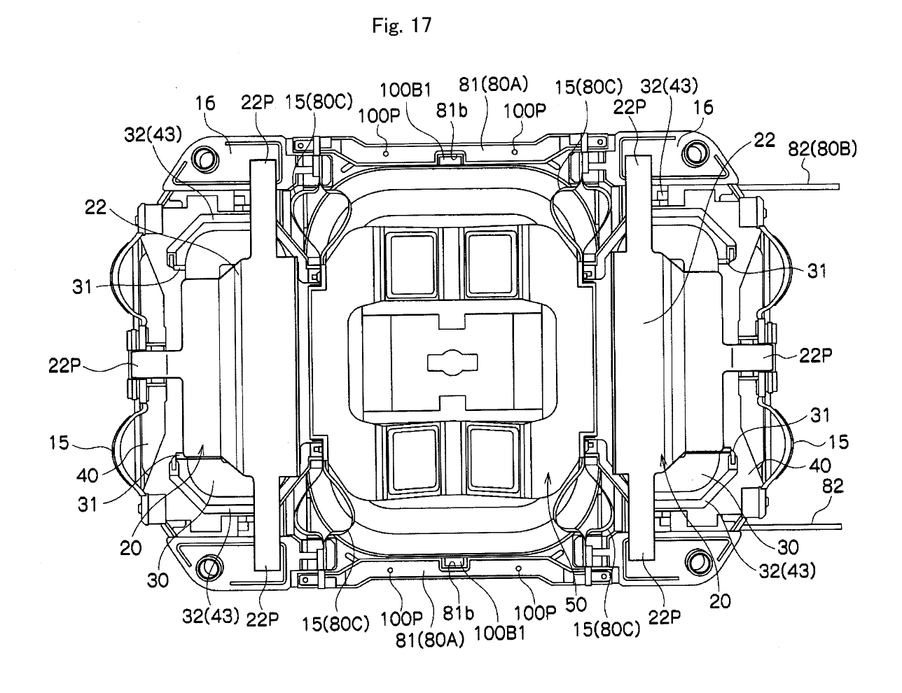

A tabular insulating member as the voice coil support part 40 has a plurality of conducting layers formed at the outside of a conducting wire. The conducting layer 43 (see FIG. 17) is electrically connected to a lead wire 31 (see FIG. 17) that is pulled out from the start point and the end point of the conducting wire. The lead wire 31 is configured, for example, with a part of an after-mentioned conducting member. Further, the lead wire 31 is electrically connected to outside via an after-mentioned holding part 15, thus functioning as a junction wire for inputting an outside audio signal into the voice coil 30. Further, for example, when a conducting wire free from the voice coil is wound in the speaker unit as the junction wire, an additional space for wiring by winding is required. However, since the conducting layer 43 (see FIG. 17) as the junction wire is formed on the surface of the voice coil support part 40, the space for the junction wire is no longer required, and thus the speaker unit may be made thin. As shown in the drawings, the voice coil 30 and the voice coil support part 40 are formed to be tabular, but they are not limited to this form and may be formed to be tubular. Further if the voice coil 30 or the voice coil support part 40 supporting the voice coil 30 are formed to be tubular, a tabular lid, which enables angle-variable coupling of the vibration direction converter part, may be connected with the end of the vibration direction converter part 50.

The voice coil 30 is formed by winding the conducting wire (conducting member) to which the audio signal is inputted. The voice coil 30 in itself is vibratably arranged at the static part 100 or is vibratably arranged at the static part 100 via the voice coil support part 40. The voice coil support part 40 may be formed, for example, with a tabular insulating member, and the voice coil 30 is supported on the surface of or inside the voice coil support part 40.

Since the voice coil support part 40 is formed, for example, with the tabular insulating member, rigidity (bending rigidity and torsional rigidity included) may be added to the voice coil 30 as a whole.

The voice coil 30 is held on the static part 100 with a holding part not shown in the drawings. The holding part is configured to vibratably hold the voice coil 30 or the voice coil support part 40 in vibration direction (for example, X-axis direction) with respect to the static part 100 and restrict them not to move in other directions. For example, the holding part is deformable in the vibration direction (for example, X-axis direction) of the voice coil 30. And the holding part may be formed with a curved plate member having rigidity in a direction crossing this vibration direction. Further, the length of the voice coil 30 in the direction orthogonal to the vibration direction of the voice coil thereof may be comparatively long with respect to the length of the voice coil 30 in the vibration direction of the voice coil so that a comparatively large driving force may be produced when driving a speaker.

Further, a driving member is not limited to a voice coil and a piezoelectric element or a magnetostrictor may also be used as a driving member. The entirety of a PCT application No. PCT/JP2009/063527 which was filed on Jul. 29 in 2009 is incorporated in this application by reference.

The vibration direction converter part 50 has one end angle-variably connected to the voice coil 30 directly or via other member, and has another end angle-variably connected to the diaphragm 10 directly or via other member. The vibration direction converter part 50 is obliquely disposed with respect to each of vibration directions of the diaphragm 10 and the voice coil 30. Specifically, the vibration direction converter part 50 includes a rigid link part 51 angle-variably and obliquely disposed between the voice coil 30 or the voice coil support part 40 and the diaphragm 10, and a hinge part 52, which is formed at both ends of the link part 51 and functions as a fulcrum for angle change of the vibration direction converter part 50. The connecting part 53 of the vibration direction converter part 50 is connected to the diaphragm 10, the voice coil 30, or an attaching counterpart 200 including other member than the diaphragm 10 or the voice coil 30 with a coupling member including a connecting member such as an adhesive or a double-faced tape, and a fastener member such as a screw, etc. The hinge part 52 is arranged in proximity of the attaching counterpart 200. The connecting part 53 (53A) at the end of the vibration direction converter part 50 is coupled to the voice coil 30 or the voice coil support part 40 via a connecting part 60 as shown in the drawings. However, the connecting part 53 (53A) may be directly connected without the connecting part 60. The connecting part 60 is formed between the end of the vibration direction converter part 50 on the voice coil side and the end of the voice coil 30 or the voice coil support part 40 on the side of vibration direction converter part, and thereby both ends are coupled spaced apart in the vibration direction. Further, the connecting part 60 absorbs the thickness of the magnetic circuit 20, thus making the speaker unit thin.

Further, a contact avoiding part 70 avoiding contact with the hinge part 52 is formed on the face side of the attaching counterpart 200 in proximity of the hinge part 52 of the vibration direction converter part 50. The contact avoiding part 70 also functions as a connecting member housing part (restraining part), which houses and restrains the connecting member connecting the vibration direction converter part 50 and the attaching counterpart 200. The contact avoiding part 70 is, for example, a recessed portion, a notch part, a groove part, etc., which is formed in a recessed shape along the hinge part 52. Accordingly, a predetermined space is formed between the hinge part 52 and the surface of the attaching counterpart 200 arranged near the hinge part 52 and thus preventing the adhesive material provided between the vibration direction converter part 50 and the attaching counterpart 200 from affecting the hinge part 52. As shown in the drawings, the notch part 71 as the contact avoiding part 70 is formed at the connecting part 60, which is the attaching counterpart 200, such that the notch part 71 is located in proximity of the hinge part 52 (52A), while the recessed portion 72 as the contact avoiding part 70 is formed at the diaphragm 10, such that the recessed portion 72 is located in proximity of the hinge part 52 (52B). As such, when the connecting part 53 of the vibration direction converter part 50 and the connecting part 60 or the end face of the diaphragm 10 are applied with the connecting member such as adhesive, double-faced tape, etc., the adhesive and the end of the double-faced tape running off toward the hinge part 52 enter into the notch part 71 or the recessed portion 72, and thus preventing them from contacting and adhering to the hinge part 52.

In the above-mentioned speaker unit 1U, when an audio signal SS as an electric signal is inputted to the voice coil 30 of the driving part 14 as shown in FIG. 2 (a), the voice coil 30 or the voice coil support part 40 vibrates along the magnetic gap 20G of the magnetic circuit 20, for example, in X-axis direction of the drawings as shown in FIG. 2 (b). Accordingly, the vibration is direction-converted by the vibration direction converter part 50 and the vibration is transmitted to the diaphragm 10 such that the diaphragm 10 is vibrated, for example, in Z-axis direction of the drawings, thereby a sound in response to the audio signal is emitted in the sound emission direction SD.

In the speaker unit 1U as described above, since the direction of the vibration produced by the voice coil 30 and the vibration direction of the diaphragm 10 are different from each other by using the vibration direction converter part 50, the thickness of the speaker unit 1U on the rear side of the diaphragm 10 may be made smaller than the thickness of the speaker, of which the voice coil 30 is vibrated in the vibration direction of the diaphragm 10. As such, a thin speaker device, which may reproduce a low frequency range with a high sound pressure, may be realized.

Further, since the vibration produced by the voice coil 30 is direction-converted by the vibration converter part 50 and the vibration is transmitted to the diaphragm 10, the thickness in sound emission direction of the speaker unit 1U (total height of the speaker unit) is not increased even if the amplitude of vibration of the diaphragm 10 is increased by increasing the amplitude of vibration of the voice coil 30. As such, a thin speaker device, which may emit a loud reproduced sound, can be obtained.

Further, when the connecting part 53 of the direction converter part 50 and the attaching counterpart 200 are connected to each other by using the adhesive as an connecting member, if the adhesive spreads out and runs off toward the hinge part 52 due to the connect, and adheres to the hinge part 52, the hinge part 52 may be hardened and lose mobility. Also, when the double-faced tape is used as the connecting member, if the end of the double-faced tape runs off toward the hinge part 52 and the double-faced tape adheres to the hinge part 52, the hinge part 52 may be hardened and lose mobility. In addition, the hinge part 52, which is adhered to and hardened by the adhesive, the end of the double-faced tape, etc. adhered thereto, may be subject to fracture by the repetition of bending, folding or rotational motion. If the hinge part 52 fractures as described above, the part to which the adhesive or the end of the double-faced tape adheres may repeatedly contact with and separate from the diaphragm 10, the voice coil 30 or the attaching counterpart 200 as other members, etc., and thus an abnormal noise (contact sound) may be generated each time. On the other hand, if the applied volume of the adhesive or the connecting area by the double-faced tape is limited such that the adhesive or the double-faced tape does not run off and adhere to the hinge part 52, the coupling force between the vibration direction converter part 50 and the attaching counterpart 200 may be reduced, then detachment, etc. may occur at the end face, causing abnormal noise, or if a total detachment occurs, the speaker may eventually be fractured. Furthermore, since the hinge part 52 is arranged near the attaching counterpart 200, the hinge part 52 may contact the attaching counterpart 200. Therefore, the hinge part 52 damages, or there is a case that the vibration direction converter part 50 cannot bend, fold or rotate with respect to the attaching counterpart 200. However, in this speaker unit 1U, since the contact avoiding part 70 is formed on the face side of the attaching counterpart 200 in proximity of the hinge part 52, it is possible to prevent the attaching counterpart 200 from contacting the hinge part 52 and restrain the generation of abnormal noise, etc. due to the contact. Further, even if the connecting member such as the adhesive, double-faced tape, etc., which is used for coupling the connecting part 53 of the vibration direction converter part 50 and the attaching counterpart 200, runs off, the connecting member enters into the contact avoiding part 70 that also functions as a connecting member restraining part, and thus it is possible to restrain adherence of the connecting member to the hinge part 52 causing hindrance to mobility thereof. As such, the function of the hinge part 52 may be maintained while the coupling force between the vibration direction converter part 50 and the attaching counterpart 200 is maintained large. Since the vibration direction converter part 50 securely bends, folds or rotates with respect to the attaching counterpart 200, contact of the hinge part 52 to the attaching counterpart 200, generation of the abnormal noise, etc. due to fracture may be restrained.

### (Vibration Direction Converter Part)

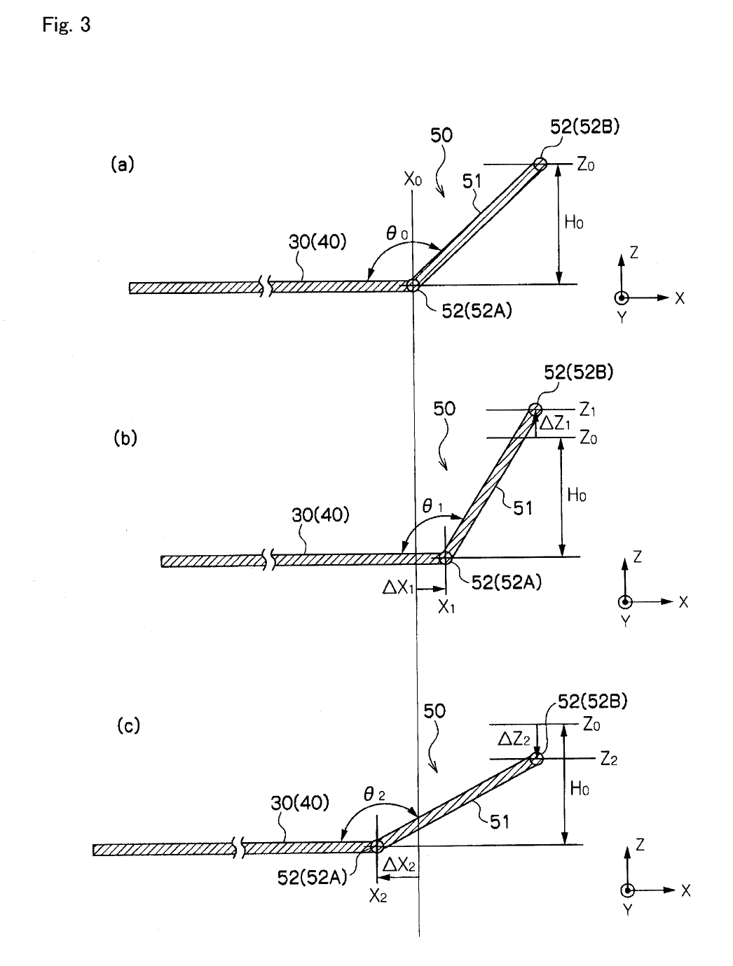

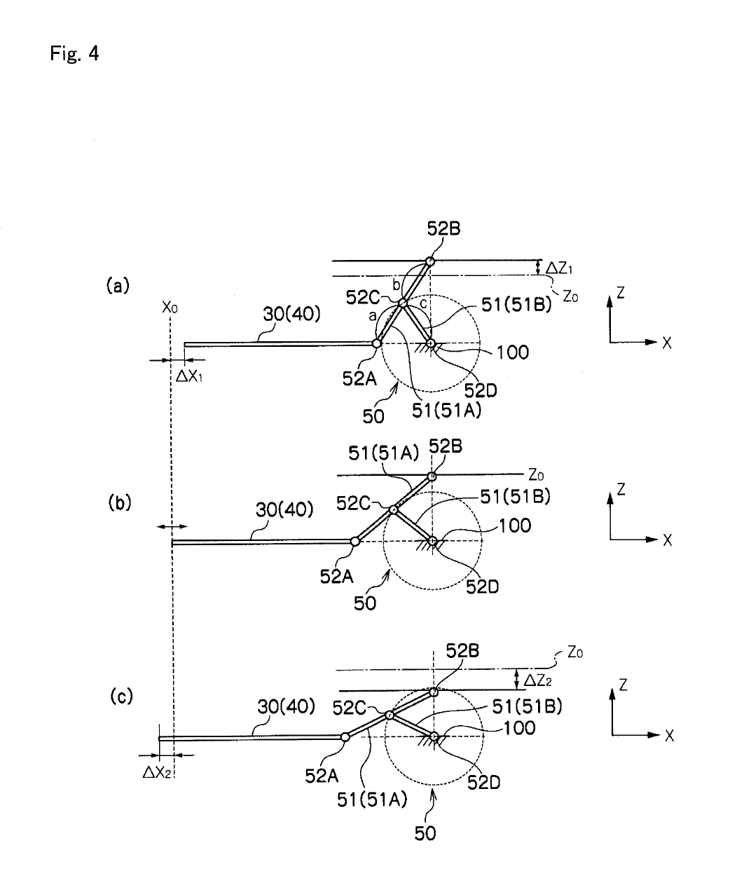

FIGS. 3 and 4 are views illustrating a configuration example and an operation of the vibration direction converter part 50. The rigid vibration direction converter part 50, direction-converting the vibration of the voice coil 30 and transmitting it to the diaphragm 10, has hinges 52 formed on the sides of the diaphragm 10 and the voice coil 30 respectively, and has the link part 51 obliquely disposed with respect to the vibration direction of the voice coil 30. The hinge part 52 is a part that rotatably connects two rigid members or a part that bends or bendably connects integrated two rigid parts, while the link part 51 is a rigid part having the hinge parts 52 formed at the ends. The rigidity means that the members and the parts are not so deformable that the vibration of the voice coil 30 can be transmitted to the diaphragm 10. It does not mean that they are totally undeformable. The link part 51 can be formed in a plate shape or in a rod shape.

In the embodiment shown in FIG. 3, one link part 51 has the hinge parts 52 (52A, 52B) formed at both ends such that the one hinge part 52A is formed at the end of the voice coil 30 or the voice coil support part 40, while another hinge part 52B is formed on the side of the diaphragm 10. Another hinge part 52B may be connected to the diaphragm 10 or connected to the diaphragm 10 via other member. A conventional member may be used as other member. For example, a metal material, etc. improving connecting strength between the hinge part 52 and the diaphragm 10, may be selected (diaphragm 10 is not shown in FIG. 3).

FIG. 3(a) shows that the link part 51 is in the middle position of the vibration. The link part 51 is obliquely disposed between the voice coil 30 (or voice coil support part 40) and the diaphragm 10 at an angle θ₀. Meanwhile, the hinge part 52B on the side of the diaphragm 10 is arranged at the position Z₀ apart from the voice coil 30 by distance H₀ in the vibration direction of the diaphragm 10. The vibration direction of the voice coil 30 (or voice coil support part 40) is restricted such that it may vibrate in one axis direction (for example, X-axis direction), while the vibration direction of the diaphragm 10 is restricted such that it may vibrate in a direction (for example, Z-axis direction) different from the vibration direction of the voice coil 30.

As shown in FIG. 3(b), when the hinge part 52A formed at the end of the voice coil 30 moves from position X₀ to position X₁ by ΔX₁, in the vibration direction (X-axis direction), the inclination angle of the link part 51 is converted to be θ₁(θ₀>θ₁) and the position of the hinge part 52B on the side of the diaphragm 10 moves to position Z₁ by ΔZ₁ in the vibration direction of the diaphragm 10 (Z-axis direction). More specifically, the diaphragm 10 is pushed up by ΔZ₁ in the vibration direction.

As shown in FIG. 3(c), when the hinge part 52A formed at the end of the voice coil 30 moves from the original position X₀ to the position X₂ by ΔX₂ in the vibration direction (−X-axis direction), the inclination angle of the link part 51 is converted to be θ₂ (θ₀<θ₂) and the position of the hinge part 52B on the side of diaphragm 10 moves to position Z₂ by ΔZ₂ in the vibration direction of the diaphragm 10 (−Z-axis direction). More specifically, the diaphragm 10 is pushed down by ΔZ₂ in the vibration direction.

As such, the vibration direction converter part 50, including the link part 51 and the hinge part 52 (52A, 52B), converts vibration of the voice coil 30 to the change in the angle of the link part 51 obliquely disposed and transmits it to the diaphragm 10, and thus vibrating the diaphragm 10 in a direction different from the vibration direction of the voice coil 30.

FIG. 4 is a view illustrating another configuration example and the operation of the vibration direction converter part 50. Specifically, FIG. 4(b) shows a state of the vibration direction converter part 50 when the diaphragm 10 is positioned in a reference position, FIG. 4(a) shows a state of the vibration direction converter part 50 when the diaphragm 10 is displaced to the sound emission side from the reference position and FIG. 4(c) shows a state of the vibration direction converter part 50 when the diaphragm 10 is displaced in the direction opposite to the sound emission side from the reference position (diaphragm 10 is not shown).

The vibration direction converter part 50 has a function that the link part 51 can angle-convert by receiving reaction force from a static part 100 such as the frame 12 positioned on the opposite side of the diaphragm. Specifically, the vibration direction converter part 50 includes a first link part 51A having one end on the side of the voice coil 30 as a hinge part 52A while another end on the side of the diaphragm 10 as a hinge part 52B and a second link part 51B having one end as a hinge part 52C to the middle part of the first link part 51A while another end as a hinge part 52D to the static part 100, and the first link part 51A and the second link part 51B are obliquely disposed in different directions with respect to the vibration direction of the voice coil 30. More specifically, the vibration direction converter part 50 includes a first link part 51A having one end on the side of the voice coil 30 as a first hinge part 52A while another end on the side of the diaphragm 10 as a second hinge part 52B and a second link part 51B having one end as a third hinge part 52C to the middle part of the first link part 51A while another end as a fourth hinge part 52D to the static part 100, and the first hinge part 52A, the second hinge part 52B and the fourth hinge part 52D are located on the circumference of a circle with a diameter of substantially the same length as the first link part 51A, having the third hinge part 52C as the center.

In the vibration direction converter part 50, the hinge part 52 D, supported by the static part 100 (or frame 12), is only the hinge part that does not change position, and thus providing reaction force from the static part 100 for the link part 51. Accordingly, when the voice coil 30 (or the voice coil support part 40) moves from the reference position X₀ by ΔX₁ in the X-axis direction, angles of the first link part 51A and the second link part 51B that are obliquely disposed in different directions are increased by substantially the same angle as shown in FIG. 4(a), and thus the hinge part 52B, receiving reaction force from the static part 100 at the hinge part 52D, securely pushes up the diaphragm 10 from the reference position Z₀ by ΔZ₁ in the Z-axis direction. Further, when the voice coil 30 moves from the reference position X₀ by ΔX₂ in the direction opposite to the X-axis direction, angles of the first link part 51A and the second link part 51B are decreased by substantially the same angle as shown in FIG. 4(c), and thus the hinge part 52B, receiving reaction force from the static part 100 at the hinge part 52D, securely pushes down the diaphragm 10 from the reference position Z₀ by ΔZ₂ in the direction opposite to the Z-axis direction

A length a of a link part from the hinge part 52A to the hinge part 52C, a length b of a link part from the hinge part 52C to the hinge part 52B and a length c of a link part from the hinge part 52C to the hinge part 52D are configured to be substantially the same as each other, and thereby the hinge part 52A and the hinge part 52D are preferably arranged substantially in parallel with the moving direction of the voice coil 30. This link body is well known as a “Scott Russell linkage” where the hinge parts 52A, 52B and 52D are located on the circumference of a circle with the length of the first link part 51A (a+b=2a) as the diameter and the hinge part 52C as the center of the circle. In particular, the angle defined by the line passing through the hinge part 52A and the hinge part 52D and the line passing through the hinge part 52B and the hinge part 52D becomes a right angle. As such, when the voice coil 30 is moved in the X-axis direction, the hinge part 52B between the first link part 51A and the diaphragm 10 moves in the Z-axis direction that is perpendicular to the X-axis, and thus it is possible to convert the vibration direction of the voice coil 30 to its orthogonal direction and transmit the vibration to the diaphragm 10.

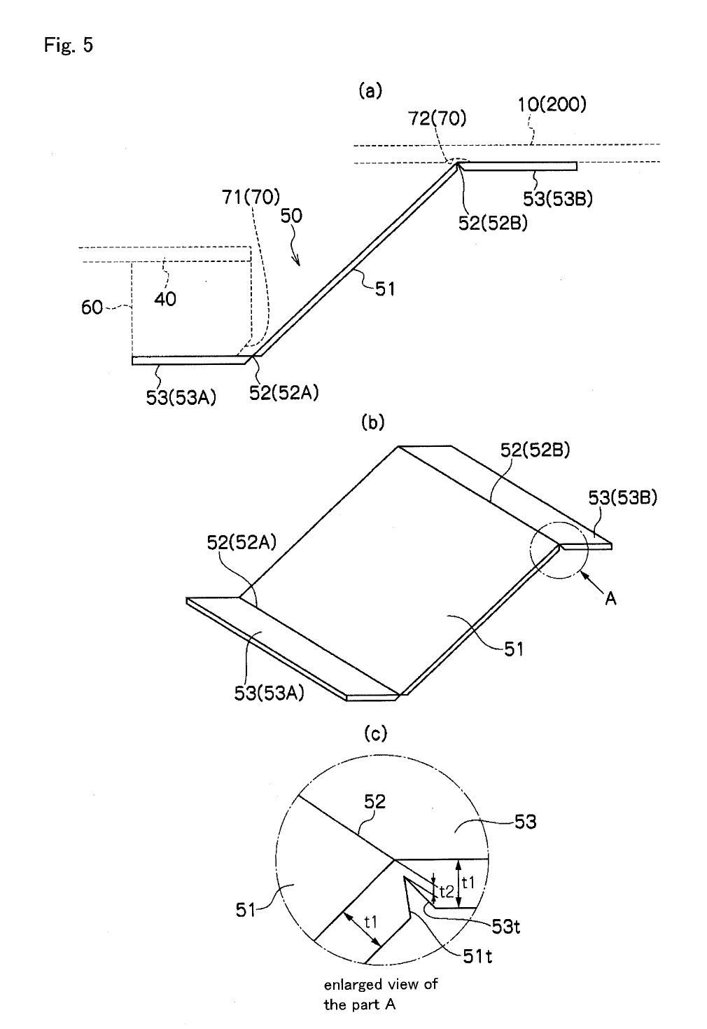

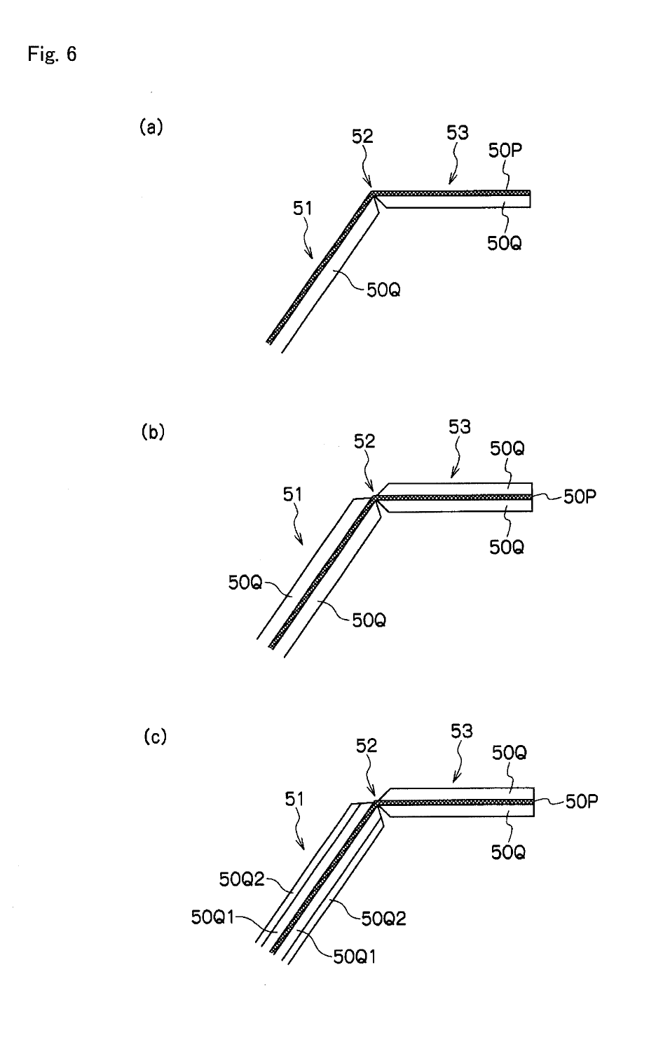

FIGS. 5 and 6 are views illustrating a formation example of the vibration direction converter part (FIG. 5(a) is a side view, FIG. 5(b) is a perspective view and FIG. 5(c) is an enlarged view of part A). The vibration direction converter part 50 includes the link part 51 and the hinge parts 52 (52A, 52B) formed at both ends of the link part 51 as described above. As shown in the drawings, connecting parts 53 (first connecting part 53A and second connecting part 53B) are formed at both ends of the link part 51 via hinge parts 52. The first connecting part 53A, connected to the voice coil 30 or the voice coil support part 40 directly or via other member, integrally vibrates with the voice coil 30, while the second connecting part 53B, connected to the diaphragm 10 directly or via other member, integrally vibrates with the diaphragm 10.

In the vibration direction converter part 50, the link part 51, the hinge parts 52A and 52B, the first and second connecting parts 53A and 53B are integrally formed, and the hinge parts 52A and 52B are formed with a bendable continuous member continuing between the parts of both sides over the hinge parts 52A and 52B. This continuous member may be a member configuring the link part 51 and the first and the second connecting part 53A and 53B as a whole, or may be a member configuring the link part 51 and a part of the first and second connecting parts 53A and 53B. Provided with this second connecting part 53B, the link part 51 may support the diaphragm 10 over a wide range, and thereby it is possible to vibrate the diaphragm 10 in the same phase. The term “fold” includes “bend” in its conceptual scope.

If the vibration direction converter part 50 is formed with a plate shape member, the hinge part 52 is linearly formed extended in a width direction as shown in FIG. 5 (b). Further, the link part 51 is required to be rigid and not to be deformable. Since the hinge part 52 is required to be bendable, the integral member is configured to have a different property by forming the thickness t2 of the hinge part 52 smaller than the thickness t1 of the link part 51 or the connecting part 53.

Further, the change in thickness of the hinge part 52 and the link part 51 is formed on a slant face, and the slant faces 51t and 53t, facing the ends of the parts of both sides over the hinge part 52, are formed. As such, when the link part 51 is angle-varied, interference to the angle variation by thickness of the link part 51 may be restrained.

Further, a recessed portion or notch part 71, which acts as a contact avoiding part 70, is formed at the end of the connecting part 60 that is an attaching counterpart 200 arranged near the hinge part 52A, such that a space is formed between the hinge part 52A and the connecting part 60 as shown in FIG. 5(a). In an example shown in FIG. 5(a), the notch part is formed in a slantwise cross-sectional shape. Furthermore, a recessed portion or notch part 72, which acts as a contact avoiding part 70, is formed at the diaphragm 10 that is an attaching counterpart 200 arranged near the hinge part 52B, such that a space is formed between the hinge part 52B and the diaphragm 10. In an example shown in FIG. 5(a), the recessed portion is formed in a curved cross-sectional shape. As such, contact between the hinge parts 52A, 52B and the attaching counterpart 200 may be restrained. Further, when joining the first connecting part 53A of the link part 51 with the end face of the connecting part 60, and joining the second connecting part 53B with the diaphragm 10 respectively with adhesive as a connecting member, even if the adhesive runs off toward the hinge parts 52A, 52B, it will run into the recessed portion or the notch part 71, 72, and therefore it will not adhere to the hinge parts 52A, 52B. Since the adhesive only adheres to a non-hinge part (unbendable or unfoldable rigid part) even if the adhesive adheres, interference to bending or folding of the hinge parts 52A, 52B may be restrained.

In an example shown in FIG. 6, a link part or a connecting part is configured by integrating a bendable continuous member and a rigid member, and a hinge part is a part that is configured by the continuous member. In the example shown in FIG. 6(a), the link part 51 or the connecting part 53 is configured by joining a rigid member 50Q to the surface of a continuous member 50P that is a bendable sheet-shaped member. According to this configuration, the continuous member 50P continuously extends between the parts of both sides over the hinge part 52, and the hinge part 52 is bendably formed substantially only by the continuous member 50P. Meanwhile, the link part 51 or the connecting part 53, which is formed by joining the rigid member 50Q to the continuous member 50P, may be formed as a rigid part.

In an example shown in FIG. 6(b), the rigid members 50Q are applied to sandwich the continuous member 50P to form the link part 51 or the connecting part 53. Also, the part, not applied with the rigid member 50Q, becomes the hinge part 52. In an example shown in FIG. 6(c), the rigid member forming the link part 51 is formed in multiple layers laminated by the rigid members 50Q1 and 50Q2. Further, in FIG. 6(c), the rigid member 50Q1 and the rigid member 50Q2 may be formed in a multiple-layer structure. As such, the bendable hinge part 52 and the rigid link part 51 and connecting part 53 may be integrally formed by partially joining the rigid member 50Q to the bendable continuous member 50P.

The continuous member 50P is preferably configured to have strength and durability durable against repeated bending of the hinge part 52 when the speaker unit is driven, and have flexibility making little noise when bending is repeated. According to one embodiment, the continuous member 50P may be formed with a woven or an unwoven material made of high-strength fiber. As an example of the woven material, plain weave with uniform material, plain weave having different warp and weft material threads, plain weave with alternately changed thread material, plain weave with twisted union yarn and plain weave with paralleled yarn. Other than plain weaves, there may be applied triaxial and quadraxial woven fabrics, triaxial and quadraxial continuous non-woven fabric of glued layer, knitting, fabric with paralleled yarn in one direction, etc.

When the high-strength fiber is applied partially or as a whole, sufficient strength against vibration of the voice coil 30 or the voice coil support part 40 may be achieved by arranging the high-strength fiber in the vibration direction of the voice coil support part 40. When applying both the warp and the weft thread as the high-strength fiber, durability may be improved with a uniform tensile force given to the warp and the weft thread by inclining both fiber directions by 45° with respect to the vibration direction of the voice coil support part 40. As the high-strength fiber, aramid fiber, carbon fiber, glass fiber, etc. may be used. Further, a damping material may be applied to adjust characteristic such as bending stress and rigidity of the continuous member.

As the rigid member 50Q, thermoplastic resin, thermosetting resin, metal, paper, etc., which are light weight, easy to mold and having rigidity after hardening, may preferably be used. The vibration direction converter part 50 may be configured by joining the rigid member 50Q, which is molded in a plate shape, to the surface of the continuous member 50P other than the part of the hinge part 52 by using adhesive as a joining material. Further, if thermosetting resin is used as the rigid member 50Q, the vibration direction converter part 50 may be configured by impregnating partially the link part 51 or the connecting part 53 of the fibrous continuous member 50P with resin and then hardening it. Further, if resin or metal is used as the rigid member 50Q, the continuous member 50P and the rigid member 50Q may be integrated at the link part 51 and the connecting part 53 by using insert molding. The above-mentioned technology concerning the integral forming is described in US20050127233 (Publication No. US2005/253298) filed in the US on May 12, 2005 and US20050128232 (Publication No. US2005/253299) filed in the US on May 13, 2005, which is incorporated here in the present application.

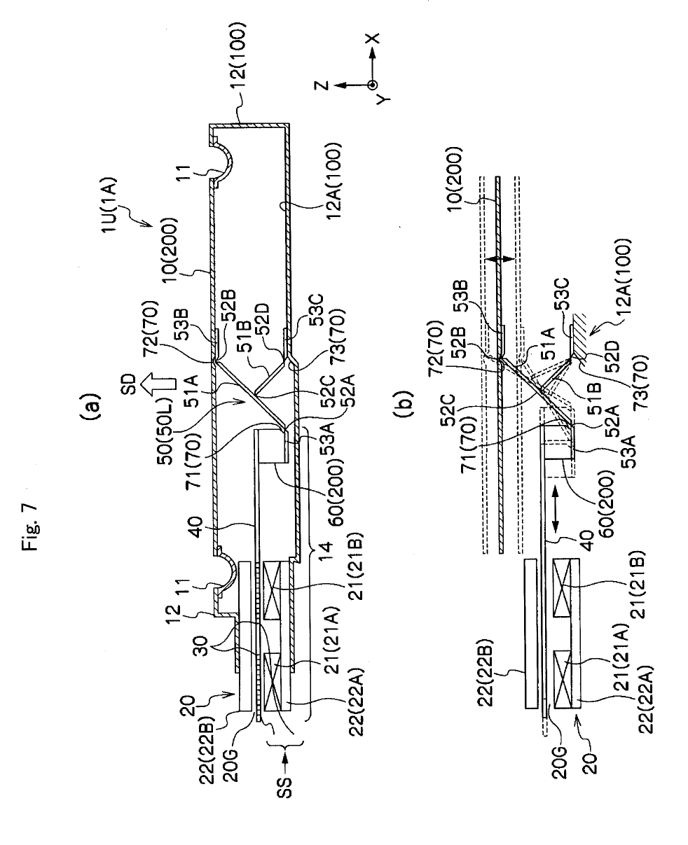

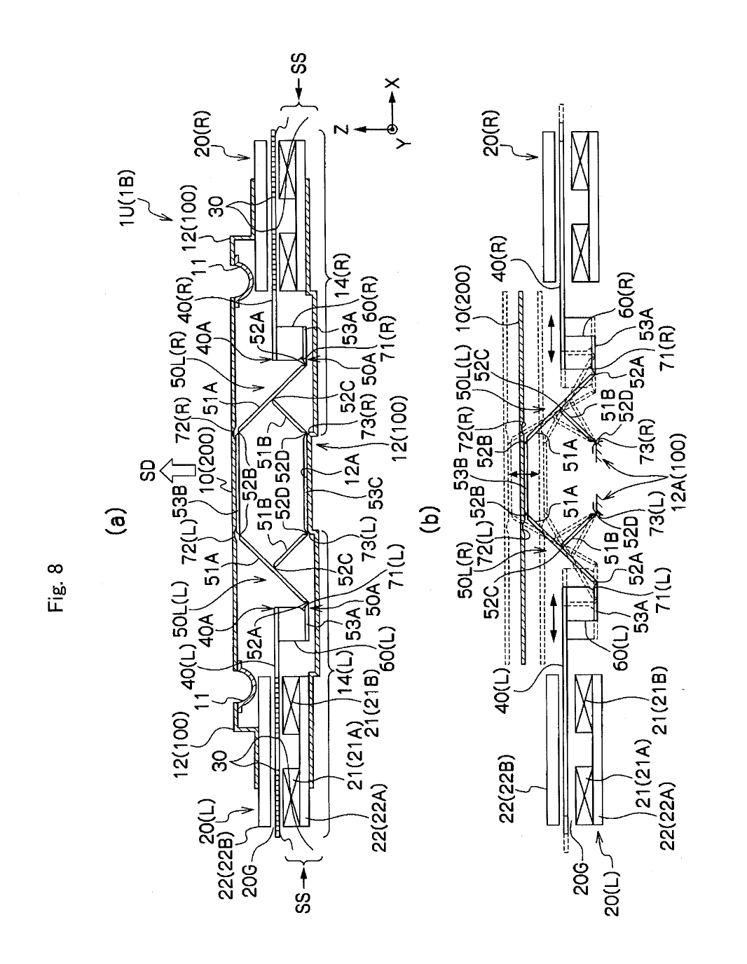

FIGS. 7 and 8 are views illustrating a speaker device adopting the above-mentioned vibration direction converter part (FIGS. 7(a) and 8(a) are cross-sectional views taken in X-axis direction and FIGS. 7(b) and 8(b) are views illustrating an operation of the driving part). The same symbols are applied to the same parts and a part of duplicate descriptions is eliminated. In a speaker unit 1 U (1A, 1B) shown in FIGS. 7 and 8, a link body 50L is configured to include the first connecting part 53A that is connected to the voice coil support part 40 and vibrates integrally with the voice coil support part 40 and the second connecting part 53B that is connected to the diaphragm 10 and vibrates integrally with the diaphragm 10 as well as a plurality of link parts.

In the speaker unit 1 U (1A) shown in FIG. 7, the vibration direction converter part 50 is formed with the link body 50L including the rigid first link part 51A and second link part 51B. The first connecting part 53A is located at one end of the first link part 51A via the hinge part 52A while the second connecting part 53B is located at another end of the first link part 51A via the hinge part 52B. The middle part of the first link part 51A is located at one end of the second link part 51B via the hinge part 52C while the connecting part 53C, which is static with respect to vibration of the voice coil support part 40, is located at another end of the second link part 51B via the hinge part 52D.

According to the drawings, the first connecting part 53A is connected to the end of the voice coil support part 40 directly or via the connecting part 60, the second coupling part 53B is directly connected to the diaphragm 10 and the static connecting part 3C is coupled to the bottom portion 12A of the frame 12 that is the static part 100. A recessed portion or a notch part 73, which acts as a contact avoiding part 70, is formed at the bottom portion 12A of the frame 12 that is an attaching counterpart 200 arranged near the hinge part 52D, such that a space is formed between the hinge part 52D and the bottom portion 12A of the frame 12. In an example shown in the drawings, the notch part is formed. The first link part 51A and the second link part 51B are obliquely disposed in different directions with respect to the vibration direction (X-axis direction) of the voice coil support part 40 and the static part 100 is provided on the opposite side of the diaphragm 10 with respect to the vibration direction converter part 50. In the example shown in the drawings, although the static part 100 is formed with the bottom portion 12A of the frame 12, a yoke 22A of a magnetic circuit 20 may be the static part 100 instead of the bottom portion 12A of the frame 12 by extending the yoke 22A of the magnetic circuit 20 to the position under the vibration direction converter part 50.

As shown in FIG. 7(b), the hinge part 52A on the side of the voice coil support part 40 moves in the X-axis direction in accordance with the movement of the voice coil support part 40 while the hinge part 52D connected to the static part 100 is fixed. The movement of the hinge part 52A is converted to changing angles of the first link part 51A and the second link part 51B, and thus the hinge part 52B on the side of the diaphragm 10 is moved in the vibration direction of the diaphragm 10 (for example, Z-axis direction).

The speaker unit 1 U (1B) shown in FIG. 8 is configured with the driving parts 14 shown in FIG. 7 symmetrically disposed opposite to each other, which includes the driving parts 14(R) and 14(L), respectively. Each of the driving parts 14(R) and 14(L) includes a link body 50L(R) or 50L(L), a voice coil support part 40(R) or 40(L), a magnetic circuit 20(R) or 20(L) and a connecting part 60(R) or 60(L).

The link bodies 50L(R) and 50L(L) configure the vibration direction converter part 50 such that a pair of the first link parts 51A, a pair of the second link parts 51B, a pair of the first connecting parts 53A, the second connecting part 53B and the static connecting part 53C, which are disposed opposite to each other, are integrally formed. A pair of the first connecting parts 53A are connected to the voice coil support part 40 respectively, the second connecting part 53B is connected to the diaphragm 10, and the static connecting part 53C is connected to the bottom portion 12A of the frame 12.

According to this configuration, as shown in FIG. 8(b), the diaphragm 10 may be driven by two combined driving forces of the driving parts 14(R) and 14(L) by setting the vibration directions of the voice coil support part 40(R) and 40(L) synchronously opposite to each other. Further, since a plurality of hinge parts 52B are provided on the side of the diaphragm 10, the number of support points on the diaphragm 10 is increased, thereby the phase of vibration of the diaphragm 10 may become uniform.

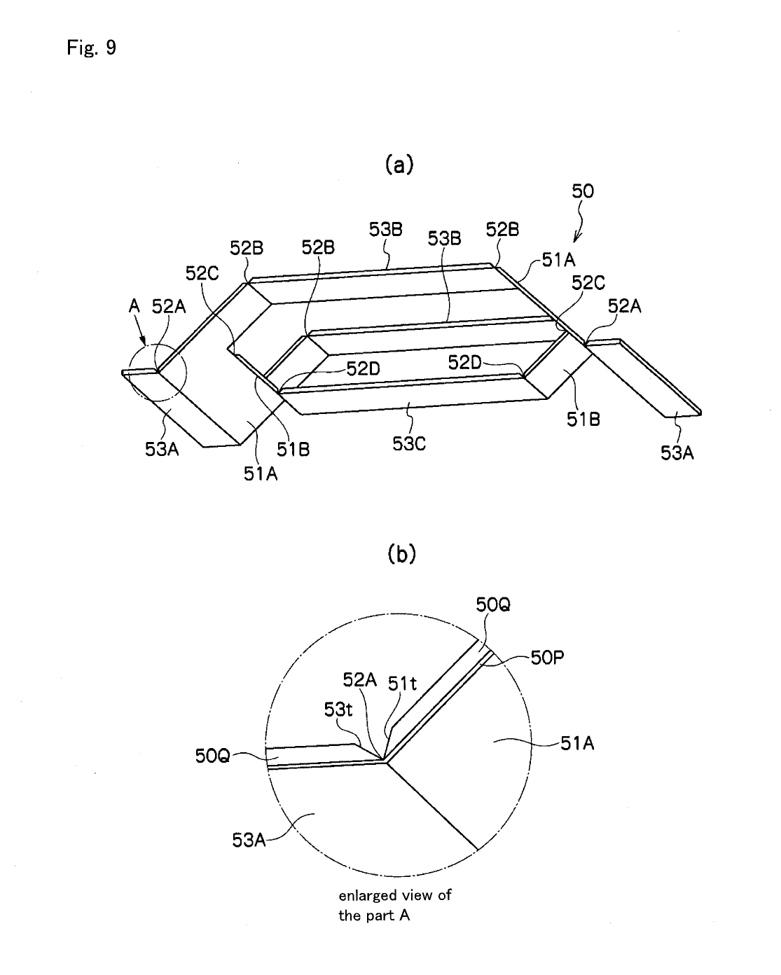

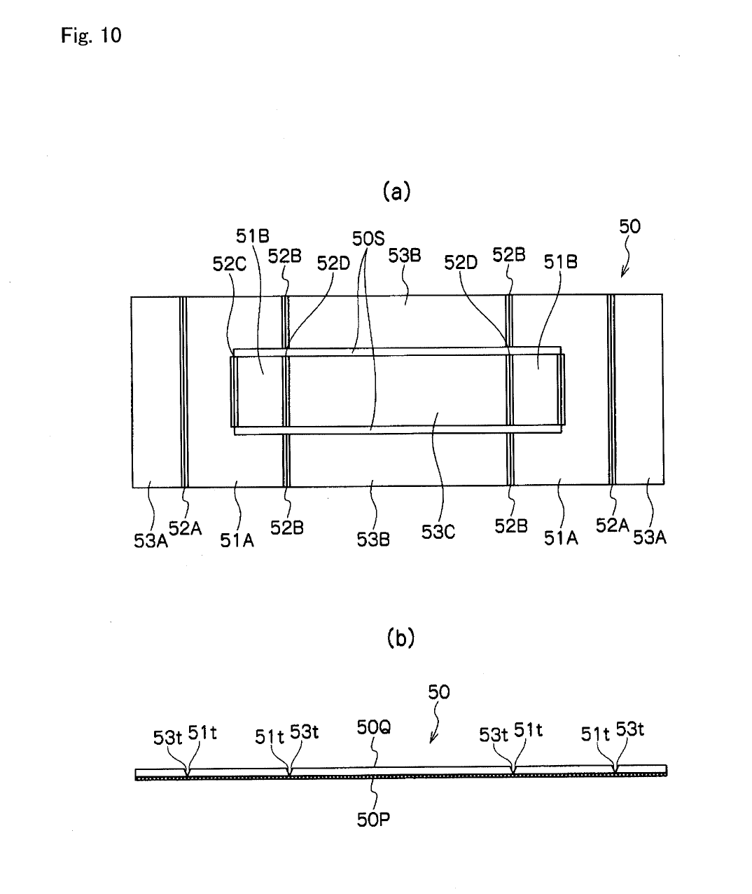

FIGS. 9 and 10 are views illustrating more specific vibration direction converter part (FIG. 9(a) is a perspective view, FIG. 9(b) is an enlarged view of part A in FIG. 9(a), FIG. 10(a) is a plan view illustrating a flattened whole part by unfolding the vibration direction converter part and FIG. 10(b) is a side view illustrating a flattened whole part by unfolding the vibration direction converter part. In this example, the vibration direction converter part 50 is formed with a single integrated component. As described above, the vibration direction converter part 50 is formed with a pair of the first link parts 51A, hinge parts 52A and 52B formed at both ends of the first link parts 51A, a pair of the second link parts 51B and hinge parts 52C and 52D formed at both ends of the second link parts 51B. Further, the first connecting parts 53A are formed at one ends of a pair of the first link parts 51A via the hinge parts 52A, the second connecting part 53B is formed between hinge parts 52B formed at other ends of a pair of the first link parts 51A and the static connecting part 53C is formed between the hinge parts 52D formed at other ends of the second link parts 51B. The first link parts 51A, 51A and the second connecting part 53B are bent in a projecting shape and the second link parts 51B, 51B and the static connecting part 53C are bent in a recessed shape.

As shown in FIG. 9(b), the hinge part 52A is bendably formed with the above continuous member 50P. The above rigid member 50Q is attached to the first link part 51A and also to the first connecting part 53A. Also, the first connecting part 53A is joined by the above rigid member 50Q. As such, all of the above-mentioned hinge parts are formed in the similar configuration. Further, slant faces 51t and 53t are formed opposite to each other in each hinge part.

As shown in FIG. 10(a), the vibration direction converter part 50, including the link parts 51A, 51B, each hinge part and the connecting part 53A, 53B, 53C, is formed with an integral sheet-shaped member. The hinge parts 52A are formed linearly crossing the integral sheet-shaped member, while the hinge parts 52B, 52C, 52D are formed partially crossing the integral sheet-shaped member. A pair of notch parts 50S are fanned in a longitudinal direction of the integral sheet-shaped member such that the second link parts 51B, 51B and the static coupling part 53C are cut out and formed.

As shown in FIG. 10(b), the vibration direction converter part 50 is formed, for example, by applying resin material forming the rigid member 50Q to the whole face of the continuous member 50P that is a sheet-shaped member, such that the resin material is laminated on the continuous member 50P, and cutting in a V-shape to form each hinge part and the slant faces 51t and 53t at both sides thereof. After that, the above-mentioned notch part 50S is formed and the resin material is hardened. A liquid unhardened resin material or resin film may be used as the resin material used in this embodiment.

Further, each hinge part and the slant faces 51t and 53t at both sides thereof may be formed at the same time as forming the rigid member 50Q with the resin material. It is preferable that a cross-sectional V-shape groove or a recessed portion is formed preliminarily in a die, which is used to mold the rigid member 50Q.

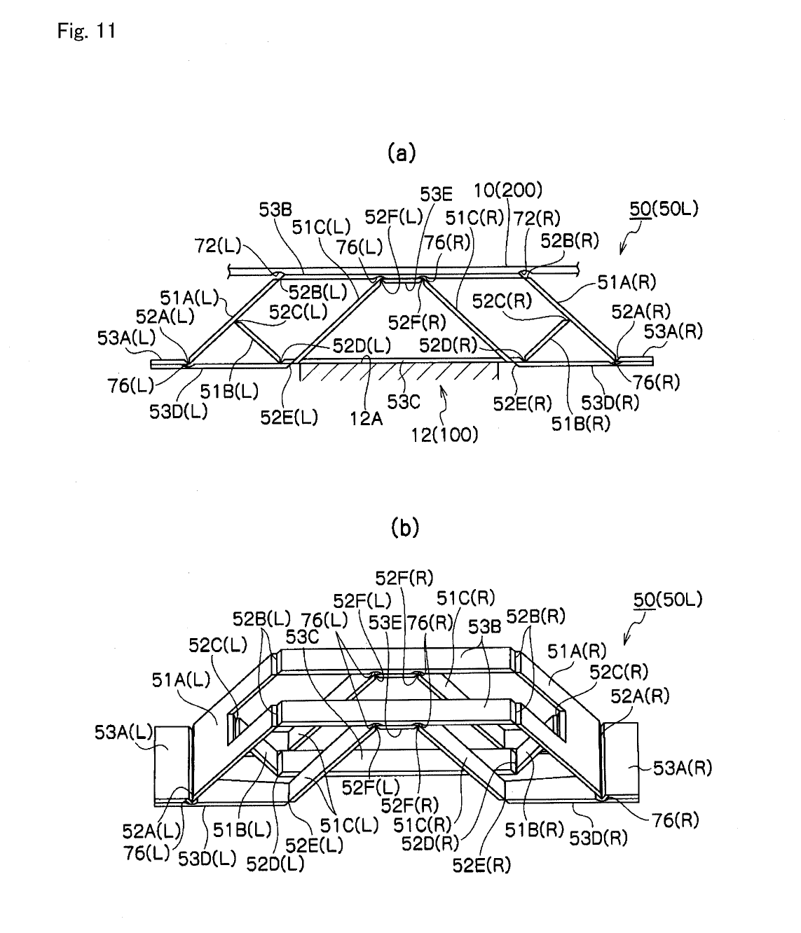

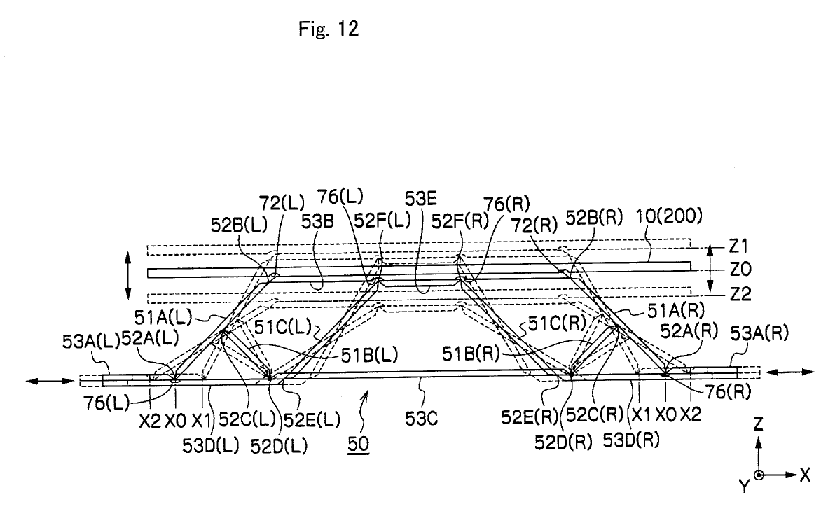

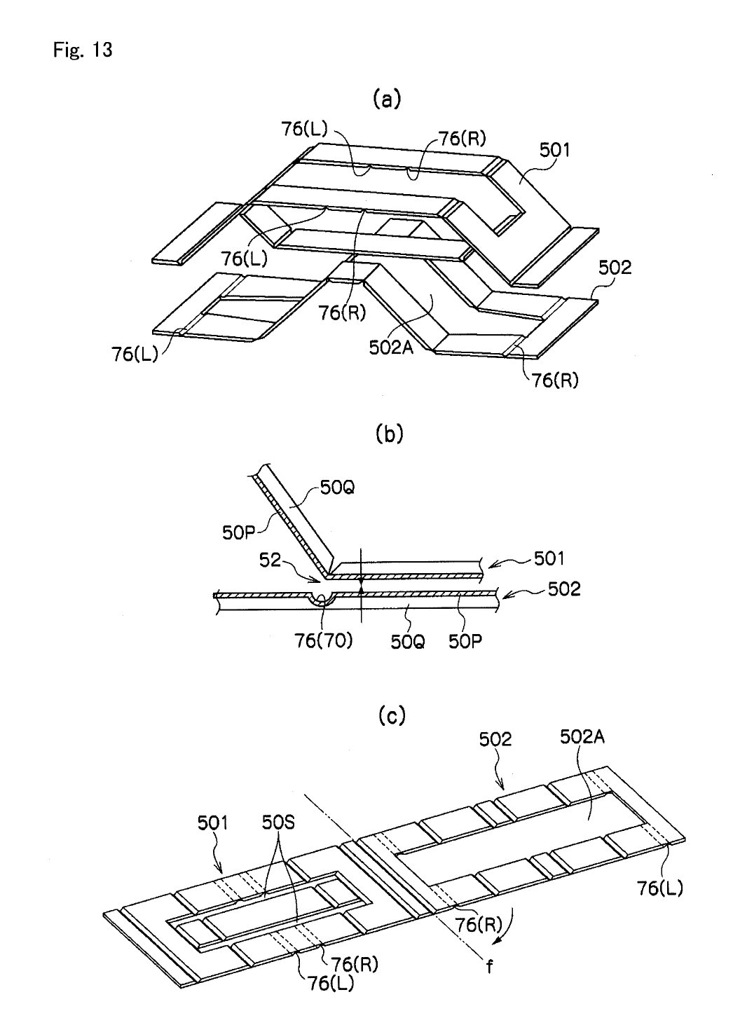

FIGS. 11, 12 and 13 are views illustrating other examples of the vibration direction converter part 50 (FIG. 11(a) is a side view, FIG. 11(b) is a perspective view, FIG. 12 is a view illustrating an operation and FIGS. 13(a) and 13(b) are views illustrating formation examples). The vibration direction converter part 50 (link body 50L) includes a pair of driving parts. In this embodiment, the vibration direction converter parts 50 are substantially symmetrically disposed opposite to each other and a parallel link is formed with a plurality of link parts.

The vibration direction converter part 50 includes a pair of first link parts 51A(R) and 51A(L) having hinge parts 52A(R) and 52A(L) to a first connecting part 53A (R) and 53A (L) at one end, and having a hinge part 52B(R) and 52B(L) to a second connecting part 53B at another end. Also, the vibration direction converter part 50 includes a pair of second link parts 51B(R) and 51B(L) having hinge parts 52C(R) and 52C(L) to the middle parts of the first link parts 51A(R) and 51A(L) at one end, and having hinge parts 52D(R) and 52D(L) to the static connecting part 53C at another end. As described above, the first connecting part 53A is connected to the voice coil 30 or the voice coil support part 40 directly or via the connecting part 60 as other member, while the second connecting part 53B is connected to the diaphragm 10 and the static connecting part 53C is connected to the bottom portion 12A of the frame 12 that is the static part 100, the yoke 22, etc. forming the magnetic circuit 20.

Further the vibration direction converter part 50 includes a pair of third link parts 51C(R) and 51C(L) having hinge parts 52E(R) and 52E(L) at one end to a pair of the connecting parts 53D(R) and 53D(L) integrally extending from the first connecting part 53A (R) and 53A (L), and having hinge parts 52F (R) and 52F (L) at another end to a connecting part 53E that is integral with the second connecting part 53B.

Further, the first link part 51A(R) and the third link part 51C(R), the first link part 51A(L) and the third link part 51C(L), the second link part 51B(R) and the third link part 51C(L), and the second link part 51B(L) and the third link part 51C(R) form parallel links respectively.

This link body 50L of the vibration direction convertor part 50 substantially includes a function combining the link body of the embodiment shown in FIG. 7 and the parallel link body. Each link part and connecting part are formed by integrating the continuous member 50P with the rigid member 50Q, while each hinge part between link parts is linearly formed with the bendable continuous member 50P, and thus link parts are mutually integrally formed via hinge parts.

As shown in the drawings, the second connecting part 53B arranged near the hinge parts 52F (R) and 52F (L) and a pair of the connecting part 53D(R) and 53D(L) arranged near the hinge parts 52A(R) and 52A(L) form recessed portions 76 as the contact avoiding part 70, such that a space is formed between each hinge part and connecting part.

An operation of the vibration direction converter part 50 is described with reference to FIG. 12. In this embodiment, the static connecting part 53C functions as the static part 100. According to the vibration direction converter part 50, when the hinge parts 52A(R) and 52A(L) is moved from the reference position X0 to X1 in the X-axis direction in accordance with vibration of the voice coil support part 40, the second connecting part 53B and the connecting part 53E integrally with the second connecting part 53B moving up keeping a parallel state by the parallel link body, while the first link parts 51A(R) and 51A(L) and the third link parts 51C(R) and 51C(L), which configure a parallel link, are angle-varied as they are erected. Since the hinge parts 52D(R) and 52D(L) are supported at both ends of the static connecting part 53C as the static part, they receive a reaction force from the static part and angle of the first link parts 51A(R) and 51A(L) and the third link parts 51C(R) and 51C(L) is securely varied and the displacement of the hinge parts 52A(R) and 52A(L) from the position X0 to X1 is securely converted to the displacement of the diaphragm 10 from the position Z0 to Z1.

Similarly, when the hinge parts 52A(R) and 52A(L) is moved from the reference position X0 to X2 in the X-axis direction, the second connecting part 53B and the connecting part 53E integrally with the second connecting part 53B are moved down keeping a parallel state by the parallel link body, while angles of the first link parts 51A(R) and 51A(L) and the third link parts 51C(R) and 51C(L), which configure a parallel link, are varied as they are laid. Since the hinge parts 52D(R) and 52D(L) are supported by the static part, they receives a reaction force from the static part and angle variation of the first link parts 51A(R) and 51A(L) and the third link parts 51C(R) and 51C(L) is securely produced and the displacement of the hinge parts 52A(R) and 52A(L) from the position X0 to X2 is securely converted to the displacement of the diaphragm 10 from the position Z0 to Z2.

According to this vibration direction converter part 50, the vibration in the X-axis direction of one voice coil support part 40 is converted to the vibrations in the Z-axis direction of the hinge parts 52B(R) and 52B(L), 52F (R) and 52F (L), and the second connecting part 53B, which vibrate substantially in the same phase and the same amplitude. As such, since the diaphragm 10 is supported over a large area and given the vibration that has substantially the same phase and the same amplitude, the vibration of the voice coil support part 40 may be transmitted substantially in the same phase to the planar diaphragm 10 with large area.

As shown in FIG. 11 (b), in the vibration direction converter part 50, a pair of the connecting parts 53B, 53D(R) and 53D(L) and the third link parts 51C(R) and 51C(L) are disposed in a width direction and parallel respectively. The first link parts 51A(R) and 51A(L) are formed in a biforked shape, and the hinge parts 52C(R) and 52C(L) to the second link parts 51B(R) and 51B(L) are formed at the middle parts of the first link parts 51A(R) and 51A(L). The second link parts 51B(R) and 51B(L) and the connecting part 53C are placed between a pair of the connecting parts 53B, 53D(R) and 53D(L) and the third link parts 51C(R) and 51C(L), which are disposed in a width direction and parallel.

With link parts configured with a single sheet-shape (plate shape) component as described above, the diaphragm 10 can be vibrated and supported by a face, and thereby the whole diaphragm 10 can be vibrated substantially in the same phase and divided vibration may be restrained.

Further, as shown in FIG. 11(b), in the vibration direction conversion part 50 of this embodiment, the first link parts 51A(R) and 51A(L), and the second connecting parts 53B are formed by folding the whole single sheet-shape component forming the link parts in a projecting-trapezoid shape, while the second link parts 51B(R) and 51B(L), and the static connecting part 53C are formed by folding a partially taken-out portion of this plate component.

A method of forming this vibration direction converter part 50 is described with reference to FIG. 13. According to one forming method, this vibration direction convertor part 50 is formed by joining a plurality of sheet-shape components 501, 502 (for example, two components) as shown in FIG. 13(a). The first connecting parts 53A(R) and 53A(L), the first link parts 51A(R) and 51A(L), the second link parts 51B(R) and 51B(L), the second connecting parts 53B and the static connecting part 53C are formed in one sheet-shape component 501, while the connecting parts 53D, the third link parts 51C(R) and 51C(L) and the connecting parts 53E are formed in another sheet-shape component 502. And, the third link parts 51C(R) and 51C(L) and the connecting parts 53D(R) and 53D(L) are formed along the first link parts 51A(R) and 51A(L) and the second connecting parts 53B, and an opening 502A is formed in the sheet-shape component 502 corresponding to the second link parts 51B(R) and 51B(L) and the static connecting part 53C.

In this embodiment, the opening 502A, formed in another sheet-shape component 502 corresponding to the second link parts 51B(R) and 51B(L) and the static connecting part 53C of one sheet-shape component 501, is formed so as to expand inward from ends of another sheet-shape component 502. This configuration may prevent the second link parts 51B(R) and 51B(L), and the static connecting part 53C from contacting another sheet-shape component 502, and thus a smooth movement of the link body may be performed.

The two sheet-shape components 501 and 502, which are formed with the continuous member 50P and the rigid member 50Q, are applied with their continuous members 50P, 50P face-to-face as shown in FIG. 13(b). According to this arrangement, the continuous members 50P, 50P are integrated, and thereby hinge parts 52 may smoothly bend. Also in this case, the recessed portion or the notch part 76 is formed as the contact avoiding part 70 near the hinge part 52.

Further, the slant face as shown in FIG. 5(c) is formed at the end of each link part near each hinge part. The slant face is formed such that the link parts do not interfere with each other when they bend at the hinge parts. Thus the link parts can efficiently bend at the hinge parts.

In another configuration example, the above-mentioned sheet-shape component 501 and the sheet-shape component 502 are integrally formed with the sheet-shape component 502 connected to the end of the sheet-shape component 501 as shown in FIG. 13(c). The vibration direction converter parts 50 shown in FIGS. 11 and 12 may be obtained by folding the integrated components along a folding line f in the direction of an arrow. In this example, the vibration direction converter part 50 may be simply configured by applying resin material forming the rigid member 50Q to the whole face of the continuous member 50P that is a sheet-shaped member, cutting in a V-shape to form each hinge part and the slant faces at both sides thereof, and then forming the above-mentioned notch part 50S and opening 502A and hardening the resin material in the same way as shown in FIG. 10.

Further, when forming each hinge part and the slant faces 51t and 53t at the both sides thereof, the rigid member 50Q may be formed with the resin material and molded at the same time. It is preferable that a cross-sectional V-shape groove or a recessed portion is preliminarily formed in a die, which is used to mold the rigid member 50Q.

In the vibration direction converter part 50 shown in FIGS. 8 to 13, since the link body of the vibration direction converter part 50 may be configured with a single integral component with respect to two opposing voice coil support parts 40, the assembly operation may be simplified as well when configuring a speaker unit provided with a pair of driving parts. Further, provided with the static connecting part 53C, the hinge parts 52D(R) and 52D(L) may be held at fixed positions even if they are not particularly supported by the frame 12 corresponding to opposing vibrations of the voice coil support parts 40 (a plurality of the voice coil support parts 40 vibrate in directions opposite to each other), and thus the vibration direction converter part may be simply built into a speaker unit.

Further, in the vibration direction converter part 50, since the right side first link part 51A(R) and the third link parts 51C(R), and the left side first link part 51A(L) and the third link parts 51C(L) form parallel links as the link body, the second connecting parts 53B fixed to the diaphragm 10 may be stably moved in parallel in the Z-axis direction corresponding to the opposing vibrations of the voice coil supporting parts 40. Accordingly, it is possible to apply stable vibrations to the planar diaphragm 10.

According to this speaker unit 1U (1A, 1B), when an audio signal SS is inputted, the voice coil support part 40 vibrates along the magnetic gap 20G formed in a direction different from the vibration direction admissible for the diaphragm 10, and this vibration is direction-converted by the vibration direction converter part 50 and transmitted to the diaphragm 10, and thereby vibrating the diaphragm 10 to emit a sound in the sound emission direction SD corresponding to the audio signal SS.

Since the direction of the magnetic gap 20G is configured to cross the vibration direction of the diaphragm 10 and the thickness direction of the speaker unit 1U (1A, 1B), increasing the driving force of the magnetic circuit 20 or the vibration of the voice coil 30 does not directly affect the size of the speaker unit 1U (1A, 1B) in the thickness direction (Z-axis direction). Accordingly, it is possible to make the speaker unit 1U (1A, 1B) thin while pursuing making a louder sound.

Further, since the vibration direction converter part 50 converts the vibration direction of the voice coil support part 40 and transmits the vibration to the diaphragm 10 through the mechanical link body, transmission efficiency of vibration is high. In particular, in the speaker unit 1U (1A, 1B) shown in FIGS. 7 to 8, since angle variation of the first link parts 51A and the second link parts 51B is produced by the vibration of the voice coil support part 40 and reaction force of the static part 100, vibration of the voice coil support part 40 may be more securely transmitted to the diaphragm 100. Accordingly, the speaker unit 1U (1A, 1B) may produce preferable reproducing efficiency.

Further, in the speaker unit 1U (1A, 1B) shown in FIGS. 2, 7, and 8, provided with the connecting part 60, interval in the Z-axis direction may be provided between the position of the end 40A of the voice coil support part 40 and the position of the end 50A of the vibration direction converter part 50. As such, the length (height) in the Z-axis direction (thickness) of the magnetic circuit 20 can be included in the length in the Z-axis direction of the vibration direction converter part 50, and thus the speaker unit 1U (1A, 1B) may be made thin while securing a sufficient length in the Z-axis direction for the magnetic circuit 20, which is required to secure a driving force. Further, provided with the connecting part 60, a necessary length of the direction converter part 50 (length of link parts 51) may be sufficiently secured even if the speaker unit 1U (1A, 1B) is made thin, and thus the amplitude of vibration of the diaphragm 10 may be comparatively large.

More particularly, a bottom portion 61 of the connecting part 60 is configured to slide over the bottom portion 12A of the frame 12 or the static part 100 with a predetermined distance therefrom, and thereby vibration of the voice coil support part 40 may be stabilized. Further, the end of the vibration direction converter part 50 can be linearly moved, and thus the end of the vibration direction converter part 50 connected to the diaphragm 10 can be securely and stably moved.

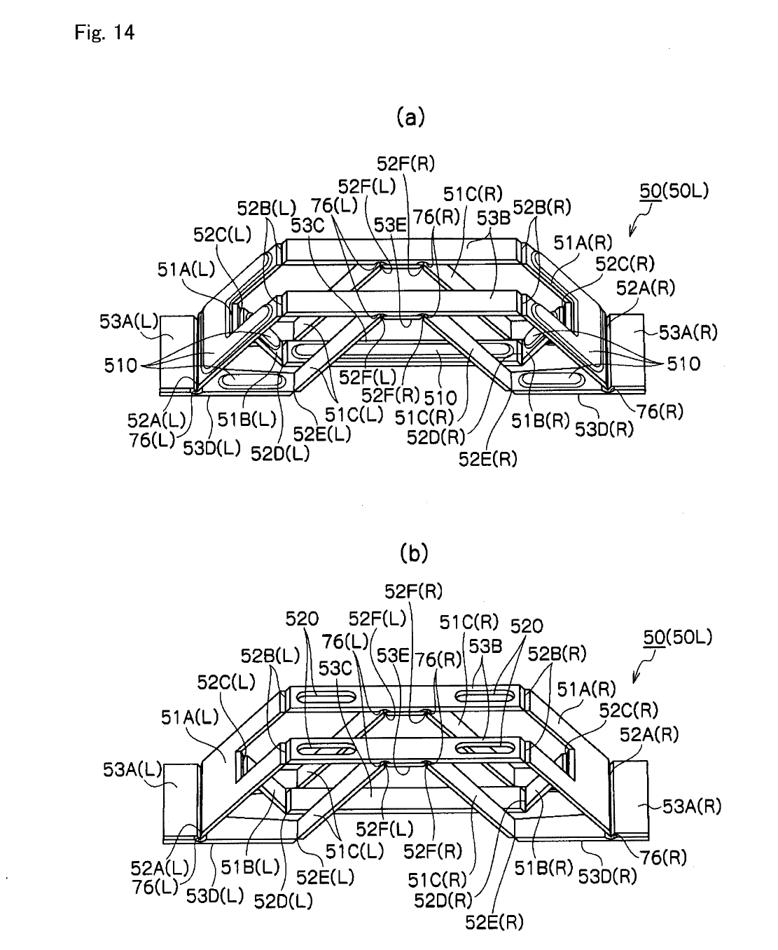

The vibration direction converter part 50 shown in FIG. 14 is a modified example of the embodiment shown in FIG. 11. In one example shown in FIG. 14(a), a projecting portion 510 is provided on the link part that are subject to bend by opposing vibrations of the voice coil supporting parts 40, thereby rigidity of the link part can be increased. As shown in the drawing, the first link part 51A(R) and 51A(L), the second link parts 51B(R) and 51B(L), the connecting parts 53D(R) and 53D(L) and the connecting part 53C are provided with the projecting portion 510 respectively. Further, in one example shown in FIG. 14(b), openings 520 are provided in the link part that need no particular strength, weight of the vibration direction converter part can be decreased. In the drawing, the connecting part 53B includes the openings 520. The weight reduction of the vibration direction converter part is effective to broaden a reproduction characteristic or increase amplitude and a sound pressure level of a sound wave corresponding to predetermined voice currents.

### (Power Feed Structure)

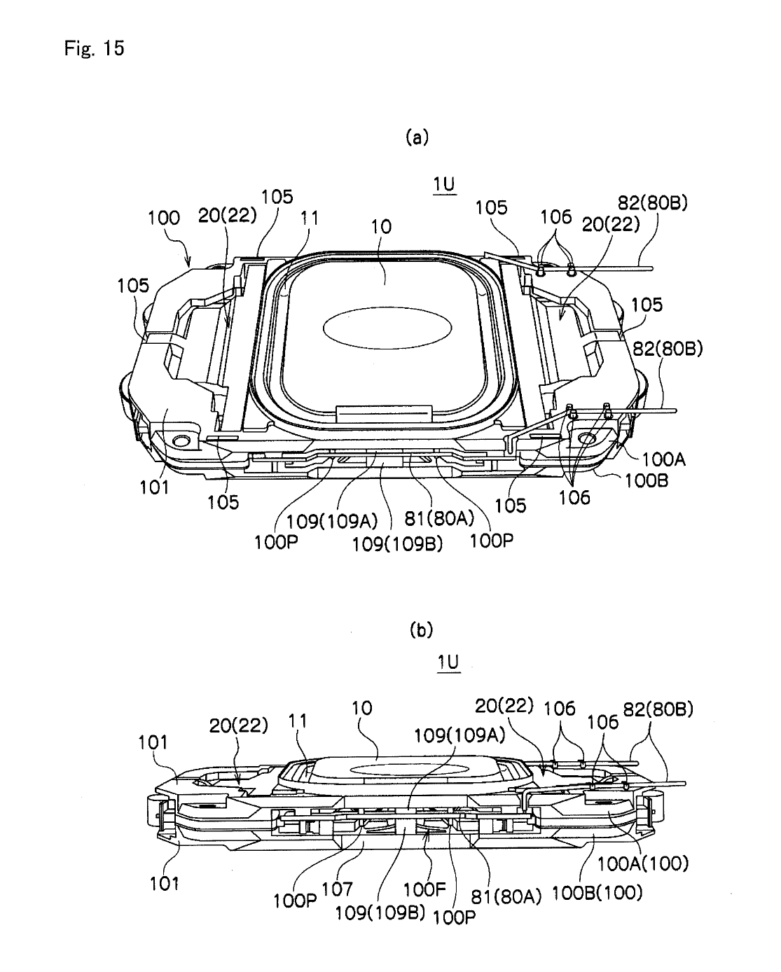

FIGS. 15 to 24 are views illustrating a power feed structure of the speaker unit according to one embodiment of the present invention. The speaker unit according to the embodiment of the present invention, with reference to the above-mentioned basic structure, includes the diaphragm 10, the static part 100 vibratably supporting the vibrating body 10 and the driving part 14, provided in proximity of the static part 100, vibrating the diaphragm 10 in response to an audio signal, while the driving part 14 includes a plurality of the voice coils 30, 30 vibrating in a direction different from the diaphragm 10 upon the inputted audio signal, a plurality of the magnetic circuits 20, 20 having the magnetic gaps 20G, 20G in which the voice coils 30, 30 are arranged respectively and the rigid vibration direction converter part 50, which is obliquely disposed with respect to the vibration directions of the voice coils 30, 30 and the diaphragm 10, transmits the vibrations of the voice coils 30, 30 to the diaphragm 10.

Further, terminal parts 81, 81 common to a plurality of the voice coils 30, 30, which extend from one voice coil 30 to another voice coil 30 of the plurality of the voice coils 30, 30 in order to input the audio signal to the plurality of the voice coils 30, 30, are provided on the static part 100. When a pair of the voice coils 30, 30 are provided, a pair of these terminal parts 81, 81 are provided and each one end of the pair of the voice coils 30, 30 is connected to one terminal part 81, while each another end of the pair of the voice coils 30, 30 is connected to another terminal part 81. Provided with common terminal parts 81, 81 to a plurality of the voice coils 30, 30, a space for arranging the terminal parts may be reduced to be less than when the terminal parts are provided on one and another end of each voice coil 30. The space required for the terminal parts is reduced, and thereby a small sized or thin speaker unit may be produced.

Wirings (first wiring 80A) are formed at the terminal parts 81, 81 to electrically connect a plurality of the voice coils 30, 30. As such, the audio signal may be supplied to each of the plurality of the voice coils 30, 30 via the wirings when the audio signal is inputted to the terminal parts 81, 81.

FIGS. 15(a) and 15(b) are external perspective views of the speaker unit according to the embodiment of the present invention. The static part 100 of the speaker unit 1U is configured with a first configuring member 100A and a second configuring member 100B. The second configuring member 100B is a frame arranged on the side of the vibration direction converter part 50, and supports a part of the vibration direction converter part 50. The terminal parts 81, 81 are arranged between the first configuring member 10A and the second configuring member 100B. The first configuring member 100A is a frame arranged on the side of the diaphragm 10, and supports the diaphragm 10 via the edge 11. Further, the first configuring member 100A and the second configuring member 100B support the magnetic circuit 20. The first configuring member 100A supports one magnetic pole member (yoke 22) that is one side of the magnetic circuit 20. The second configuring member 100B supports another magnetic pole member (yoke 22) that is another side of the magnetic circuit 20. Thereby, a magnetic gap with a prescribed interval is formed between both magnetic pole members while the first configuring member 100A and the second configuring member 100B are coupled.

An opening 100F is configured with a recessed portion formed between the opposing faces of the first configuring member 100A and the second configuring member 100B. Projection parts 109 (109A, 109B), supporting the terminal parts 81, 81, are formed at the first configuring member 100A and the second configuring member 100B, and the terminal parts 81, 81 are sandwiched between the projection part 109A and the projection part 109. As such, when the first configuring member 100A and the second configuring member 100B are coupled, the terminal parts 81, 81 may be concurrently stably fixed.

Further, as shown in FIG. 15, the static part 100 includes an outer-periphery frame 101 surrounding the magnetic circuit 20 and a bottom face part 107, and the terminal parts 81, 81 are formed in a shape along the outer-periphery frame 101 and are mounted on the outer-periphery frame 101. As such the terminal parts 81, 81 are not projected out of the outer-periphery frame 101 of the static part 100, the device can be made compact. Further, with the terminal parts 81, 81 mounted on the outer-periphery frame 101, the terminal parts 81, 81 may be stably fixed, and thereby bad connection with the voice coils 30, 30 may be avoided.

The terminal parts 81, 81 are formed in a shape having a long axis extending along one voice coil 30 to another voice coil 30 and a short axis crossing the long axis. With this longitudinal shape, efficiency of installation space may be improved.

The terminal parts 81, 81 may be arranged inside the outer-periphery frame 101. Therefore the terminal parts 81, 81 may be arranged without affecting shape or size of the outer circumference of the speaker unit. Further, the terminal parts 81, 81 may be arranged inside the outer-periphery frame 101 by using a technique of insert molding as necessary.

The respective outer-periphery frames 101, 101 of the first configuring member 100A and the second configuring member 100B include the above-mentioned openings 100F between faces opposing the voice coil 30, and the terminal parts 81, 81 are arranged in the opening 100F. In this case, the terminal parts 81, 81 act as reinforcing parts reinforcing the opening 100F of the static part 100.

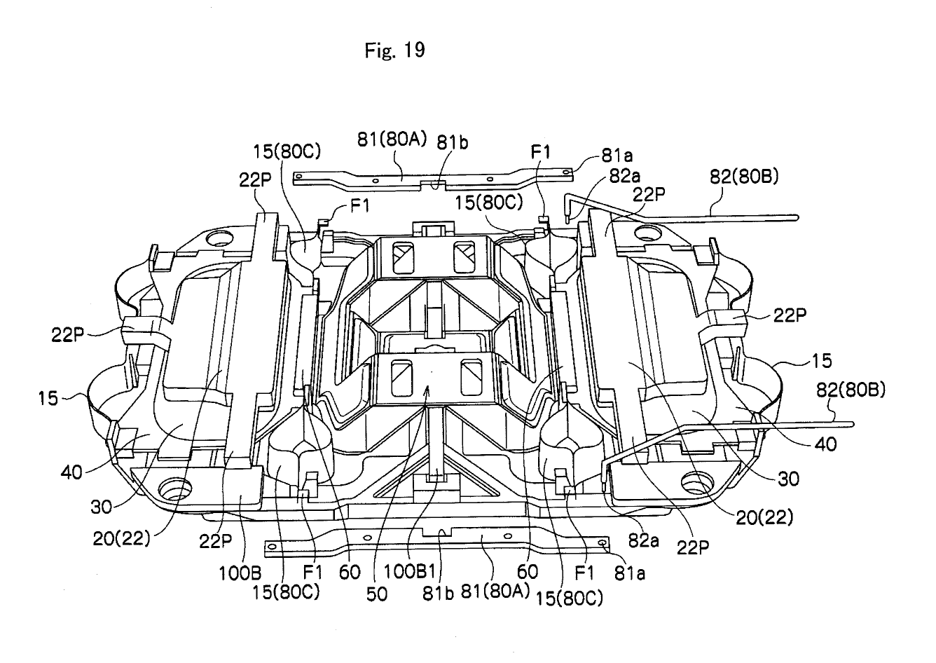

The terminal parts 81, 81 are provided with a connecting part 81a to wirings 82, 82 (second wiring 80A) that are electrically connected to outside (see FIG. 19), and a wiring (first wiring 80A) of the terminal parts 81, 81 and a wiring 82 (second wiring 80B) are electrically connected at the connecting part 81a. The wiring 82 (second wiring 80A) is fixed on the side face of the static part 100 and connected to the terminal parts 81, 81. The outer-periphery frame 101 of the static part 100 includes a side face on which the wiring 82 (second wiring 80B) is mounted, and guiding parts 106, 106 guiding the wirings 82, 82 are formed on the side face of the static part 100.

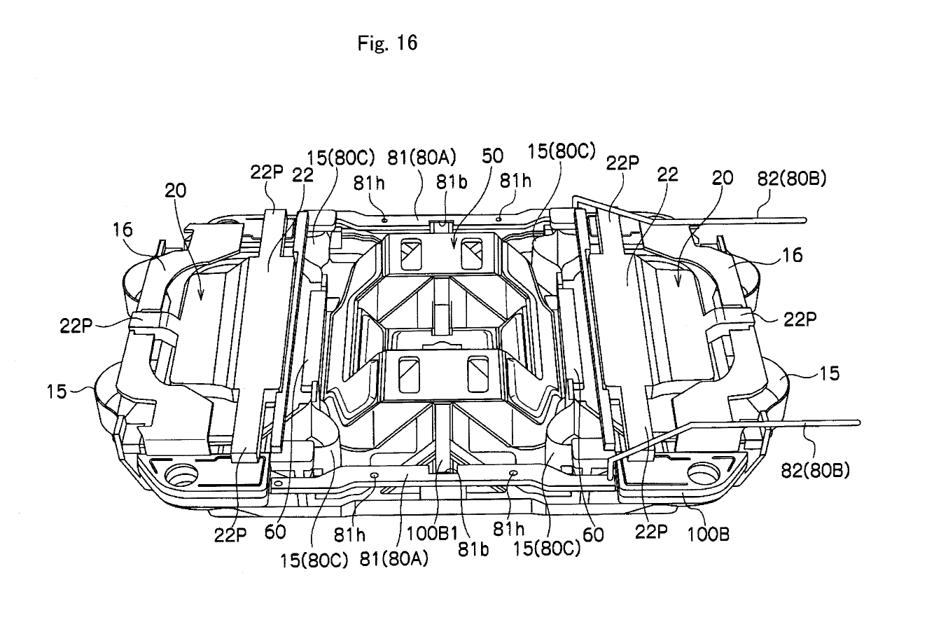

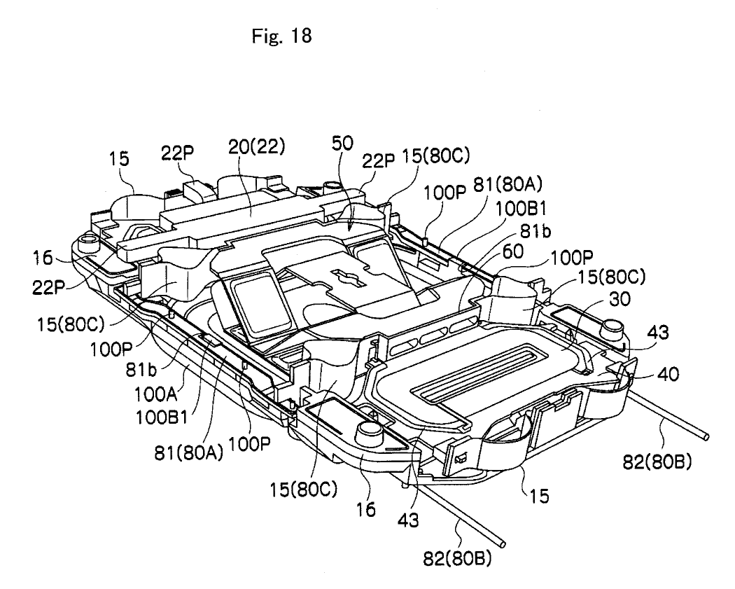

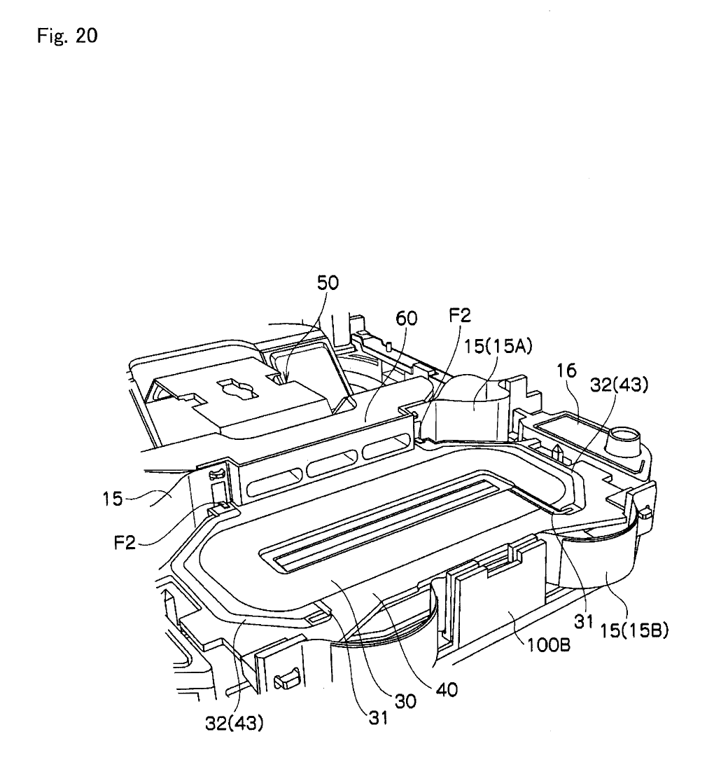

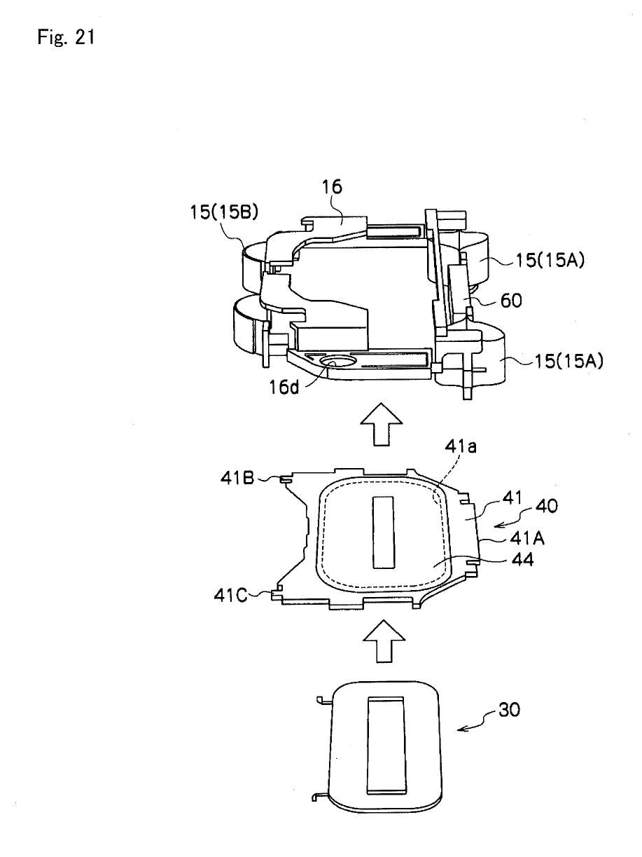

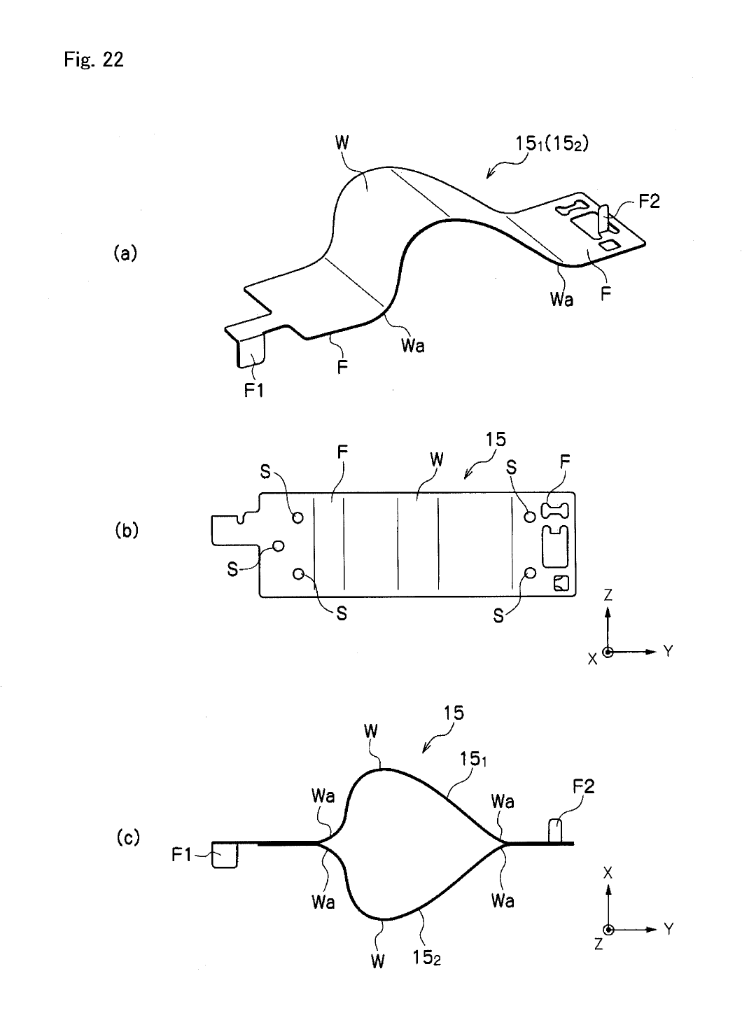

FIG. 16 is a perspective view illustrating an inner structure of the speaker unit (excluding the first configuring member 100A); FIG. 17 is a plan view illustrating an inner structure of the speaker unit (excluding the second configuring member 100B); FIG. 18 is a perspective view illustrating an inner structure of the speaker unit (excluding the second configuring member 100B); FIG. 19 is a perspective view illustrating an inner structure of the speaker unit (illustration of connected state of wiring); FIG. 20 is a partial enlarged view illustrating an inner structure of the speaker unit; FIG. 21 is a view illustrating installation structure of the voice coil; and FIG. 22 is a view illustrating components of the holding part.

The yoke 22 of the magnetic circuit 20 is provided with a projection part 22p to support the yoke 22 at the first configuring member 100A and the second configuring member 100B. The projection part 22p is engaged with a receiving part 105 provided at the first configuring member 100A and the second configuring member 100B.

Either one of the first configuring member 100A and the second configuring member 100B is provided with a positioning pin 100P positioning the terminal parts 81, 81 (see FIGS. 17 and 18) and the terminal part 81 may be arranged at a prescribed position with respect to the static part 100 with the positioning pin 100P inserted into a hole 81h (see FIG. 16) of the terminal parts 81, 81. Further, according to the example shown in the drawings, a recessed portion 81b is formed at the side portion of the terminal part 81, 81, and the terminal parts 81, 81 are positioned at the second configuring member 100B with this recessed portion 81b engaged with a projecting portion 100B1 formed at the second configuring member 100B.

The voice coil 30 is an annular conducting member formed in a tabular shape, and this conducting member is supported by a rigid base (voice coil support part 40). The voice coil 30 or the voice coil support part 40 is unitized by a mounting unit 16 and mounted between the first configuring member 100A and the second configuring member 100B. Further, the voice coil 30 or the voice coil support part 40 is mounted at the mounting unit 16 via the holding part 15, and the voice coil 30 or the voice coil support part 40 is supported by the static part 100 via the holding part 15 with the mounting unit 16 mounted between the first configuring member 100A and the second configuring member 100B. Further, the mounting unit 16 is integrated with the connecting part 60, and the voice coil 30 or the voice coil support part 40 are connected to the vibration direction converter part 50 via the connecting part 60.

A voice coil lead wire 32 (see FIG. 19) connected to a lead wire 31 is formed on the surface of the voice coil support part 40 (base) supporting the voice coil 30. The voice coil lead wire 32 is a conducting layer 43, which is pattern-formed outside of the conducting member of the voice coil 30 so as to surround the conducting member. A pair of the conducting layers 43 is placed such that the voice coil lead wire 32 electrically connects the conducting member of the voice coil 30 and the holding part 15 and functions as a junction wire for inputting the audio signal to the conducting member of the voice coil 30.

A wiring (third wiring 80C), which electrically connects the voice coil 30 and the terminal part 81, is formed on the holding part 15. The end of the terminal parts 81, 81 and the wiring (third wiring 80C) are electrically connected, the wiring (third wiring 80C) of the holding part 15 and the voice coil lead wire 32 are connected, and the wiring 82 (second wiring 80B) is connected to the terminal part 81, 81. Thereby, the audio signal is inputted from outside to the voice coil 30. The wiring (third wiring 80C) may be formed with the holding part 15 as the conducting member. Further, wiring may be separately formed on the holding part 15. Also, the holding part 15 in itself may be formed by using a wiring substrate. Connection between the wiring 82 (second wiring 80B) and the terminal part 81, 81 is made by electrical connection between an end 82a of the wiring 82 and a connecting part 81a of the terminal parts 81, 81.

The holding part 15 has rigidity in a vibration direction of the diaphragm 10 and has a deformable shape in a vibration direction of the voice coil 30. In the example shown in the drawings, the holding part 15 has a side face linearly extending in the vibration direction (X-axis direction) of the diaphragm 10 and has a curved cross-sectional shape in the vibration direction of the voice coil 30. As such, the holding part 15 may restrict the vibration of the voice coil 30 in one axis direction (X-axis direction) and the vibration of the voice coil 30 in other directions is restrained.

The holding part 15, which supports the voice coil 30 at the static part 100 directly or via other member vibratably in the vibration direction of the voice coil 30, has the first holding part 15 (15A) and the second holding part 15 (15B). The first holding part 15 (15A) is arranged on the side of the vibration direction converter part 50 of the voice coil 30, and the second holding part 15 (15B) is arranged on the side opposite to the vibration direction converter part 50 of the voice coil 30.

The first holding part 15 (15A) is arranged on the right and left sides of the connecting part 60 between the connecting part 60 and the static part 100, and the second holding part 15 (15B) is arranged on the right and left sides of the voice coil 30 on the opposite side of coupling to the connecting part 60, and the first holding part 15 (15A) and the second holding part (15B) substantially symmetrically support the voice coil 30 at the static part directly or via other member. More particularly, in the second holding part 15 (15B), the central part thereof is supported by the static part directly or via other member, and both ends thereof are connected to the right and left ends of the voice coil.

FIG. 21 is a view illustrating an attachment structure of the voice coil. The voice coil 30, winding a conducting member, is supported by the voice coil support part 40, and the voice coil support part 40 is supported by the mounting unit 16 via the holding part 15. The voice coil support part 40 includes a voice coil attaching point 41a having an opening in the base 41 made of a tabular insulating material, and one side of the opening is covered with a protection film 44. The voice coil 30 is attached in this voice coil attaching point 41a.

Each of outer ends of a pair of the first holding part 15 (15A) is coupled to the mounting unit 16 on one side of the mounting unit 16, while inner end parts of a pair of the first holding part 15 (15A) are connected to the connecting part 60. The second holding part 15 (15B), a single component, is mounted on the mounting unit on another side of the mounting unit 16, and the central part of this second holding part 15 (15B) is connected to the mounting unit 16 while both ends of the second holding part 15 (15B) are mounted on both ends 41B, 41C of the voice coil support part 40. An end 41a of the voice coil support part 40 is connected to the connecting part 60. The connecting part 60 is a member connecting the voice coil 30 and the vibration direction converter part 50. A connection hole 16d is a fitting hole configured to connect the mounting unit 16 to the static part.

With reference to FIG. 22, a forming example of the holding part 15 is more specifically described. As shown in the drawing, the holding part 15 is formed by joining two configuring members 15₁, 15₂. FIG. 22(a) is a perspective view illustrating a single component of the configuring members 15₁, 15₂, FIG. 22(b) is a side view of the holding part 15, and FIG. 22(c) is its plan view. The configuring members 15₁(15₂) of the holding part 15, contacting each other at the tabular portion F, have first curved parts W and second curved parts Wa. Tabular portions F, F are provided on both ends, and connecting parts F1, F2 are provided in a direction perpendicular to the tabular portion F. A plurality of configuring members 15₁, 15₂ are conductive metal materials and applied by welding. In one example shown in the drawing, the configuring members 15₁, 15₂ are welded by applying a spot welding to the tabular portion F facing each other. In this example, spot welding is applied to a plurality of points of the tabular portions F, F at both ends (symbols s are spot welding points). Since the holding part 15 is formed with two configuring members 15₁, 15₂ applied each other, the holding part 15 may be prevented from twisting or generating a resonance

A connecting part F1 to the terminal part 81, 81, which the holding part 15 includes, extends in a direction crossing the vibration direction (Z-axis direction) of the diaphragm 10, and is tabularly formed to contact with the terminal parts 81, 81. Also, a connecting part F2 to the voice coil lead wire 32, which the holding part 15 includes, extends in a direction crossing the vibration direction (Z-axis direction) of the diaphragm 10, and is tabularly formed to contact with the end of the voice coil lead wire 43.

### [Cabinet]

### (Cabinet Configuration Example)

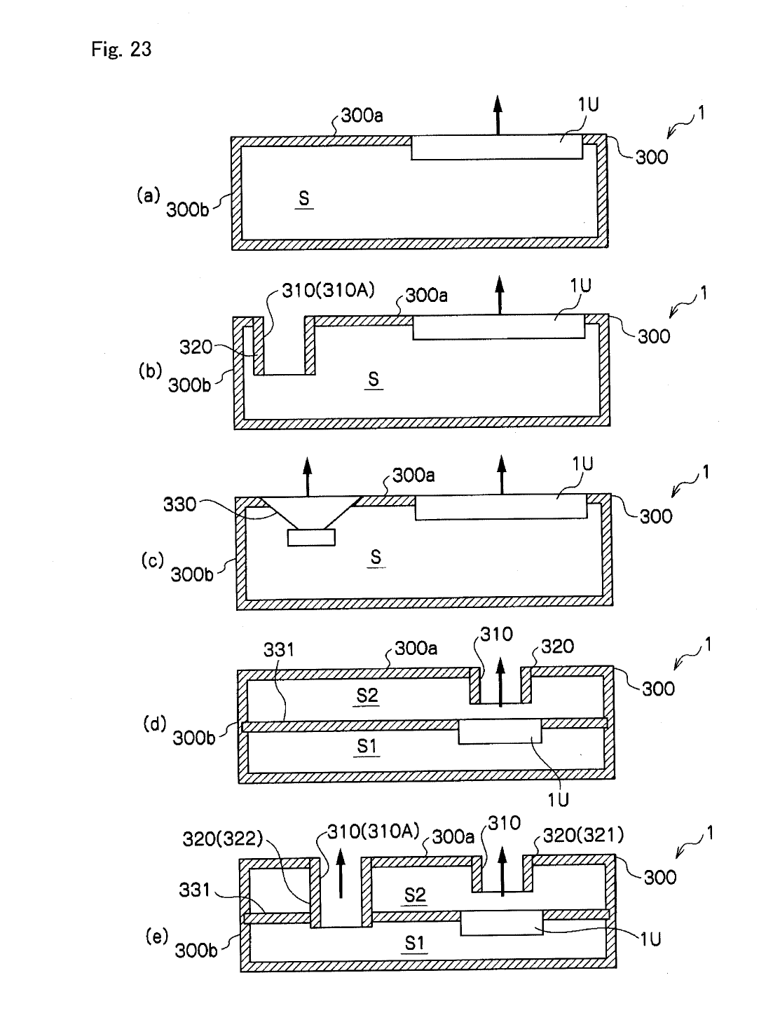

FIG. 23 is a view illustrating applied to the speaker device according to one embodiment of the present invention. Configurations of a cabinet are not limited to examples shown here.

A cabinet 300 of a speaker device 1 according to an embodiment of the present invention has a front face (a face facing the sound emission direction of a speaker unit 1U) 300a and a side face (faces other than the face facing the sound emission direction of a speaker unit 1U) 300b, and prescribed space S (S1, S2) is fat tied between the cabinet 300 and the speaker unit 1U. This space S is basically formed to surround a sound wave emitted from the side opposite to the sound emission side of the diaphragm 10 of the speaker unit 1U, and thereby an acoustic output of the speaker device 1 is prevented from fading due to interference between the sound wave emitted to the opposite side and the sound wave emitted to the sound emission side. The space S surrounded by the speaker unit 1U and the cabinet 300 may be sealed as shown in FIGS. 23(a) and 23(c), or may be opened to outside in part with an opening 310 provided on a front face 300a (sound emission direction side of the speaker unit 1U) or on a side face 300b (other than the sound emission direction side of the speaker unit 1U) of the cabinet 300 as each example shown in FIG. 23(b). Further, although not shown, a sound absorbing material may be placed in the cabinet 300 as necessary.

Although the sound wave emitted from the side opposite to the sound emission side of the diaphragm 10 may be securely confined if the space S is sealed, this example may suppress movement of the diaphragm 10 by stiffness of the air with air in the rear of the speaker unit confined and may increase a lowest resonance frequency f0 of the speaker unit 1U (reproduction band of a low frequency range is limited). However, in the speaker device 1 according to the present invention, a volume of cabinet 300, which does not affect the movement of the diaphragm 10, may be obtained with the speaker unit 1U made thin without forming a large depth in the cabinet 300.

Further in the example of the drawing, although the depth of the cabinet 300 (depth in the vibration direction of diaphragm 10) is formed comparatively large with respect to the thickness (thickness in the vibration direction of diaphragm 1) of the speaker unit 1U, the depth of the cabinet 300 may not be limited to this example and may be formed comparatively small with respect to the thickness of the speaker unit 1U. In this case, the thickness of the speaker device 1 (thickness in the vibration direction of the diaphragm 10) may be further comparatively small, and thus the speaker device 1 may be made thin and small as well.

On the other hand, with the space S opened, it is possible to improve acoustic characteristic by positively making use of the sound wave (rear sound wave) emitted to the side opposite to the sound emission side of the diaphragm 10. To this end, the opening 310 is made as a tubular opening (acoustic port) 310A. In the example shown in FIG. 23(b), a sound emitting part 320 communicates between inside and outside of the cabinet 300 and guides to outside the sound wave emitted from the side opposite to the sound emission side of the diaphragm 10. The sound emitting part 320 is provided on a front face 300a or a side face 300b of the cabinet 300. Provided with this sound emitting part 320, a reproducing frequency range in a low frequency range may be widened and a uniform reproducing frequency characteristic may be produced.

In the embodiment shown in FIG. 23(c), a passive diaphragm 330, vibrating corresponding to the drive of the speaker unit 1U, is mounted on or in the cabinet 300 adjacent to the speaker unit 1U. The passive diaphragm 330 (diaphragm provided in a speaker unit having only a vibration system and not a drive system) mounted on the front face 300a of the cabinet 300 instead of the above-mentioned tubular opening (acoustic port) 310A. This may also makes it possible to improve a reproducing frequency characteristic as in the above-mentioned embodiment.

In the embodiment shown in FIGS. 23(d) and 23(e), the cabinet 300 has a wall portion 331 partitioning the inside space into a first space S1 and a second space S2, and the speaker unit 1U is mounted on this wall portion 331 such that a part of the speaker unit 1U is arranged in the first space S1. In the embodiment shown in FIG. 23 (d), the sound emitting part 320, communicating the second space S2 with outside and emitting the sound wave of the speaker unit 1U, is provided on the front face 300a or the side face 300b of the cabinet 300. In the embodiment shown in FIG. 23 (d), the rear side of the speaker unit 1U forming the first space S1 is sealed, and with the second space S2 and the sound emitting part 320 provided on the front face of the diaphragm of the speaker unit 1U, it is possible to improve the above-mentioned reproducing frequency characteristic while using advantage of sealed structure. Further, since the rear side of the speaker unit 1U forming the first space S1 is sealed, reproduction frequency in a prescribed reproducing frequency range has a bandpass characteristic, and thus frequency characteristic of output sound pressure in the frequency range may be improved.

In the embodiment as shown in FIG. 23(e), the cabinet 300 has the wall portion 331 partitioning the inside space into the first space S1 and the second space S2. The speaker unit 1U is mounted on this wall portion 331 such that a part of the speaker unit 1U is arranged in the first space S1. The second space S2 is disposed in the opposite side of the speaker unit 1U. The first sound emitting part 320 (321) guiding outside the sound wave which the speaker unit 1U emits in the side of the second space S2 and the second sound emitting part 320 (322) guiding outside the sound wave the speaker unit 1U emits in the side of the first space S1 are provided on the front face 300a or the side face 300b of the cabinet 300. The second sound emitting part 322 has a tubular shape, which extends from outside to the space S1 passing through the second space S2 and the wall portion 331. This example is configured to add an advantage of emitting the rear sound wave by using the sound emitting part 320 (322) to the example shown in FIG. 23 (d).

### (Examples of the Arrangement of a Speaker Unit in a Cabinet)

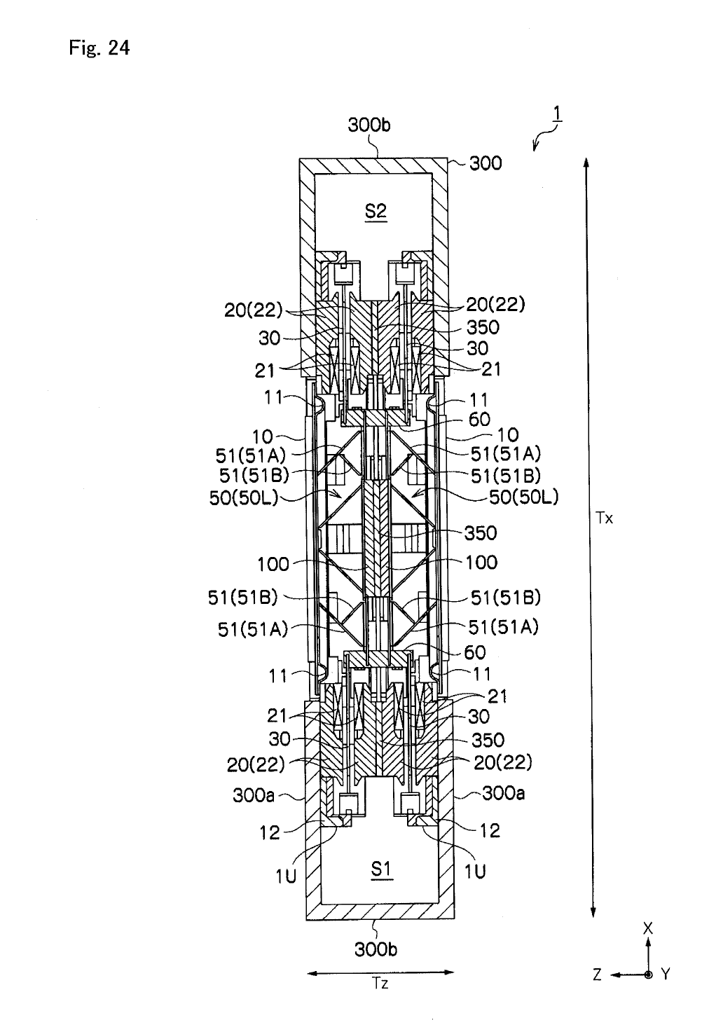

FIGS. 24 to 26 are views illustrating examples of the arrangement of a speaker unit in a cabinet. Here, a plurality of diaphragms 10 disposed oppositely is driven by a plurality of speaker units 1U, 1U or a single speaker unit 1U.

An example shown in FIG. 24 has a plurality of speaker units 1U. The plurality of speaker units 1U are oppositely mounted on the outer periphery face of a cabinet 300 such that the sound emission faces face different directions each other, and the sound emission faces of the speaker units 1U are configured to face the outside. In the example shown in the drawing, two speaker units 1U are oppositely disposed each other such that the sound emission faces face different directions each other, and each static part 100 is connected directly or via other members whereby a thin both face emission type speaker device is formed. As such, when two speaker units 1U are driven by a single audio signal, the vibrations caused by driving and transmitted to both speaker units 1U, 1U cancel each other out, whereby a stable driving can be achieved. In the aforementioned speaker unit 1U that can achieve the reduction in thickness, there is little increase in the thickness of the speaker device even when two diaphragms are oppositely disposed and connected, and the spaces S1, S2 in the cabinet 300 are formed lateral to the speaker units 1U, 1U whereby a speaker device with the cabinet 300 that is small in depth (thickness) can be obtained. Since the sufficient volume of the spaces S1, S2 can be secured by using the space lateral to the speaker units 1U, 1U even when the depth (thickness) of the cabinet 300 is reduced, the vibration of the diaphragm 10 is prevented from being suppressed by the effect of the stiffness of air in the cabinet 300 even when a sealed type cabinet 300 is formed.

Further, in this embodiment, a damping material 350 can be provided between the speaker units 1U, 1U. As such, the vibration having an effect on each speaker unit 1U is absorbed by the damping material 350, whereby more stable driving of the speaker device can be achieved.

Further, in this embodiment, the vibration direction converter part 50 has the link part 51 as the first link part 51A, and a second link part 51B as the link body 50 L between the first link part 51A and the static part 100 as described above, and the aforementioned damping material 350 is mounted to a part of the static part 100 supporting the second link part 51B. In such an embodiment, since the damping material 350 is mounted between the static parts 100, 100 supporting both link bodies 50L, 50L, when a speaker device is driven, the unstable driving of the speaker device and the occurrence of abnormal sound, which are caused by the vibrations of the vibration direction converter parts 50 having an effect on each other, can be prevented. Further, when the aforementioned mechanical impedance is substantially the same, reaction forces that are received from the diaphragm 10 and are applied on each link part of the vibration direction converter part 50 can cancel each other out. The action itself of the vibration direction converter part 50 makes it possible to achieve a stable action of vibration direction conversion since there is little position variation in the static parts 100, 100 by adapting the static parts 100, 100 supporting both the vibration direction converter parts 50, 50 so as to have contact with each other directly or via other members.

Further, the damping material 350 mounted between the aforementioned static parts 100, 100 has flexibility or comparatively large compliance while the voice coil 30 has the capability of cutting off the high frequency vibration from the vibration that is transmitted to the diaphragm 10 via the vibration direction converter part 50, whereby the vibration of the vibration direction converter part 50 can be prevented from causing resonance in the static part 100 which generates a turbulent reproduced sound pressure frequency characteristic of the speaker unit 1U and the occurrence of harmonic distortion.

Further, as shown in the example of the drawing, the connecting portions 60, 60 provided on the speaker units 1U, 1U may be connected to each other directly or via the damping material 350. When the connecting portions 60, 60 are connected directly or via other members, the occurrence of unwanted vibration can be prevented, and thus the acoustic characteristic can be improved.

Hereinafter, the width of the cabinet 300 of the speaker device 1 shown in FIG. 24 is described. Firstly, the width Tz of the cabinet 300 in the vibration direction of the diaphragm 10 (Z axial direction in the drawing) is prescribed by the width of the vibration direction (Z axial direction) of the diaphragms 10 of the oppositely disposed vibration direction converter parts 50, 50 in a plurality of the speaker units 1U, 1U. More specifically, the width Tz of the cabinet 300 in the vibration direction (Z axial direction) of the diaphragm 10 is substantially the same as the width of the vibration direction converter parts 50, 50 in the vibration direction (Z axial direction) of the diaphragm 10.

Further from another point of view, the width Tz of the cabinet 300 in the vibration direction of the diaphragm 10 (Z axial direction in the drawing) is prescribed by the width of the vibration direction (Z axial direction) of the diaphragms 10 of the oppositely disposed magnetic circuits 20, 20 in a plurality of the speaker units 1U, 1U. More specifically, the width Tz of the cabinet 300 in the vibration direction (Z axial direction) of the diaphragm 10 is substantially the same as the sum of the width of the magnetic circuits 20, 20 in the vibration direction (Z axial direction) of the diaphragm 10 and the width of the spaces S1, S2 formed between the cabinet 300 and the speaker units 1U, 1U. Although not shown in the drawing, the width Tz of the cabinet 300 in the vibration direction (Z axial direction) of the diaphragm 10 may be substantially the same as the width of the magnetic circuits 20, 20 in the vibration direction (Z axial direction) of the diaphragm 10.

As such, in the speaker device 1, the width of vibration direction converter parts 50, 50 is decreased and thus the width of the magnetic circuits 20, 20 is decreased and when the diaphragms 10 of a plurality of the speaker units 1U, 1U are disposed near each other, the width Tz of the cabinet 300 in the Z axial direction can be reduced.

The width Tx of the cabinet 300 in the vibration direction (X axial direction) of the voice coil 30 is prescribed by the width of the speaker units 1U, 1U in the vibration direction (X axial direction) of the voice coil 30. More specifically, the width Tx of the cabinet 300 in the vibration direction (X axial direction) of the voice coil 30 is prescribed by the distance between a pair of magnetic circuits 20, 20 provided on the speaker unit 1U. In the speaker unit 1U shown in the drawing, magnetic circuits 20, are disposed outside the diaphragm 10 such that the diaphragms 10 are disposed near each other so as to narrow the width Tz in the Z axial direction of the cabinet 300, and thus the distance between the magnetic circuits 20, 20 can be determined by the size of the diaphragm 10. When a large diaphragm 10 is used, the distance between the magnetic circuits 20, 20 is increased, and a comparatively small diaphragm 10 is used, the distance between the magnetic circuits 20, 20 is decreased. Accordingly, the width Tx in the X axial direction of the cabinet 300 is defined.

Further, in the example of the drawing, the width in the vibration direction (X axial direction) of the voice coil 30 of the spaces S1, S2 formed between the cabinet 300 and the speaker units 1U, 1U is smaller than the width of the speaker units 1U, 1U in the vibration direction (X axial direction) of the voice coil 30.

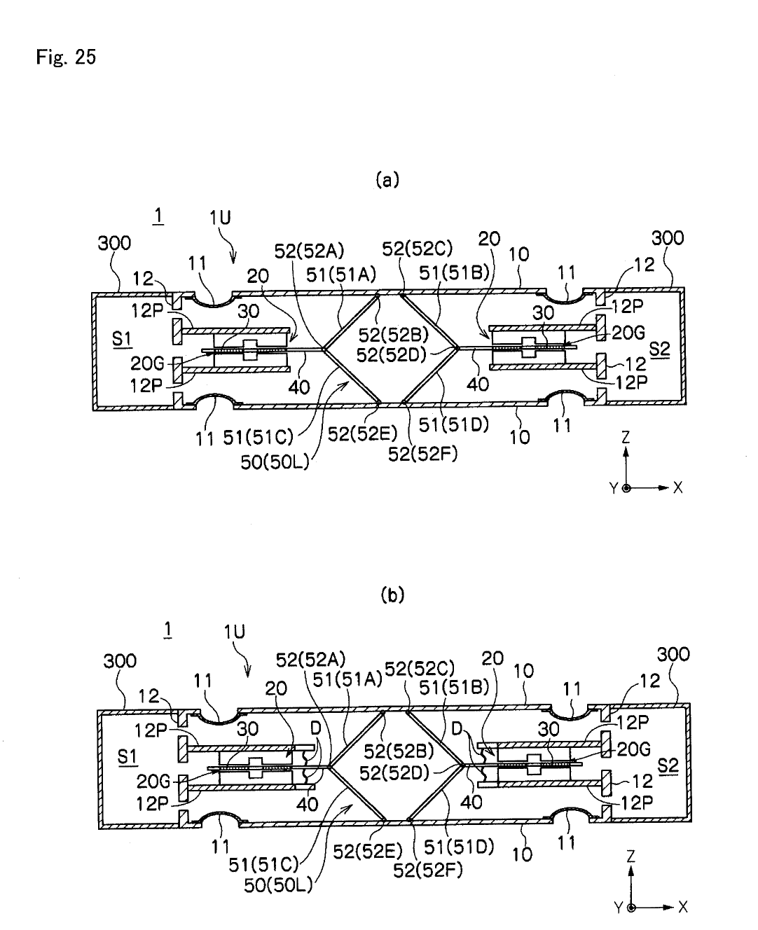

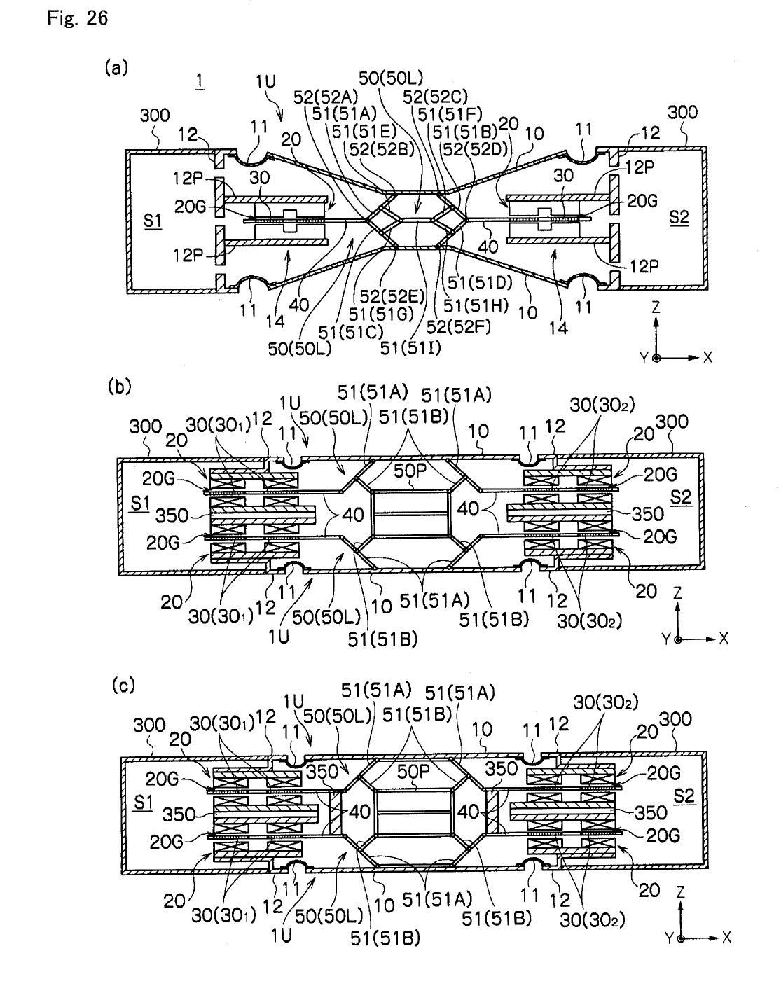

FIGS. 25 and 26 show examples of mounting to the cabinet 300 the speaker unit 1U vibrating a pair of the diaphragms 10, 10 by various types of the link bodies 50L of the vibration direction converter part 50. In the example shown in FIG. 25, the voice coils 30 (30₁,30₂) are vibratably held in the X axial direction and the approaching and distancing vibrations thereof are direction-converted by the vibration direction converter part 50 that forms the link body 50L comprising link parts 51 (51A, 51B, 51C, 51D) and hinge parts 52 (52A, 52B, 52C, 52D, 52E, 52F), and thereby the pair of the diaphragms 10, 10 are driven. The voice coils 30 (30₁,30₂) are disposed in a magnetic gap 20G in the magnetic circuit 20 that is arranged in an attachment unit 12P in a frame 12. And the spaces S1, S2 are formed lateral to the frame 12 in the cabinet 300. In FIG. 25(a), the voice coil 30 is held only by a holding part (not shown), and in FIG. 25(b), the movement of the voice coil is restricted by a damper D in addition to the holding part.

In an example shown in FIG. 26(a), the link part 51 is provided with link parts 51B, 51F, 51G, 51H, 51I in addition to the example shown in FIG. 25(a) and the diaphragm 10 is the same as the example shown in FIG. 25(a) except a recessed shaped central part. The examples shown in FIGS. 26(b), 26(c) are provided with two voice coils 30₁,30₁ vibrating substantially in the same direction and two voice coils 30₂,30₂ vibrating substantially in the same direction, approaching and distancing the two voice coils 30₁,30₁, and the vibration direction converter part 50 is supported on the four corners of a rectangular fixed frame body 50P as a link body comprising a first link part 51A and a second link part 51B. The voice coils 30 (30₁, 30₁, 30₂, 30₂) are disposed in the magnetic gaps 20G of respectively corresponding magnetic circuits 20, and nearly disposed magnetic circuits 20 are connected via the damping materials 350.

In the examples shown in FIGS. 25 and 26, the vibration direction converter parts 50 vibrating a pair of diaphragms 10, 10 are disposed substantially axis symmetrically with respect to the center axis along the vibration direction of the voice coils 30. As such the vibration of the link part 51 in the link body 50L is applied substantially symmetrically with respect to the aforementioned center axis, and thus it is possible that the mutual effects applied on each link part 51 cancel each other out. As such, a resonance phenomenon and so forth caused by the vibration of the vibration direction converter part 50 can be suppressed.

Further, in the examples shown in FIGS. 25 and 26, when the distance between the speaker units 1U, 1U, particularly the distance between the diaphragms 10, 10 is comparatively reduced, the speaker units 1U, 1U can be seen as point sound sources in a frequency range where wavelength is comparatively large (frequency is comparatively low). As such, the speaker device 1 can preferably provide reproduced sound of low-frequency sound range without the output sound pressure characteristic of low frequencies being affected by the baffle board area (a part of area of the cabinet 300 supporting the diaphragms 10, 10 and surrounding he periphery thereof). Further, even when the cabinet 300 becomes relatively small, the speaker device can sufficiently provide reproduced sound of low-frequency sound range.

Further, when the aforementioned mechanical impedance is substantially the same, the reaction forces that are received from the diaphragm 10 and are applied to each link part of the vibration direction converter part 50 cancel each other out.

Further similarly to FIG. 24, the voice coils 30 of the speaker units 1U, 1U may be connected by directly connecting the voice coil supporting parts 40 or may be connected via the damping material 350 as shown in FIG. 26(c). When the connecting portions 60, 60 are connected directly or via other members, the occurrence of unwanted vibration can be prevented and thereby the acoustic characteristic can be improved.

In the aforementioned embodiments according to FIGS. 24 to 26, when the mechanical impedances are substantially the same among the vibration direction converter parts 50, 50, the diaphragms 10, 10, the edges 11, 11, the holding parts 15 (not shown here) and so forth that are provided on each speaker unit 1U, two speaker units 1U can be well-balancedly driven.

For example, the weights of the vibration direction converter parts 50, 50, the diaphragms 10, 10, and the edges 11, 11, the compliance of the holding parts 15, the rigidity and compliance (mechanical compliance) of each link part provided on the vibration direction converter part are preferably substantially the same as each other.

Further, when the mechanical impedances are significantly different, each speaker unit may not be preferably driven, causing unwanted vibrations in the speaker units 1U, 1U.

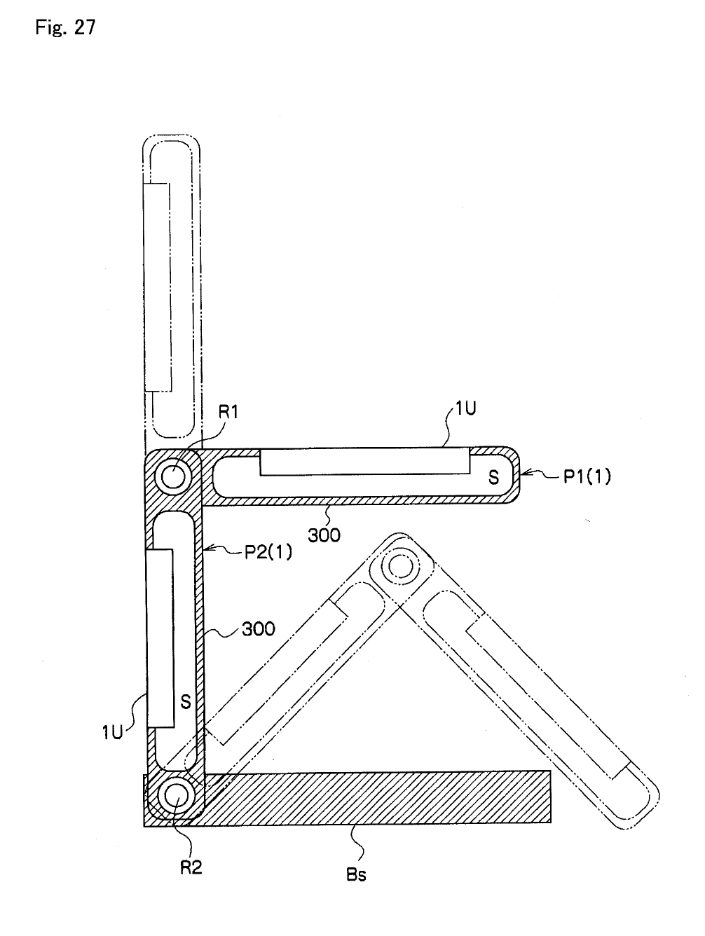

FIG. 27 shows an example of a speaker device 1 including the cabinet 300. In this example, a first panel P1 provided with a first speaker device 1 in which a speaker unit 1U is mounted to a cabinet 300 and a second panel P2 provided with a second speaker device 1 in which a speaker unit 1U is mounted to a cabinet 300 are rotatably connected to each other at each lateral portion. Here, one side lateral portion of the first panel P1 is connected to one side lateral portion of the second panel P2 via a rotation axis R1 and the other lateral portion of the second panel P2 is rotatably connected to the end part of a base board Bs via a rotation axis R2. According to such a speaker device, the angle of the panels P1, P2 is changed depending on use such that the sound emission direction of the speaker unit 1U can face any direction. Since the speaker unit 1U is mounted to the cabinet 300, it is possible to surround the back face sound wave of the speaker unit 1U with the space S in the cabinet 300. Further a mid-high frequency speaker unit may be used in place of either one of the speaker units mounted on the panel P1 and panel P2 and full frequency range reproduced sound can be provided in such a case. When a mid-high frequency speaker unit is mounted on either the panel P1 or the panel P2, the panel P1 and the Panel P2 may be arranged substantially orthogonally to the base board Bs. Such an example can be applied to various types of electronic devices mounting thereon a speaker unit 1U.

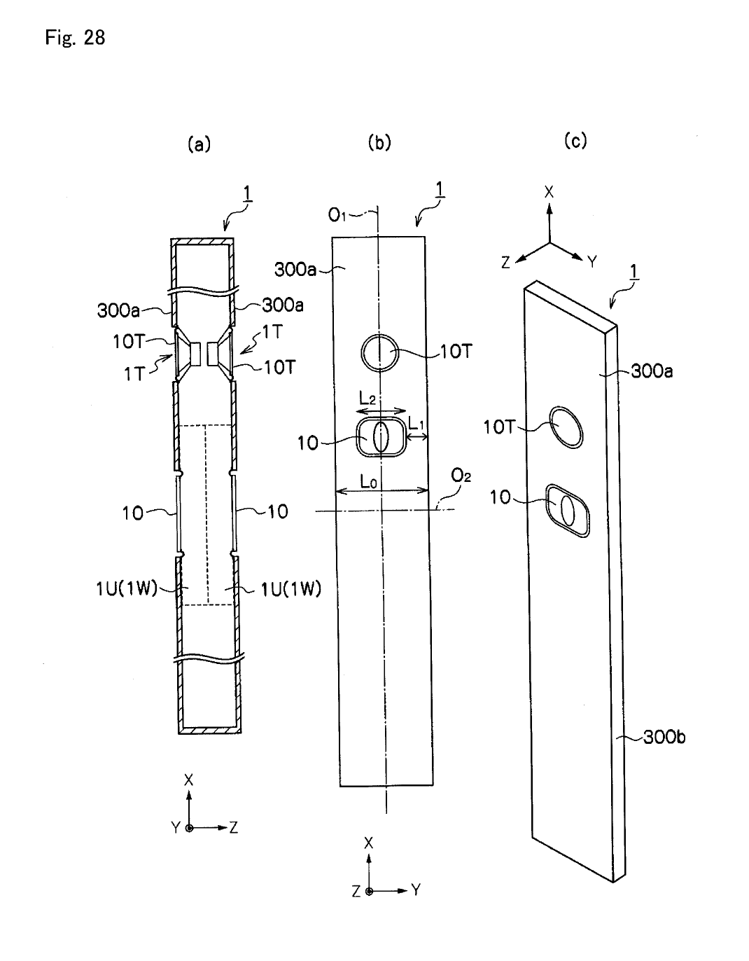

Embodiments according to the present invention are described with reference to FIGS. 28 to 33. FIG. 28 is a view illustrating the entire configuration of a speaker device according to an embodiment of the present invention (FIG. 28(a) is a cross-sectional view, FIG. 28(b) is a plan view, and FIG. 28(c) is a perspective view). The speaker device 1 is provided with a low-frequency reproduction speaker unit 1U (1W), a mid-high frequency reproduction speaker unit 1T, and a cabinet 300 mounted to the speaker units 1U and 1T. The detail of the speaker unit 1U is shown, for example in FIG. 24, 25 or 26 and the duplicated description is not repeated here. The diaphragm 10 of the speaker unit 1U and the diaphragm 10T of the speaker unit 1T are exposed on the face of the sound emission side (front face 300a) of the cabinet 300.

The speaker device 1 is provided with a plurality of mid-high frequency reproduction speaker units 1T in addition to a plurality of low-frequency reproduction speaker units 1U (1W). And, in the example of the drawing, the plurality of low-frequency reproduction speaker units 1U (1W) and the plurality of mid-high frequency reproduction speaker units 1T are oppositely disposed with the sound emission faces facing different directions each other. More specifically, a low-frequency reproduction speaker unit 1U and a mid-high frequency reproduction speaker unit 1T are disposed on one sound emission face, and on another sound emission face different by 180° in direction from the one sound emission face, a low-frequency reproduction speaker unit 1U and a mid-high frequency reproduction speaker unit 1T are disposed.

Further, the cabinet 300 of the speaker device 1 forms prescribed space between the speaker units 1U, 1T and the face on the sound emission side of the cabinet 300 (front face 300a) has a plane shape defined by a long axis O₁ and a short axis O₂. More specifically, the face on the sound emission side of the cabinet 300 (front face 300a) is formed in an elongated rectangular shape with a long axis O₁ and in a box shape with comparatively small depth.

And, in the speaker device 1, the low-frequency reproduction speaker unit 1U and the mid-high frequency reproduction speaker unit 1T disposed on the same sound emission face side are mounted side by side along the long axis O₁ of the cabinet 300, and the distance L₁ between the outer periphery part of the cabinet 300 and the speaker unit 1U in the direction of the short axis O₂ of the cabinet 300 (Y axial direction as shown in the drawing) is formed to be smaller or substantially the same as the width L₂ of the speaker unit 1U in the direction (Y axial direction). That is, the distance L₁ from the speaker unit 1U to the outer periphery part of the cabinet 300 is configured to be comparatively small. When the distance L₁ from the speaker unit 1U to the outer periphery part of the cabinet 300 is configured to be sufficiently small, the width Lₒ of the cabinet 300 in the direction of the short axis O₂ (Y axial direction) becomes substantially the same as the width L₂ of the speaker unit 1U in the direction (Y axial direction).

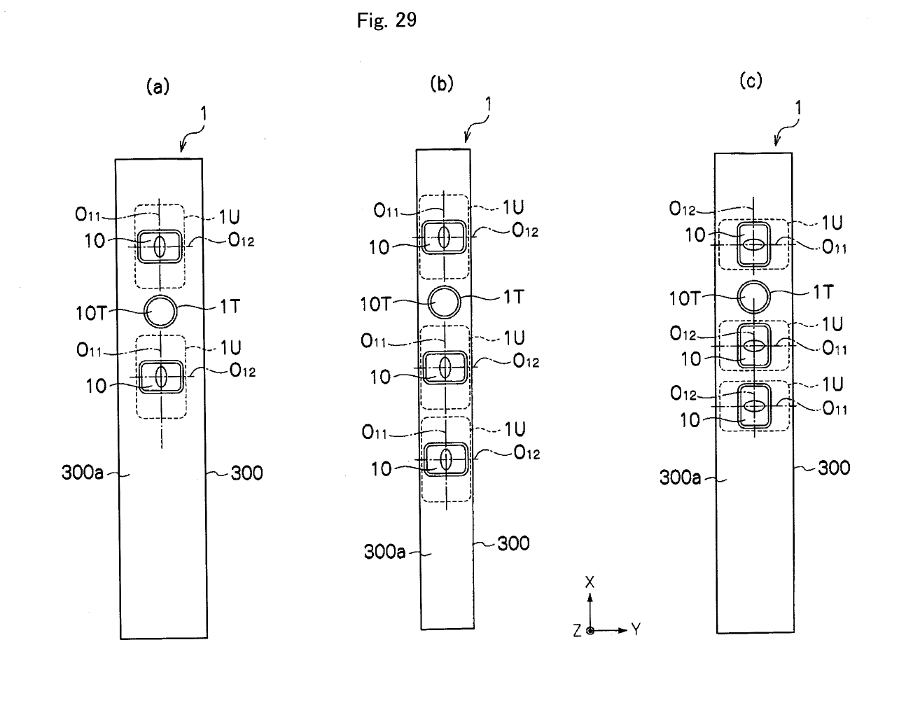

The example shown in FIG. 29 is a variation of the speaker device 1 according to the aforementioned embodiment of the present invention. The same symbols are applied to the parts in common with the aforementioned example and the duplicated description is partially skipped. The basic configuration that a low-frequency reproduction speaker unit 1U and a mid-high frequency reproduction speaker unit 1T are disposed on different sound emission faces respectively is the same as the aforementioned example, however in this example, a plurality of speaker units 1U are disposed on a single sound emission face side.

And, a plurality of low-frequency reproduction speaker units 1U and mid-high frequency reproduction speaker units 1T that are disposed on the same sound emission face side are mounted side by side along the long axis O₁ of the cabinet 300 (along X axial direction), and the mid-high frequency reproduction speaker units 1T is disposed between the plurality of low-frequency reproduction speaker units 1U, 1U . . . . In the example shown in FIG. 29(a), a speaker unit 1T is disposed between two speaker units 1U aligned in the X axial direction. In the example shown in FIGS. 29(b) and 29(c), a single speaker unit 1T is disposed between two speaker units 1U, 1U of three speaker units 1U, 1U, 1U aligned in the X axial direction.

Further, the speaker unit 1U is provided with a plane shape defined by a long axis Oₙ and a short axis O₁₂ (specifically an elongated rectangular shape with the long axis O₁₁). In the examples shown in FIGS. 29(a), 29(b), the speaker unit 1U is mounted on the cabinet 300 such that the short axis of the cabinet 300 (Y axial direction) and the short axis O₁₂ of the speaker unit 1U are substantially in the same direction. In the example shown in FIG. 29(c), the speaker unit 1U is mounted on the cabinet 300 such that the short axis O₁₂ of the cabinet and the long axis of the speaker unit (X axial direction) are substantially in the same direction. Further, in the example shown in FIG. 29(c), the distance between the diaphragms 10, 10 of the adjacently disposed speaker units 1U, 1U is configured to be smaller than the distance between the outer periphery part of the cabinet 300 in the short axis direction of the cabinet 300 (Y axial direction) and the diaphragm 10 of the speaker unit 1U.

Further, in the example of the drawing, the long axis direction of the speaker unit 1U is the vibration direction of the voice coil 30 and is in substantially the same direction as the short axis direction of the diaphragm 10. Further, the short axis direction of the speaker unit 1U is in substantially the same direction of the long axis direction of the diaphragm 10.

Further, the width of the cabinet 300 in the vibration direction of the diaphragm 10 in the speaker device 1 (Z axial direction of the drawing), that is, the width of the lateral face 300b of the cabinet 300 is prescribed by the width of the vibration direction converter part 50 (see FIG. 24) in the vibration direction of the diaphragm 10 which a pair of speaker units 1U mounted to the cabinet 300 includes, that is, by the thickness of the two vibration direction converter parts 50. Specifically, the width of the lateral face 300b of the cabinet 300 is formed substantially equivalent to the thickness of the two vibration direction converter parts 50. Further, the width of the lateral face 300b of the cabinet 300 is formed substantially equivalent to the distance (see FIG. 24) between the two magnetic circuits which the pair of speaker units 1U oppositely disposed on the cabinet 300 includes. Further, the width of the lateral face 300b of the cabinet 300 is formed substantially equivalent to the distance between the two diaphragms 10 the pair of speaker units 1U oppositely disposed on the cabinet 300 includes. The two diaphragms 10, 10 the pair of speaker units 1U oppositely disposed on the cabinet 300 includes are disposed near each other. As such, the width of the lateral face 300b of the cabinet 300 is comparatively reduced. An omnidirectional speaker like the speaker device 1 is prevented from generating directional characteristic by comparatively decreasing the width of the lateral face 300b of the cabinet 300 with the diaphragms 10, 10 being arranged near each other.

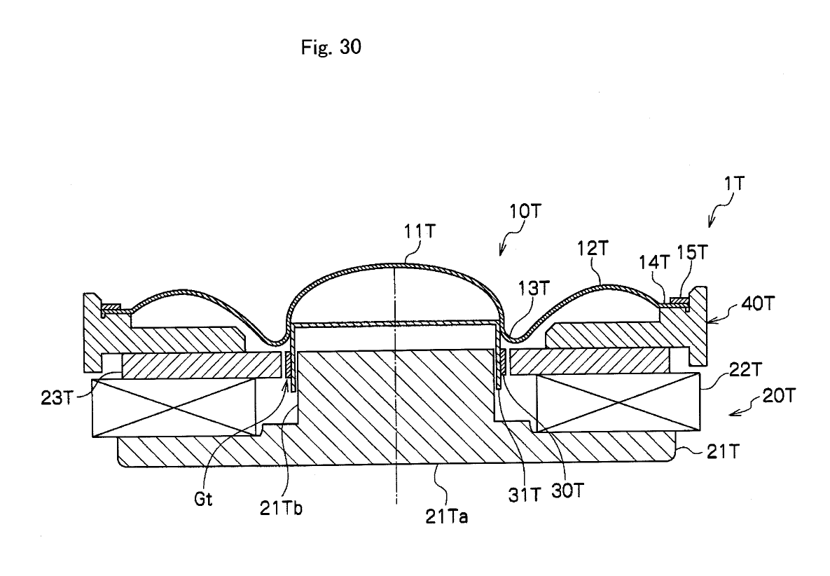

FIG. 30 is a view (cross-sectional view) illustrating an example of a mid-high frequency reproduction speaker unit 1T used for an embodiment of the present invention. The mid-high frequency reproduction speaker unit 1T, using a dome shaped diaphragm is shown here.

The speaker unit 1T is provided with a magnetic circuit 20T, a frame 40T (static part) with the magnetic circuit 20T mounted to the back side, a diaphragm 10T, a cylindrical voice coil supporting part 31T, and a voice coil 30T wound on the voice coil supporting part 31T.

The magnetic circuit 20T is provided with a yoke 21T including a bottom face part 21Ta having a round plane shape and a column shaped center pole 21Tb provided on the bottom face part 21Ta, an annular magnet 22T disposed outside the center pole 21Tb, and an annular plate 23T disposed on the annular magnet 22T. A magnetic gap Gt where the voice coil 30T is disposed is provided between the inner peripheral lateral face of the plate 23T and the outer peripheral lateral face of the center pole 21Tb.

The diaphragm 10T is provided with a dome shaped vibrating part 11T forming a projecting shape in the sound emission direction and an edge part 12T continuously formed from the vibrating part 11T while supporting the vibrating part 11T to the frame. A connecting part 13T is provided between the vibrating part 11T and the edge part 12T. The connecting part 13T supports the voice coil supporting part 31T and is formed in a projecting shape toward the magnetic circuit 20T. The upper end part of the voice coil supporting part 31T is connected to the connecting part 13T with a connecting member, for example, adhesive and so forth. Further, the vibrating part 11T and the edge part 12T may be formed with different members and connected together with a connecting member and so on without being limited to the configuration such that the vibrating part 11T and the edge part 12T are integrally formed. Further, although the voice coil supporting part 31T and the diaphragm 10T are formed with different members, they may be integrally formed without being limited to this configuration.

Although not shown in the drawing, the vibrating part 11T and the voice coil supporting part 31T are formed with different members from each other and the outer periphery part of the vibrating part 11T is mounted to the upper end part of the voice coil supporting part 31T for example with a connecting member, etc. and the inner periphery part of the edge part 12T is mounted to the outer peripheral lateral face of the voice coil supporting part 31T at the position apart from the outer periphery part of the vibrating part 11T, for example with a connecting member and so forth. Further, the vibrating part 11T may be formed in a recessed shape in the sound emission direction. The above-mentioned technology related to a mid-high frequency reproduction speaker unit is disclosed in the Japanese Patent No. 3989856 filed in Japan on Feb. 27, 2003 and the U.S. Pat. No. 7,088,842 filed in the US on Feb. 25, 2004. The present application incorporates what is described in the above patents.

Although the edge part 12T is formed in a projecting shape in the sound emission direction, it may be formed in a recessed shape without being limited to the projecting shape.

Further, valid vibration area may be increased by comparatively increasing the edge part 12T. In this case, the edge part 12T has the same function as the vibration part 11T (function as a diaphragm).

A flange part 14T is formed in the outer periphery part of the edge part 12T and is connected to the outer periphery part of the frame 40T. An outer fringe projection is provided on the outer periphery edge of the flange 14T, and the outer fringe projection is formed on the outer periphery part of the frame 40T. An annular gasket 15T is provided on the flange 14T which is connected to the outer periphery part of the frame 40T.

The aforementioned technology related to a mid-high frequency reproduction speaker unit is described in the Japanese Laid-open patent publication 2005-333276 filed on May 18, 2004, and in the U.S. Pat. No. 7,577,270 filed in the US on May 17, 2005. The present application incorporates what is described in the aforementioned publications. Further, the mid-high frequency reproduction speaker unit 1T is not limited to a speaker unit provided with a dome shaped diaphragm, and may adopt a known speaker unit provided with a cone shaped diaphragm, tabular diaphragm and so forth.

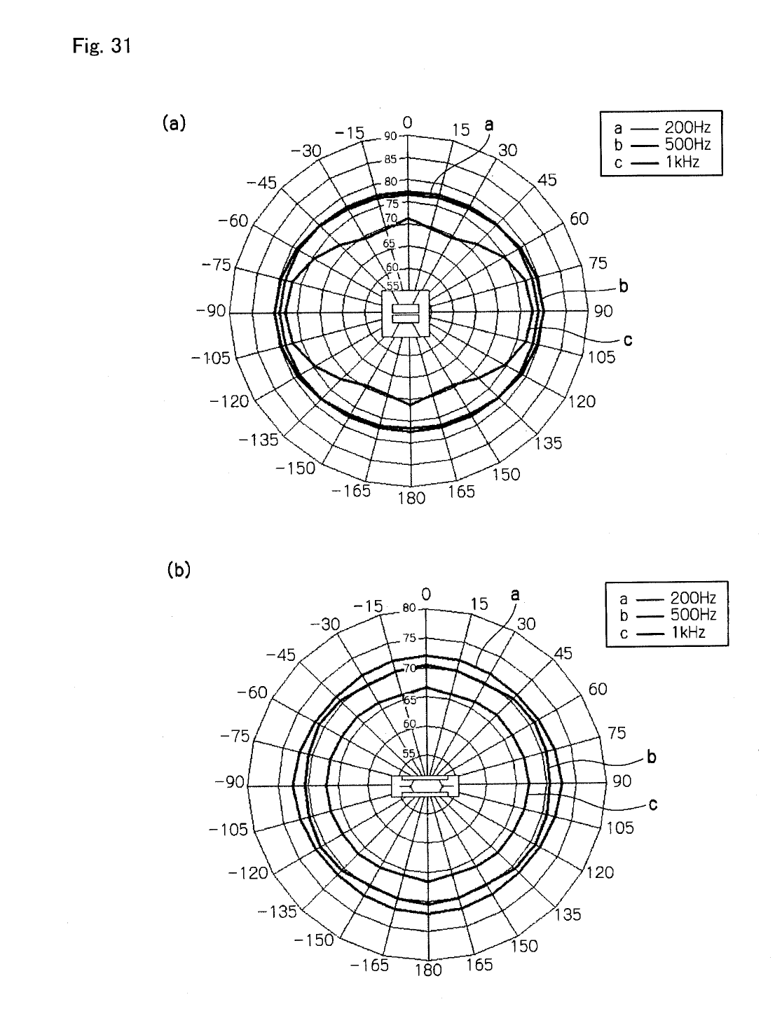

FIG. 31 is a view illustrating the directional characteristic of the speaker device 1. The directional characteristic is obtained by measuring an omnidirectional sound pressure characteristic for each different frequency band (200 Hz, 500 Hz, 1 kHz), defining the front faces of a speaker unit oppositely disposed as 0° or 180° by changing angle from the aforementioned front at a given distance away from the diaphragm of a speaker unit. Further, the vibration directions of the diaphragms which the oppositely arranged speaker units include are opposite each other, and when the diaphragm of one speaker unit vibrates from the inner side to the outer side of the cabinet, the diaphragm of the other speaker unit vibrates from the inner side to the outer side of the cabinet as well.

FIG. 31(a) is a view illustrating the directional characteristic according to a conventional speaker device wherein the vibration direction of a voice coil is the same as the vibration direction of a diaphragm. As can be seen from the directional characteristic, conspicuous directional characteristic occurs due to the phase difference between the sound wave emitted from one speaker unit and the sound wave emitted from the other speaker unit, caused by comparatively large distance between the two diaphragms which the speaker units include. FIG. 31(b) is a view illustrating the directional characteristic in the speaker device 1 according to the present invention. As can be seen from the directional characteristic, the occurrence of conspicuous directional characteristic due to the phase difference between the sound wave emitted from one speaker unit and the sound wave emitted from the other speaker unit is prevented by comparatively small distance between the two diaphragms the speaker units include.

As is apparent from the comparison of the directional characteristic shown in FIGS. 31(a) and 31(b), the sound pressure of the speaker device 1 is substantially the same in all directions particularly in the frequency range of 200 Hz to 1 kHz, and therefore it can be seen that there is no occurrence of conspicuous directional characteristic. As such the speaker device 1 according to an embodiment of the present invention has an acoustic characteristic closely to a so-called point sound source, whereby a listener can enjoy comfortable listening for example in a residential space or in a vehicle compartment regardless of the position.

By comparatively reducing the distance between the two diaphragms 10 which a pair of oppositely disposed speaker units 1U includes, the sound waves emitted from the pair of speaker units 1U interfere with each other, and thereby the problem of conspicuous directional characteristic can be prevented.

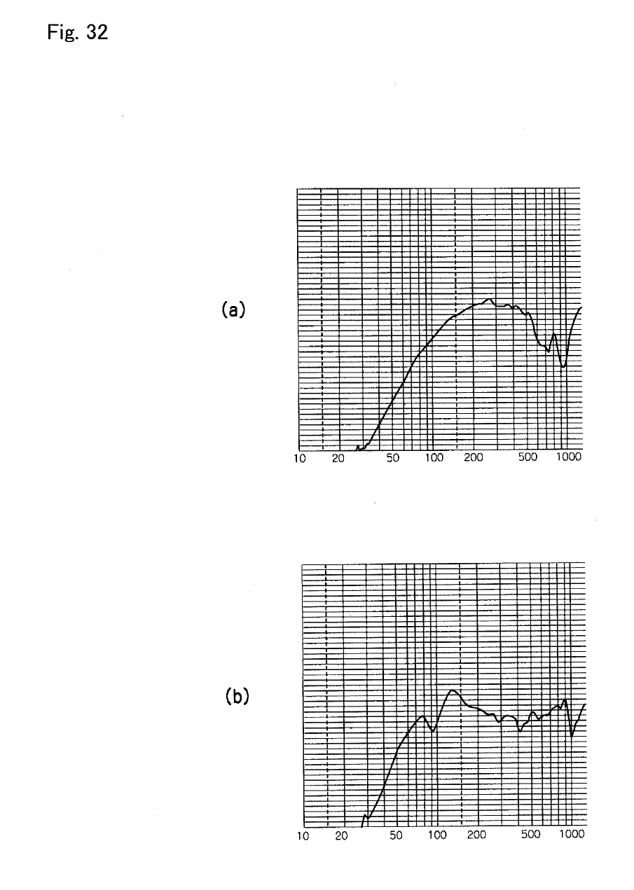

FIG. 32 is a view illustrating the acoustic characteristic (horizontal axis represents frequency (Hz), vertical axis represents sound pressure) of a speaker device 1. FIG. 32(a) is a view illustrating the acoustic characteristic according to a conventional speaker device wherein the vibration direction of a voice coil is the same as the vibration direction of a diaphragm. FIG. 32(b) is a view illustrating the acoustic characteristic of the speaker device 1 according to an embodiment of the present invention. When comparing the two drawings, it can be seen that in the acoustic characteristic of the speaker device 1, the phase difference of sound waves emitted from the two speaker units 1U is 180 degrees and the two phases are opposite each other in a given frequency range, and the interference effect occurs in higher frequencies without being generated in lower frequencies that are main reproduction frequencies of the speaker unit 1U. That is, the comparison between FIGS. 32(a) and 32(b) shows that the speaker device 1 has a preferable acoustic characteristic over a comparatively large frequency range.

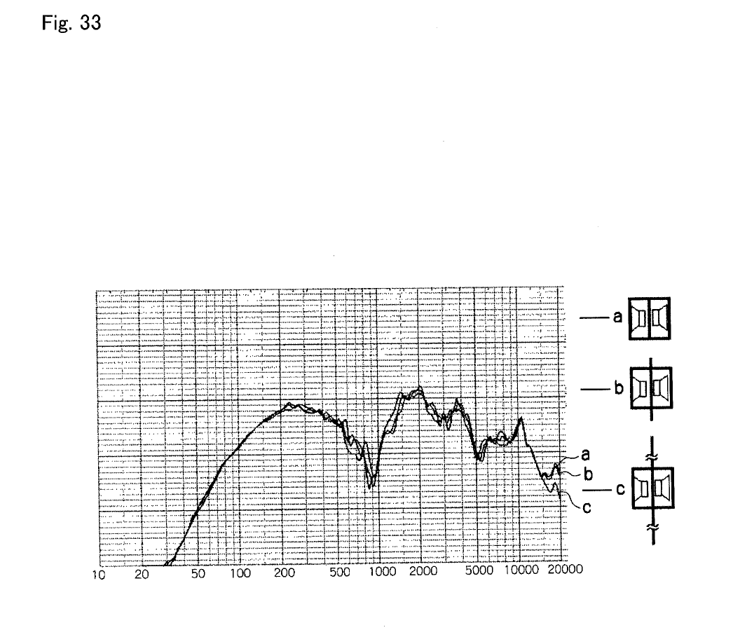

FIG. 33 is a view illustrating the acoustic characteristic of a speaker device when a baffle board is mounted to the cabinet 300 of a speaker device 1 (horizontal axis represents frequency (Hz), vertical axis represents sound pressure). The acoustic characteristic when a baffle board is not mounted to the cabinet 300 (line a) is little different from the acoustic characteristic when a baffle board with comparatively small width is mounted to the cabinet 300 (line b), or a baffle board with comparatively large width is mounted to the cabinet 300 (line c). That is, it can be seen from FIG. 33 that even if the speaker device 1 has no baffle board, preferable acoustic characteristic can be provided. Further, it can be seen that the speaker device 1 can provide substantially the same acoustic characteristic regardless of the size of baffle board (for example, outer diameter, etc.).

Further, it can be seen from FIGS. 32 and 33 that by comparatively reducing the width of the cabinet 300 in the vibration direction of the diaphragm 10 and oppositely disposing a plurality of the speaker unit 1U, the thickness of the speaker device 1 can be reduced, and thus there is no need for a comparatively large baffle board. Thus, the size of the speaker device 1 can be small. Further, it can be seen that the turbulence in a acoustic characteristic can be reduced, for example the occurrence of peak and dip is comparatively suppressed, and thus a preferable acoustic characteristic can be obtained.

FIGS. 28 and 29 show that the cabinet 300 includes a front face 300a having a plane shape defined by a long axis and a short axis, and a plurality of speaker units 1U (1W) that are low-frequency reproduction speaker units and a plurality of speaker units 1T that are mid-high frequency reproduction speaker units are mounted to the front face 300a of the cabinet 300. However, of the speaker units 1U (1W) and the speaker units 1U (1T), one from one units and two or more from the other units, or one from one units and one from the other units may be mounted to the cabinet 300. Although not shown by drawings, a plurality of speaker units 1U (1W) that are low-frequency reproduction speaker units and a plurality of speaker units (1T) that are mid-high frequency reproduction speaker units are disposed side by side in the short axial direction, and such configurations can be arbitrarily changed.

Further, a pair of speaker units 1U (1W) or a pair of speaker units 1U (1T) are oppositely mounted on the two front faces 300a, 300a of the cabinet 300 with the sound emission faces directed outside. The attachment positions of the speaker units 1U (1W), and the speaker units 1T with respect to the cabinet 300 are not limited to the embodiment shown in the drawing. From the viewpoint of the directional characteristic of the speaker unit 1T the attachment position of the speaker unit 1T is preferably adjusted in the proximity of the eye line of a listener or the height of a listener's ears in view of the listener's height in residential space. In particular, when using the speaker unit 1T as shown in FIG. 30, the attachment position of the speaker unit 1T is preferably adjusted in the proximity of the eye line of a listener or the height of a listener's ears in view of the directional characteristic of the speaker unit 1T.

When the speaker unit 1U (1W) is mounted to the cabinet 300 with the long axis of the speaker unit 1U (1W) being substantially in the same direction as the direction of the short axis of the cabinet 300 as shown in FIG. 29(c), the distance between the speaker units 1U, 1U can be comparatively small, whereby the directional characteristic of the cabinet 300 in the long axis direction can be improved.

The attachment positions of the speaker unit 1U (1W) and the speaker unit 1T are adjusted at a given height with respect to the cabinet 300 whereby the space volume in the cabinet 300 is comparatively increased, and thus a desired acoustic characteristic can be obtained.

Further, FIG. 28(c) shows that the speaker units 1U (1W) are adjacently disposed and the distance between the diaphragms 10, 10 of the speaker unit 1U (1W) is smaller than the width of the cabinet 300 in the short axial direction (Y direction). Further, the distance between the diaphragms 10, 10 of the speaker unit 1U (1W) is substantially the same or smaller than the distance between the outer periphery part of the cabinet 300 and the diaphragm 10 of the speaker unit 1U (1W). By nearly disposing the speaker units 1U, 1U, sound pressure can be prevented from comparatively increasing or comparatively decreasing in a given direction whereby the directional characteristic of a speaker device can be improved.

Further, the speaker unit 1T can be arbitrarily disposed between a plurality of the speaker units 1U, 1U . . . . Further, when the speaker unit 1U (1W) is mounted to the cabinet 300 such that the long axis or the short axis of the speaker unit 1U (1W) is in the direction of the long axis of the cabinet 300, since the speaker unit 1U needs space outside the diaphragm 10 in the long axis direction (Oₙ direction), the width of the cabinet 300 in the short axial direction (Y axial direction) of the cabinet 300 can be more narrowed if the long axis O₁₁ is adjusted in the long axis direction (X axial direction) as shown in FIG. 29(b).

Further in FIGS. 29(a) and 29(b), the length of spaces S1, S2 of the cabinet 300 in the vibration direction (X direction) of the voice coil 30 may be formed to be substantially the same as the length of the speaker unit 1U (1W) in the vibration direction (X direction) of the voice coil 30.

Further, in the present invention not limited to the embodiments, the speaker unit 1U constituting the speaker device 1 shown in FIG. 23 may be replaced by the speaker unit constituting the speaker device shown in FIG. 24 by replacing the two speaker units 1U constituting the speaker unit with a single speaker unit, and thus the speaker device 1 may be constituted. Further conventional configurations of cabinet may be arbitrarily adopted without being limited to the configuration of the cabinet 300 shown in FIG. 24.

According to the speaker device 1 including such configurations, the vibration of the voice coil 30 is direction-converted by the vibration direction converter part 50 and is transmitted to the diaphragm 10 whereby increasing the amplitude of vibration of the voice coil 30 has little effect directly on the thickness of the speaker device 1 in the sound emission direction. As such, a loud sound speaker device 1 can be achieved while reducing the thickness of the speaker. Further, the space in the cabinet 300 catches generated sounds with opposite phases, whereby effective sound reproduction can be achieved without reducing the sound generated from the diaphragm 10. Further, a part of the cabinet 300 can strongly support the link body 50L of the vibration direction converter part 50, thereby effectively angle-converting the link part 51 with the reaction force applied from the cabinet 300, and thus the vibration of the voice coil 30 can be efficiently transmitted to the diaphragm 10 while direction-converting the vibration of the voice coil 30.

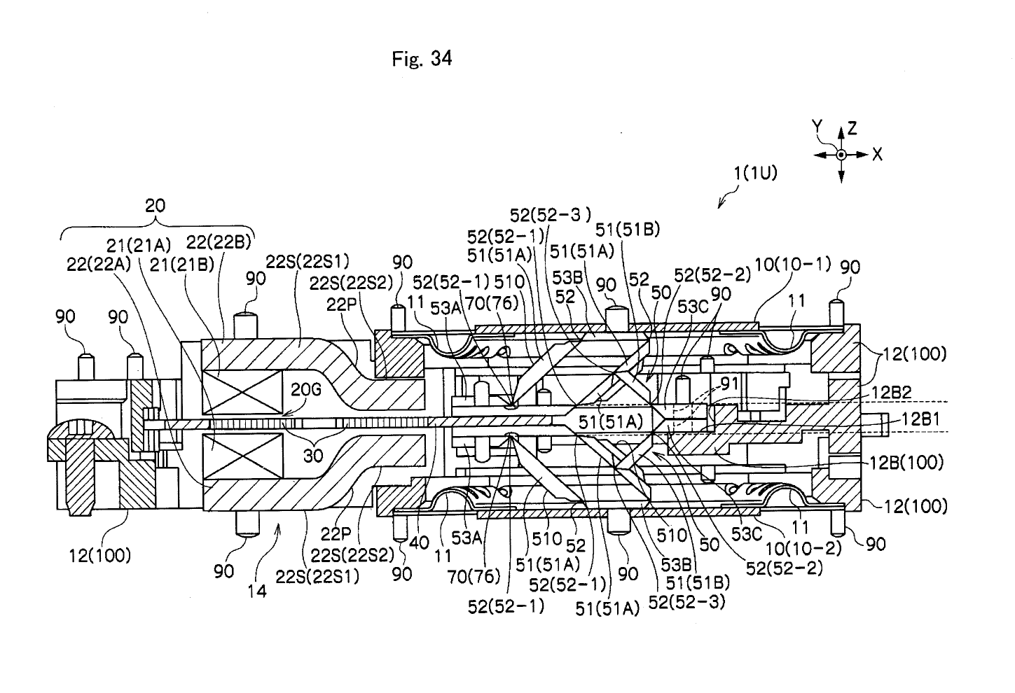

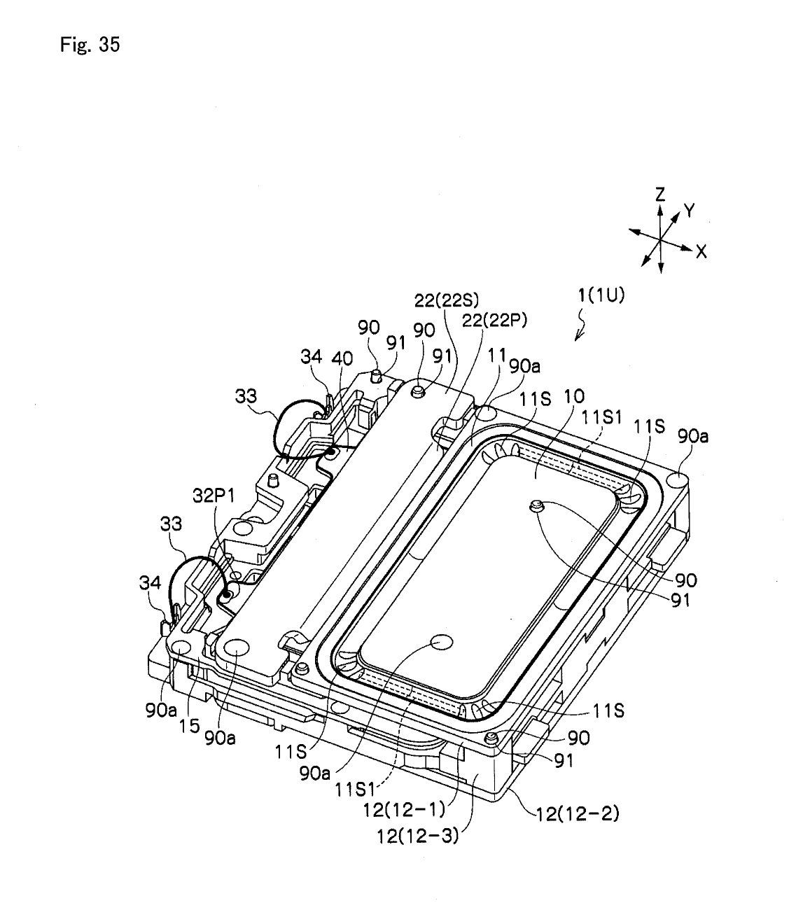

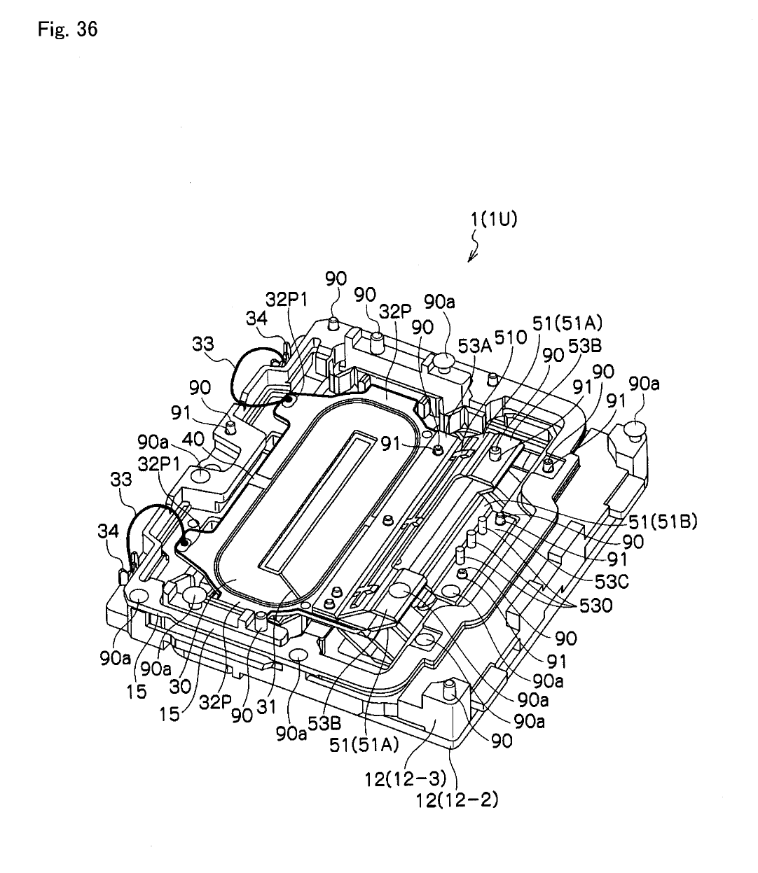

FIGS. 34, 35 and 36 are illustrating a speaker device (or a speaker unit) according to another embodiment of the present invention views (FIG. 34 is an entire cross-sectional view, FIG. 35 is an entire plan perspective view and FIG. 36 is a view illustrating an internal structure). Hereinafter, the same symbols are applied to the parts in common with the previous descriptions and duplicated descriptions are partially omitted.

The speaker device 1 (or speaker unit 1U) according to this embodiment is provided with a pair of the vibration direction converter parts 50 vibratably connecting a pair of the diaphragms 10 and the voice coil 30 similarly to the embodiments shown in FIG. 24 and so forth. Further, in this speaker device 1 (or speaker unit 1U), a pair of the vibration direction converter parts 50 is disposed between a pair of the diaphragms 10, a pair of the vibration direction converter parts 50 connects a pair of the diaphragms such that the pair of the diaphragms synchronously gets near and apart each other, a part of the vibration direction converter part 50 arranged in the proximity of the static part 100 is vibratably supported by the static part 100, a part of the vibration direction converter part 50 arranged in the proximity of the driving part 14 is vibratably supported by the driving part 14, and the pair of the vibration direction converter part 50 is integrally formed, which are similar to the embodiments shown in FIG. 24 and so forth.

Specifically, this speaker device 1 (or speaker unit 1U) is provided with the static part 100, the driving part 14 and the vibrating body. Here, the vibrating body includes a plurality of the diaphragms 10 vibratably supported by the static part 100 and the vibration direction converter part 50 disposed between these diaphragms 10. The vibration direction converter part 50 is provided between a first diaphragm 10-1 and a second diaphragm 10-2 facing each other in a plurality of the diaphragms 10. Further, the vibration direction converter part 50 connects the first diaphragm 10-1 with the second diaphragm 10-2 such that they synchronously get near and apart each other. The driving part 14 vibratably supports a part of the vibration direction converter part 50. In the example shown in the drawing, the driving part 14 is provided with a magnetic circuit 20 having a magnetic gap 20G in a direction different from the vibration direction of the diaphragm 10 (Z axial direction in the drawing) and a voice coil 30 vibrating along the magnetic gap 20G. Without being limited to this configuration the driving part 14 can be configured with any component that can convert an electric signal to a mechanical signal such as an element composed of piezoelectric elements, magnetostrictors, and shape memory metals (artificial muscle).

In the example shown in the drawing, a single driving part 14 is provided, and the single driving part 14 vibrates a pair of the vibration direction converter parts 50, and via the vibration direction converter parts 50 the first diaphragm 10-1 and the second diaphragm 10-2 synchronously vibrate, getting near and apart each other.

The static part 100 is provided with a connecting part 12B connecting the frame 12 and a part of the vibration direction converter part 50. The connecting part 12B is provided with an end part projecting from the frame 12 toward the vibration direction converter part 50. The frame 12 may be configured with a single member or a component connecting a plurality of members. In the example shown in the drawings, the frame 12 is provided with a first frame 12-1 vibratably supporting the first diaphragm 10-1, a second frame 12-2 vibratably supporting the second diaphragm 10-2 and a third frame 12-3 including the connecting part 12B. The connecting part 12B has rigidity in the vibration direction of the diaphragm 10 (Z axial direction in the drawing). Since the connecting part 12B has rigidity in the vibration direction of the diaphragm 10, the reference height of the vibration direction converter part 50 can be maintained constant even when it vibrates. Further, since the connecting part 12B has rigidity in the vibration direction of the diaphragm 10, the vibration of the voice coil 30 in the X axial direction can be efficiently converted to the vibration in the Z axial direction.

The vibration direction converter part 50 is provided with a link part 51 similarly to the aforementioned embodiments. As a link part 51, the vibration direction converter part 50 is provided with a first link part 51A disposed between the voice coil 30 and the diaphragm 10, and a second link part 51B which angle-converts the first link part 51A. The link part 51 may be provided with a reinforcing projecting part (reinforcing part) 510. Further, the vibration direction converter part 50 is provided with a voice coil connecting portion (first connecting portion) 53A, a first hinge part 52-1, a frame connecting portion 53C, and a second hinge 52-2. The voice coil connecting portion (first connecting portion) 53A connects the first link part 51A to the voice coil 30. The first hinge part 52-1 is provided between the first link part 51A and the voice coil connecting portion (first connecting portion) 53A. The frame connecting portion 53C connects the second link part 51B to the connecting part 12B. The second hinge part 52-2 is provided between the second link part 51B and the frame connecting portion 53C. Further, the vibration direction converter part 50 is provided with a third hinge part 52-3 for connecting the middle part of the first link part 51A and the second link part 51B.

The connecting part 12B is connected to the frame connecting portion 53C of the vibration direction converter part 50. In other words, the connecting part 12B is connected to the second link part 51B directly or via other members. Further, the first hinge part 52-1 and the second hinge part 52-2 are disposed substantially at the same height with respect the voice coil 30 (or in the vibration direction of the diaphragm 10 (Z axial direction in the drawing)). By arranging the first hinge part 52-1 and the second hinge part 52-2 substantially at the same height, the vibration of the voice coil 30 in the X axial direction is direction-converted substantially in the vertical direction and thus the diaphragm 10 can be vibrated. Further the pair of the diaphragm 10 can be vibrated without being tilted.

The pair of the vibration direction converter parts 50, 50 oppositely disposed each other in the vibration direction of the diaphragm 10 (Z axial direction in the drawing) are connected to the voice coil 30. At this point, the pair of the voice coil connecting portion 53A, 53A is connected to the voice coil 30. Further, the pair of the vibration direction converter parts 50, 50 is connected to a connecting part 12B. At this point, the pair of the frame connecting portions 53C, 53C is connected to the connecting part 12B of the frame 12. The sum of the thickness of the pair of the voice coil connecting portions 53A, 53A and the thickness of the voice coil 30 in the vibration direction of the diaphragm 10 (Z axial direction in the drawing) is adjusted to be substantially the same as the sum of the thickness of the pair of the frame connecting portions 53C, 53C.

The heights of the aforementioned first hinge part 52-1 and second hinge part 52-2 are adjustable by adjusting the thickness of the frame connecting portions 53C, 53C. In the example of the drawing, each thickness of the frame connecting portions 53C, 53C is adjusted to be larger than each thickness of the voice coil connecting portions 53A, 53A. Instead of adjusting each thickness of the frame connecting portions 53C, 53C as described above, a spacer member may be interposed between the frame connecting portions 53C, 53C. By using the spacer member, it is possible to adjust the sum of the thickness of the frame connecting portions 53C, 53C and the spacer member.

On the lower side of the first hinge part 52-1 of the vibration direction converter part 50, a contact avoiding part 70 is provided by forming a recessed shape on the surface of the voice coil connecting portion 53A similarly to the aforementioned embodiments. By providing such a contact avoiding part 70, the first link part 51A can be prevented from coming into contact with the link part on the lower side in the proximity of the first hinge part 52-1 and making abnormal sound. In the example shown in the drawing, the pair of the vibration direction converter parts 50, 50 is illustrated. Without being limited to such a configuration, a single vibration direction converter part 50 as shown in FIGS. 25 and 26 may be adopted instead of the pair of the vibration direction converter parts 50, 50.

The speaker device 1 (or speaker unit 1U) is provided with an edge 11 for connecting the diaphragm 10 to the static part 200. The edge 11 is formed in an annular plane shape having four corner parts. The edge 11 is provided with a plurality of corner parts, a first part extending in a short axis direction and a second part extending in a long axis direction. Further a part of the edge 11 at the corner parts and in the proximity of the corner parts is provided with a reinforcing part 11S with a cross-sectional shape formed in a projecting shape or in a recessed shape. Further in the edge 11, a reinforcing part 11S1 may be provided in the short axial direction or in the long axial direction. The reinforcing part 11S1 has larger Young's modulus or internal loss than other parts of the edge 11, and is specifically formed by applying emulsion resin to the surface or the inside of the edge 11 or by partially increasing the thickness of the edge. The reinforcing part 11S1 can reinforce the edge 11 in the vibration direction of the voice coil 30 (X axial direction in the drawing). As such, even when the vibration of the voice coil 30 is applied in the X axial direction, the rolling of the diaphragm 10 can be prevented and the diaphragm 10 can be vibrated in the Z axial direction. The reinforcing part 11S1 may be provided only on one side of the first part the edge 11 includes or it may be provided on both sides. Further, by providing the reinforcing part 11S1 in one part of the edge 11, the followability of the edge 11 in response to the vibration of the diaphragm 10 can be improved while maintaining the flexibility of the edge 11. Also, the reinforcing part 11S1 may be annularly provided on the edge 11 as necessary.

A vibration controlling member 530 formed in a projecting shape toward the diaphragm 10 may be provided on the frame connecting portion 53C or the voice coil connecting portion 53A of the vibration direction converter part 50 in the speaker device 1 (or speaker unit 1U). In this example, the vibration controlling member 530 is disposed on the voice coil connecting portion 53A and in the proximity of the second hinge part 52-2. Further, the vibration controlling member 530 is disposed so as to face the link part 51 (51B) connected to the voice coil connecting portion 53A via the second hinge part 52-2. The vibration controlling member 530 generates a sound by having contact with a part of the link part 51B. When the amplitude of vibration of the voice coil 30 is excessively increased, the amplitude of vibration of the link part 51B is excessively increased as well. At the same time, a part of the link part 51B moves toward the vibration controlling member 530. At this point, a part of the link part 51B comes into contact with the vibration controlling member 530. As such, the vibration controlling member 530, when the amplitude of vibration of the link part 51B is excessively increased, generates a sound by coming into contact with a part of the link part 51B, thereby alarming to alert a user the excessive amplitude of vibration. A user can use the speaker device as far as there is no contact sound of the vibration controlling member 530. Also the vibration direction converter part 50 can be prevented from being damaged by the excessive amplitude of vibration of the voice coil 30.

In the example shown in the drawing, the yoke 22 (22A, 22B) of the magnetic circuit 20 includes two flat parts 22S1, 22S2 and a tilted part 22P formed therebetween. A magnet 21 (21A, 21B) is provided between a pair of the flat parts 22S1, 22S2. A magnetic gap 20G is formed between these magnets 21 (21A, 21B). Further, by proving the tilted part 22P, the distance between the pair of the flat parts 2251, 22S2 is narrowed. Another magnetic gap 20G is formed between the pair of the flat parts 22S1, 22S2. The conducting wire of the voice coil 30 is wound around between the two magnetic gaps 20G.

The end part on the inner periphery side and the end part on the outer periphery side of the voice coil 30 are connected to a voice coil lead pattern 32P via a lead wire 31. The end part 32P1 of the voice coil lead pattern 32P is connected to an outside terminal 34 provided outside the frame 12 via a lead wire 33. An extension part is formed in the lead wire 33 so as to allow the vibration of the voice coil 30.

Each component member of the speaker device 1 (or speaker unit 1U) can be connected with a connecting member such as adhesive. Further, each component member can be connected when the speaker device 1 is provided with the configuration described below. A plurality of the component members of the speaker device 1 are connected each other or fixed. A projecting shaped part 90 is provided on one component member of the plurality of component members and a hole part 91 into which the projecting shaped part 90 is inserted is provide on the other component member. The projecting shaped part 90 is inserted into the hole part 91. A part of the projecting shaped part (edge end part) projecting from the hole part 91 melts, thereby forming a flange part 90a. The flange part can prevent the projecting shaped part 90 from falling off the hole part 91.

As shown in FIGS. 16, 17, and 18, one of a first component member 100A and a second component member 100B is provided with a pin 100P for positioning a terminal part 81. Further, a plurality of poisoning pins 100P are disposed in the vibration direction of the voice coil 30. The terminal part 81 is provided with a hole part 81h into which the poisoning pin 100P is inserted. The poisoning pin 100P is formed as a projecting shaped part and a part of the poisoning pin 100P (edge end part) projecting from the hole part 81h may be melted to form a flange part as necessary.

Further, as shown in FIGS. 15, 17, 18 and 20, the mounting unit 16 is provided with a connecting hole part 16d (fitting hole). Further, the second component member 100B (static part) is provided with a fitting projection part that is inserted into the connecting hole part 16d. Further, the first component member 100A (static part) is provided with a hole part into which the fitting projection part is inserted. The fitting projection part is formed as a projecting shaped part and a part of the fitting projection part (edge end part) projecting from the connecting hole part 16d or the hole part of the first component member 100A may be melted to form a flange part as necessary.

FIGS. 34 to 39 are views illustrating the connection structure of each component member of a speaker device 1. Each of the static part 100, the driving part 14 and the diaphragm 10 is composed of one or more component members. The component members are members which compose a part or a whole of the static part 100, the driving part 14 and the diaphragm 10. The static part 100 serves as a frame 12, diaphragm frames 12-1, 12-2 and so on. The driving part 14 serves as of a voice coil 30, a voice coil supporting part 40, and the components of a magnetic circuit 20 (the magnetic circuit 20 can be the static part 100) and so on. The diaphragm 10 serves as a plurality of the diaphragms 10, a plurality of the edges 11, an edge 11 and so on. If the component members are divided into two groups, the voice coil 30, the voice coil supporting part 40, each part of the diaphragms 10, 10, the edge 11, the vibration direction converter part 50 and so forth is a vibration system member, while the frame 12, the diaphragm frames 12-1, 12-2, the magnetic circuit 20 and so forth is a static system member. The plurality of the component members may be disposed with a given distance in a direction crossing the vibration direction of the driving member 14.

As shown in FIGS. 34 to 39, the speaker device 1 is composed of the aforementioned component members which are fixed or connected each other and one component member of the component members which are fixed to each other is provided with a projecting shaped part 90 while the other component member of the component members which are fixed to each other is provided with a hole part 91 into which the projecting shaped part 90 is inserted. And, the projecting shaped part 90 projects in a direction crossing the vibration direction (X axial direction in the drawing) of the driving member 14 (voice coil 30 or voice coil supporting part 40).

As such, the projecting shaped part 90 projects in a direction crossing the vibration direction of the driving member 14. Thus, the projecting shaped part 90 can receive the vibration of the driving member 14 such that the vibration of the driving member 14 has little adverse effect on the fixed state of the component member. Further, the gap between the inner diameter of the hole part 91 and the outer diameter of the projecting shaped part 90 may be substantially removed. By substantially removing the gap, the positional relationship between the component members is determined with comparatively high accuracy. Further, the projecting shaped part 90 can prevent the positional relationship of the component members which are fixed each other from being displaced due to the vibration of the driving member 14. Further, the projecting shaped part 90 may have rigidity (bending rigidity) in the vibration direction of the driving member 14. By the projecting shaped part 90 having the rigidity, the projecting shaped part 90 can prevent the displacement of the positional relationship between the component members which are fixed each other.

The positions where the projecting shaped part 90 and the hole part 91 are disposed are located at the connecting part of a plurality of vibration system members, the connecting part of a plurality of static system members, or the connecting part where the vibration system members and the static system members are connected.

One component member is provided with a fixed face on which the projecting shaped part 90 is provided. The other component member is provided with a fixed face on which the hole part 91 is provided. Each fixed face of one component member and the other component member is extended in the vibration direction (X axial direction in the drawing) of the driving member 14. The speaker device 1 wherein the vibration direction of the driving member 14 and the vibration direction of the diaphragm 10 are different each other is provided with these fixed faces and the projecting shaped part 90 the component member has is inserted into the hole part 91 which the component member has, whereby the fixed state can be stabilized in the vibration direction of the driving member 14. Further, the fixed face of one component member has contact with the fixed face of the other component member, whereby the fixed state can be stabilized in the vibration direction of the diaphragm 10.

Further, as shown in FIG. 36, one component member is provided with a plurality of the projecting shaped parts 90 and the other component member is provided with a plurality of the hole parts 91, wherein at least one of the plurality of the projecting shaped parts 90 is formed in a direction crossing the vibration direction (Z axial direction in the drawing) of the diaphragm 10, projecting in the vibration direction (X axial direction in the drawing) of the driving member 14. As such, the projecting shaped part 90 projects in a direction crossing the vibration direction of the diaphragm 10, whereby the vibration of the diaphragm 10 is received by the projecting shaped part 90 such that the vibration of the diaphragm 10 can be prevented from having an adverse effect on the fixed state of the component members which are fixed each other. In a speaker device 1 where the vibration direction of the driving member 14 and the vibration direction of the diaphragm 10 are different each other, the fixed state of the component members which are fixed each other can be stabilized in both the vibration direction of the driving member 14 and the vibration direction of the diaphragm 10.

Further, as shown in FIG. 36, the other component member is provided with a wall part (for example, wall part 12B1) adjacently disposed to one component member. The projecting shaped part 90 and the wall part are disposed side by side in the vibration direction of the driving member 14 (X axial direction in the drawing). The wall part is provided to control the position of one component member. Particularly when the wall part is disposed in the vibration direction of the driving member 14 while having contact with the projecting shaped part 90, the wall part can control the position of one component member with respect to the other component member. Further, one component member may be provided with the projecting shaped part 90 and the wall part. In this case, the wall part can determine the position of the other component member with respect to one component member.

The projecting shaped part 90 and the hole part 91 may be disposed in the proximity of the actually vibrating part of vibration system members (voice coil 30, voice coil supporting part 40, diaphragm 10, edge 11, vibration direction converter part 50 and so forth). As such, an external force (vibration) due to the actually vibrating part of the component members is directly received by the projecting shaped part 90. Thus, the external force (vibration) can be effectively prevented from having an adverse effect on the fixed state of the plurality of the component members which are fixed each other. The actually vibrating part includes a part of the vibration system member, a part of the static system member supporting the vibration system member and a part of the static system member to which the vibration of the vibration system member is directly transmitted and so forth.

Further, as shown in FIG. 36(d), the projecting shaped part 90 is provided with a column shaped pole part disposed in the hole part 91 and a flange part 90a disposed facing a fixed face (for example fixed face 12B1) which one component member provided with the projecting shaped part 90 has. Further this flange part 90a is extended from the inner side of the hole part 91 toward the outer side. The outer diameter of the flange part 90a is larger than the outer diameter of the hole part 91 in the proximity of the flange part 90a. As such, the pole part can control the position in a direction crossing the direction along the pole part while the flange part 90a can control the position in a direction along the pole part.

The fixed face of the other component member is disposed between the fixed face of one component member and the flange part 90a. Further, a plurality of fixed parts is configured in the vibration direction of the voice coil 30. The fixed face of one component member and the fixed face of the other component member which have contact with each other may be formed substantially flat. As such, the contact state of a plurality of fixed faces which the flange part 90a opposes is maintained. Thus, the component members which are fixed each other can maintain the fixed state in the vibration direction of the driving member 14 and in the vibration direction of the diaphragm 10 with the fixed faces having contact with each other. Particularly, the fixed faces of the component members which are fixed to each other have contact with each other, whereby the component member is prevented from causing any vibration in the vibration direction of the diaphragm 10, thereby enabling to maintain a preferable fixed state. The fixed faces of the component members which are fixed each other are provided with faces in the vibration direction of the voice coil 30. As such, one component member having a fixed face and the other component member having a fixed face can be disposed substantially in parallel in the vibration direction of the voice coil 30. Further, a resin member, an elastic member, a buffer member, adhesive and so forth can be disposed between a plurality of opposing fixed faces as necessary.

In the example shown in the drawing, each of the component members is formed to be comparatively thin in order to reduce the thickness of the speaker device 1. That is, the thickness of the component member in the vibration direction of the diaphragm 10 is smaller than the length in the vibration direction of the voice coil 30. Further, the thickness of the component member in the vibration direction of the diaphragm 10 is smaller than the length in a direction crossing the vibration direction of the diaphragm 10 and the vibration direction of the voice coil 30. As such, a comparatively thin component member is subject to deformation for example such that the cross-sectional shape is deformed into a curved shape. Further, depending on the condition of manufacturing and so forth, a comparatively thin component member may be slightly curved. Further the speaker device 1 shown in the drawing is configured such that each component member is put on top of each other in the vibration direction of the diaphragm 10. As such, if a curved component member is used, it may be difficult to preferably connect the curved component member with other component members. Further, when the curved component member is connected with other component members, a fixing force may be reduced. Further, in the vibration direction of the diaphragm 10, other component members may not be disposed at a desired position. Thus, by using the projecting shaped part 90 and the hole part 91, a component member can be fixed to other component members while keeping the component member substantially in parallel with other component members. Also, a fixing force of the component members which are connected each other can be increased. Further, the relative positional relationship between the component members in the vibration direction of the diaphragm 10 can be adjusted to a desired positional relationship. Particularly, by providing the fixed face around the projecting shaped part 90 or the hole part 91, the connecting portion of the component members which are connected each other can be fixed while maintaining substantially in parallel each other.

Further, the plurality of the component members are accurately fixed at desired positions in the vibration direction of the diaphragm 10. Further, the projecting shaped part 90 has rigidity, whereby the occurrence of positional displacement can be prevented in the vibration direction of the voice coil 30. Further the fixed face provided around the projecting shaped part 90 and the hole part 91 is provided with a face in the vibration direction of the voice coil 30. Further, the fixed face may be provided with a flat face. By using such projecting shaped part 90, hole part 91 and fixed face, the relative positional relationship between the component members can be preferably maintained in the vibration direction of the diaphragm 10 and in the vibration direction of the voice coil 30.

In the example shown in the drawing, the yoke 23A and the diaphragm frames 12-1, 12-2 are disposed side by side in the vibration direction of the voice coil 30 and fixed to the frame 12. The yoke part 22 prescribes the width of the magnetic gap 20G in the vibration direction of the diaphragm 10. The diaphragm frame prescribes the position of the diaphragm 10 in the vibration direction of the diaphragm 10. Further the voice coil 30 is disposed in the prescribed magnetic gap 20G. The voice coil 30 is connected to the diaphragm 10 via the vibration direction converter part 50. In this case, for example when the yoke part 22 and the diaphragm frames 12-1, 12-2 are disposed at a desired position in the vibration direction of the voice coil 30 and in the vibration direction of the diaphragm 10, at least one of the voice coil 30 and the diaphragm 10 can be prevented from being obliquely disposed in the vibration direction of the voice coil 30.

On component member provided with a projecting shaped part 90 is for example formed with resin member. The resin member includes thermoplastic resin which is heat-melted with heating means such as light radiation (infrared ray, etc.), soldering iron and so forth, and hot-melt materials such as solder. The flange part 90a is continuously provided at the end part of the pole part supporting the flange part 90a. The flange part 90a can be formed for example by pressure-welding the pole part with a hot-pressure-welding member. In particular, when component members fixed each other are fixed, the flange part 90a is formed with the end part of the pole part a being hot-melted while the projecting shaped part 90 is inserted into the hole part 91. Further, the flange 90a may be formed by pressure-welding a hot-pressure-welding member including a mold corresponding to the flange part 90a at the end part of the pole part a. As such, the component members 1A1, 1A2 can be fixed and connected each other. In the drawings shown below, the projecting shaped part 90 with the pole part a being projected before heating is shown as “1B (a)” and the projecting shaped part 90 including the flange part 90a formed by hot-melting the end part of the pole part a is shown as “1B(b)”.

The flange part 90a formed with a hot-pressure-welding member including a mold may have contact with the upper face of the component member facing the flange part 90a. Further, the lower face of the flange part 90a may be formed by copying the surface profile of the upper face of the component member. The lower face of the flange part 90a is formed by copying the surface profile of the upper face of the component member, whereby the positional displacement between the component members fixed each other can be prevented in the vibration direction of the driving member 14. Further the vibration between the component members can be prevented.

There are an external heating means and an internal heating means as a means for heating a member to be heated such as the projecting shaped part 90 and so forth. The external heating means is involved in a method of heating with a heat source outside the member to be heated on the basis of heat conduction (transfer of heat).

The internal heating means is involved in a method of generating heat in the member to be heated itself. Further, by increasing the temperature inside the member to be heated the temperature rise of the member not to be heated can be suppressed. Thus, deformation and so forth can be prevented from being generated in the member not to be heated. Further, thin component members 1A may be put on top of each other in the vibration direction of the diaphragm 10 whereby a speaker device 1 is configured. In this case, a plurality of the component members 1A is required to be accurately disposed in the vibration direction of the diaphragm 10. At this point, if one of the component members is deformed by welding heat, the deformation may have an adverse effect on the relative positional relationship between the plurality of the component members 1A. Specifically, the deformed diaphragm 10 (vibration system member) may not be vibrated in a desired vibration direction. Further, the deformed voice coil 30 (vibration system member) may have contact with a yoke described later, causing abnormal sound. Further, the frame 12 may be deformed such that the yoke described later cannot be disposed at a given position. On such an occasion, the contact between the voice coil 30 and the yoke described later may be induced. Thus, by applying the internal heating means, the relative positional relationship between the plurality of component members 1A can be proper.

As specific examples the external heating means includes hot wind welding, hot plate welding, impulse welding, iron welding and so forth. As specific examples the internal heating means includes ultrasonic welding using high frequency dielectric heating method, light welding using concentrated infrared ray or laser beam and so forth.

In particular, the light welding in the internal heating means can heat substantially only a part of the member to be heated. Thus, the deformation can be prevented from being generated in the member to be heated.

A surface treatment can be applied on the surface of the component member facing the flange part 90a. By applying the surface treatment, the adhesion between the flange part 90a and the component member can be strengthened. Further, the flange part 90a and the component member may be integrally formed as necessary at the same time when the flange part 90a is formed. Further, a gap may be formed between the component members fixed each other to the extent that vibration is not generated.

In the example shown in the drawing, a pair of the frame connecting portions 53C, 53C is connected to the connecting part 12B. The frame connecting portion is an example of the aforementioned one component member and the connecting part 12B is an example of the other component member. The connecting part 12B is provided with a fixed face 12B1 fixing the frame connecting portion 53C. The projecting shaped part 90 is provided on the fixed face 12B1 of the connecting part 12B. The frame connecting portion 53C is provided with hole parts 91, 91. The projecting shaped part 90 is inserted into this hole part 91. At this point, a pair of the frame connecting portions 53C, 53C is mounted to the fixed face 12B1 while sandwiching the connecting part 12B. The fixed face 12B1 of the connecting part 12B is formed in a step shape. A wall part 12B2 is provided at the end part of the fixed face 12B1. The wall part 12B2 is disposed opposite the end part of the frame connecting portion 53C. The wall part 12B2 serves as a positioning part with respect to the connecting part 12B. Further, the wall part 12B2 may control the movement of the frame connecting portion 53C in the vibration direction of the voice coil 30.

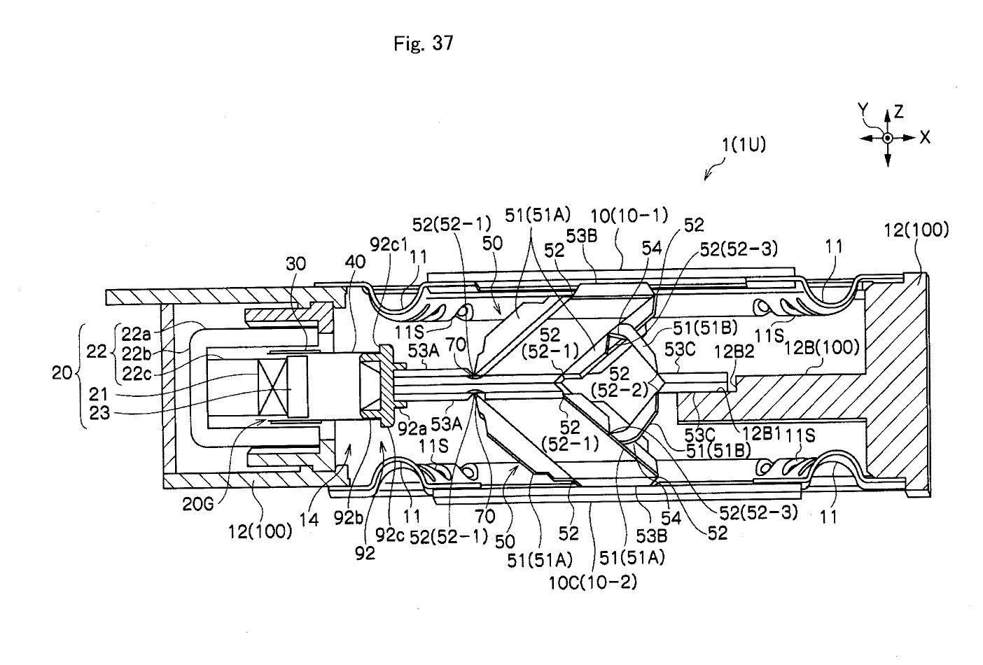

FIG. 37 is a view (an entire cross-sectional view) illustrating a speaker device (or a speaker unit) according to another embodiment of the present invention. The speaker device 1 (or a speaker unit 1U) is a variation of the examples shown in FIGS. 34 to 36 (the same symbols are applied to the same parts in the drawing and the duplicate descriptions are omitted). The speaker device 1 (or a speaker unit 1U) is provided with a voice coil 30 with annular cross-sectional shape (cross-sectional shape crossing the vibration direction of the voice coil 30).

In the example shown in the drawing, the conducting member is supported by the annular voice coil supporting part 40. Further, the voice coil 30 may be configured substantially only with the conducting member and have annular rigidity. The conducting member may be a conducting wire with a start and end points, or a metal member or metal film with a tubular shape and can use conventional materials.

The voice coil 30 may be configured with a single conducting member or a plurality of conducting members. When the voice coil 30 is configured with a plurality of conducting members, for example the voice coil 30 may be configured by winding one conducting wire on the other wound conducting wire (dual voice coil). The voice coil 30 may be provided with the voice coil supporting part 40. The voice coil supporting part 40 may be configured with a conventional resin material. In order to reduce the weight of the voice coil 30, the voice coil supporting part 40 is configured with a tubular resin member and a conducting layer may be formed on the outer peripheral lateral face of the voice coil supporting part 40 as a conducting member. The voice coil supporting part 40 may have rigidity in the vibration direction of the voice coil 30.

The magnetic circuit 20 is provided with a yoke part 22, a magnet 21 and a plate 23 in the example shown in the drawing, and the yoke part 22 includes an outer periphery tubular part 22a, a bottom face part 22b and a pole part 22c. The magnet 21 is magnetically connected to the pole part 22c, a magnetic gap 20G is formed between the outer periphery face of the plate 23 and outer periphery tubular part 22a of the yoke part 22. The yoke part 22 and the pole part 22c may be configured with different members or may be integrally configured. Further, the pole part 22c may be formed as a magnet or the magnet 21 and the pole part 22c may be integrally formed as a magnet The yoke part 22, the magnet 21 and the plate 23 as component members constituting the magnetic circuit 20 are configured with a magnetic body. The magnet 21 may be a rare earth system magnet or a ferrite system magnet and can employ conventional magnetic materials. Further, although a single magnet 21 is shown in the example shown in the drawing, a plurality of magnets can be employed in view of magnetic efficiency and so forth. When a plurality of magnets is used, magnets combining a rare earth system magnet with a ferrite system magnet may be used. The example shown in the drawing is a so-called inner-magnetic type magnetic circuit, however it may be an outer-magnetic type magnetic circuit, a magnetic circuit using both an inner-magnetic type magnetic circuit and an outer-magnetic type magnetic circuit, or a repulsive-type magnetic circuit using a plurality of magnets, thus the embodiment of the magnetic circuit is not limited to the example shown here.

The vibration direction converter part 50 is connected to the voice coil 30 via a rigid tubular connecting part member 92. Specifically, the voice coil connecting portion 53A of the vibration direction converter part 50 is connected to the voice coil 30 or the voice coil supporting part 40 via the tubular connecting part member 92.

The tubular connecting part member 92 is provided with a rigid attachment face part 92c, a first tubular connecting part 92a, and a second tubular connecting part 92b. The rigid attachment face part 92c includes an attachment face 92c1 in a direction crossing the vibration direction of the voice coil 30. The first tubular connecting part 92a is connected to the voice coil connecting portion 53A. Specifically, the inner periphery face of the first tubular connecting part 92a has contact with the outer periphery face of the voice coil connecting portion 53A. Thus, the first tubular connecting part 92a dispose the voice coil connecting portion 53A at a prescribed position with respect to the voice coil 30. The second tubular connecting part 92b is connected to the voice coil 30. Specifically, the outer periphery face of the second tubular connecting part 92b has contact with the inner periphery face of the voice coil supporting part 40. Thus, the second tubular connecting part 92b disposes the voice coil supporting part 40 at a prescribed position with respect to the voice coil connecting portion 53A.

The second link part 51B of the vibration direction converter part 50 includes a curved part 54 in the proximity of a third hinge part 52-3. By providing the curved part 54, the occurrence of abnormal sound caused by the contact between the first link part 51A and the second link part 51B when the direction converter part 50 is vibrated, can be prevented. The curved part 54 is provided with a projecting cross-sectional shape that is formed in a direction from the first link part 51A to the diaphragm 10.

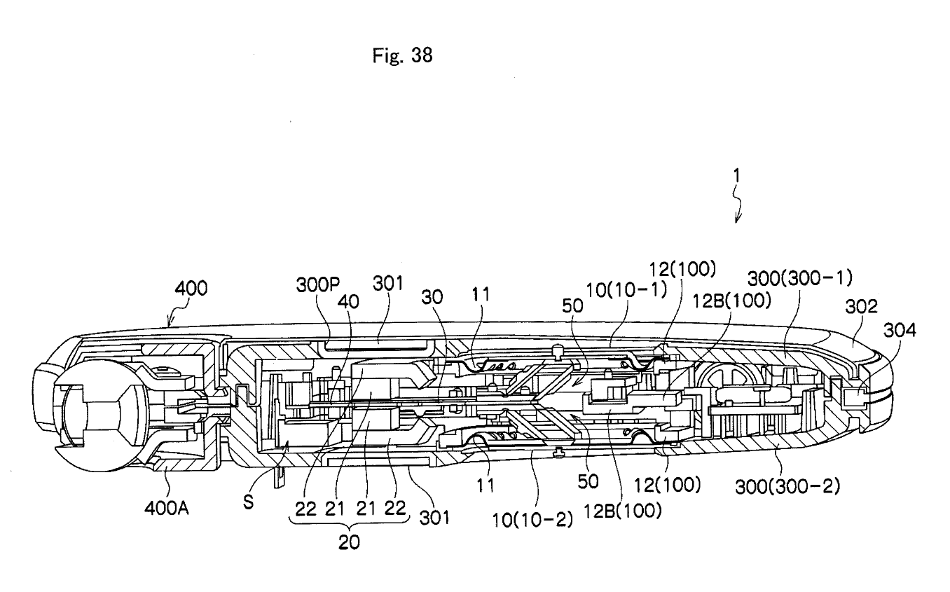

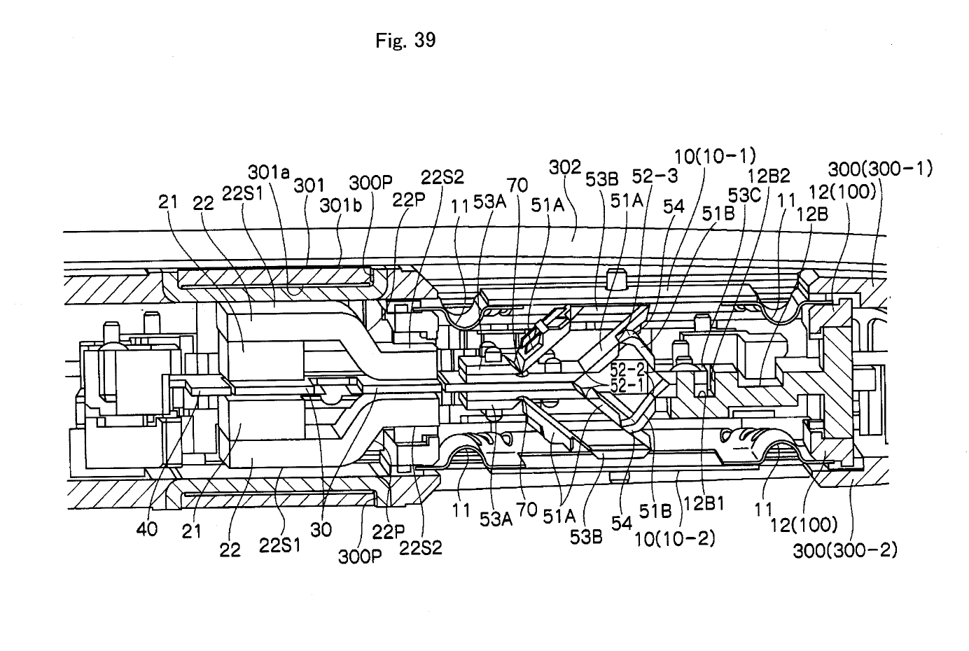

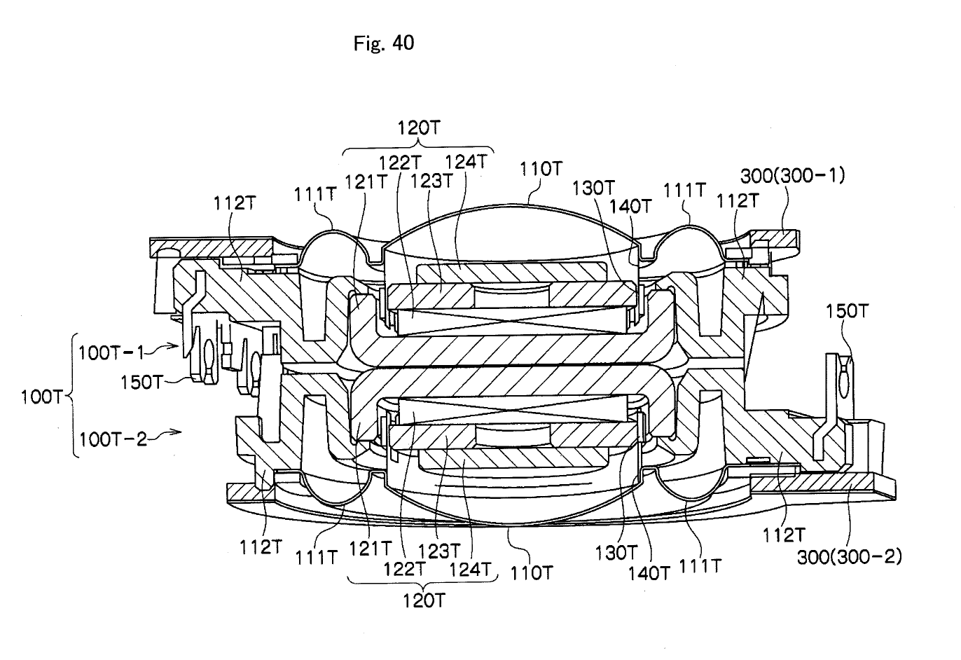

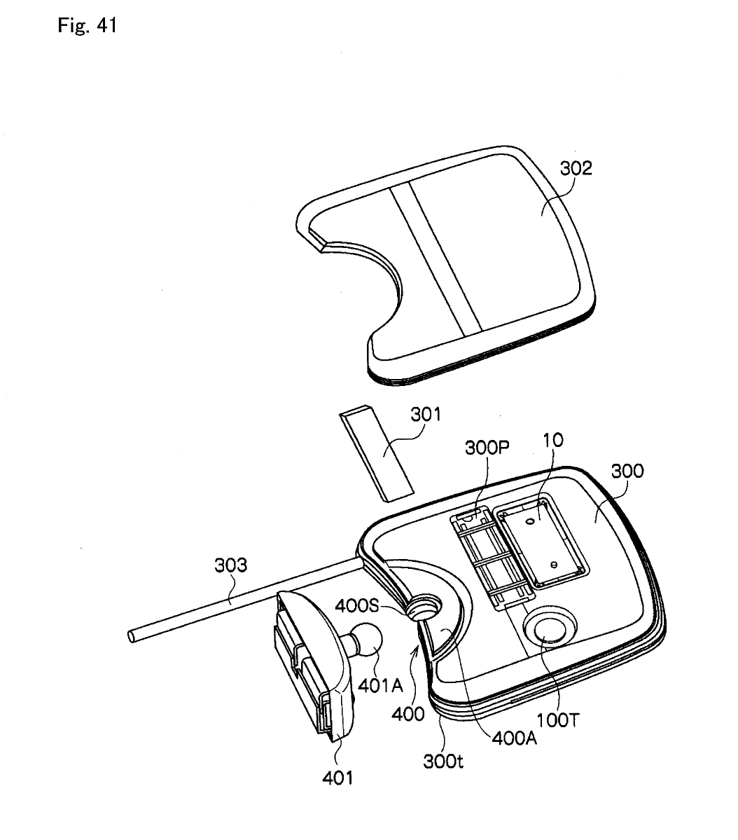

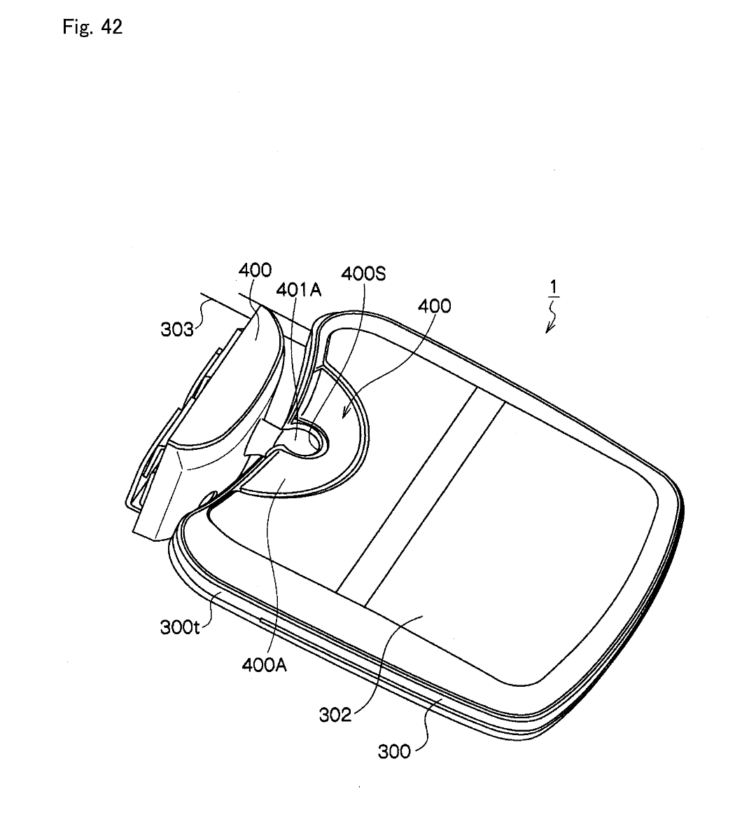

FIGS. 38, 39, 40, 41, and 42 are illustrating a speaker device according to another embodiment of the present invention views (FIG. 38 is an entire cross-sectional view, FIG. 39 is a partially cross-sectional view, FIG. 40 is a cross-sectional view illustrating a configuration example of a mid-high frequency reproduction speaker unit (tweeter), FIG. 41 is a view illustrating the attachment of accessories, and FIG. 42 is an external view). The same symbols are applied to the parts in common with the aforementioned example and the duplicated description is partially skipped.

The speaker device 1 is provided with a cabinet 300. In the space S of the cabinet 300 the speaker unit 1U provided with the aforementioned first diaphragm 10-1 and second diaphragm 10-2 is arranged. By connecting two components 300-1 and 300-2 the cabinet 300 forms therein the sealed space S. A light guide member 304 is disposed at the outer periphery edge of the cabinet 300. When the speaker device 1 is operated and so on, light is introduced from a light source (not shown) that is configured with a self-emitting element such as LED. As such, light can be emitted in the vicinity of the cabinet 300 from the light guide member. Owing to the light the designability of the speaker device 1 can be improved. Also, a user can identify the position of the speaker device 1. Also, the speaker device 1 can be used as a light source.

Further, a cover 302 is mounted to the surface of the cabinet 300. The cover 302 is provided with a plurality of hole parts. The sound wave which the speaker unit 1U emits is sent to the outside through the hole part. The cover 302 is configured with a known member such as a punching net. A tinsel wire 303 is pulled outside the cabinet 300 in order to input an audio signal.

In the space S of the cabinet 300 the magnetic circuit 20 and the diaphragm 10 (the first diaphragm 10-1 and the second diaphragm 10-2) are disposed side by side in the vibration direction of the voice coil 30. That is, the magnetic circuit 20 and the diaphragm 10 are configured not to be overlapped in the vibration direction of the diaphragm 10. In order to achieve a thin speaker device 1, the distance between the two components of the cabinet 300-1 and 300-2 is necessarily reduced, and thus the magnetic circuit 20 is disposed in the proximity of the cabinet 300.

In the speaker device 1 wherein the magnetic circuit 20 is disposed in the proximity of the cabinet 300, when it is driven Joule heat is generated in the voice coil 30. The Joule heat is sent from the magnetic circuit 20 to the cabinet as radiation heat. Thus the radiation heat is transmitted to the cabinet 300 whereby the cabinet 300 may be deformed. In order to solve the above problem the speaker device 1 is provided with a heat dissipation member 301 which is supported by the cabinet 300. The heat dissipation member 301 is configured with a metal member and a high heat conductivity member (for example a metal plate such as aluminum) Further, the heat dissipation member 301 can be configured with a plate shaped member which has a surface 301a facing the magnetic circuit 20 and a surface 301b facing the outside space of the cabinet 300.

The heat dissipation member 301 is disposed in an opening part 300p of the cabinet 300. Further, the heat dissipation member 301 is disposed in the proximity of the magnetic circuit 20. As such, the heat generated from the magnetic circuit 20 when the device is operated is effectively radiated onto the heat dissipation member 301. The heat dissipation member 301 emits the radiated heat outside the cabinet 300. The opening part 300p of the cabinet 300 is covered with the heat dissipation member 301 and thereby the air tightness of the space S of the cabinet 300 is maintained. Further, the cabinet 300 may be provided with a duct sending a sound wave (sound emitting part) while maintaining the air tightness in the connecting portion where the cabinet 300 and the heat dissipation member 301 are connected each other.

The cabinet 300 of the speaker device 1 is provided with a mid-high frequency reproduction speaker unit (tweeter) 100T which has two sound emission faces directed to the first diaphragm 10-1 and the second diaphragm 10-2. The mid-high frequency reproduction speaker unit 100T has a first unit 100T-1 and a second unit 100T-2 which are formed in the same shape and are oppositely disposed each other as shown in FIG. 40. The same audio signal as the speaker unit 1U is inputted into the first unit 100T-1 and the second unit 100T-2 of the mid-high frequency reproduction speaker unit 100T via a high pass filter. Further, the first diaphragm 10-1 (110T) and the second diaphragm 10-2 (110T) the first unit 100T-1 and a second unit 100T-2 include respectively are synchronously vibrated each other.

Basically, the mid-high frequency reproduction speaker unit 100T is configured with a pair of the mid-high frequency reproduction speaker units shown in FIG. 30. Further, the diaphragm (dome type diaphragm shown in the example of the drawing) 110T is vibratably supported by the frame 112T via an edge 111t. Further, the voice coil 130T is connected to the diaphragm 110T directly or via a voice coil supporting part 140T. Further, the voice coil 130T is vibratably disposed in the magnetic gap of the magnetic circuit 120T. According to the example shown in the drawing, the magnetic circuit 120T is composed of a yoke 121T, a magnet 122T, a plate (a first plate 122T) and a sound absorbing member 124T.

Although each frame 112T of the first unit 100T-1 and a second unit 100T-2 in the mid-high frequency reproduction speaker unit 100T is connected each other, each frame 112T may be integrally formed. Further, when each frame 112T of the first unit 100T-1 and a second unit 100T-2 is supported by the cabinet 300 respectively, both frames may be disposed with a gap. When a gap is provided between the frames 112T, 112T, a buffer member may be disposed between the frames 112T, 112T. If the buffer member is disposed, the vibration of the frame 112T, 112T can be reduced.

The speaker device 1 is provided with an attachment part 400 for rotatably mounting the cabinet 300 to an attaching counterpart. The attachment part 400 may be integrally formed with the cabinet 300. Also, the attachment part 400 may be formed with a component member different from the cabinet 300. The attachment part 400 formed with a different component member may be connected outside the cabinet 300.

The attachment part 400 is provided with a rotatable supporting member 401 for rotatably supporting the cabinet 300 at the attaching counterpart while being provided with a receiving part 400A for rotatably receiving the rotatable supporting member 401. The rotatable supporting member 401 is mounted and fits into the receiving part 400A. Specifically, the pivot supporting fitting member 401A of the rotatable supporting member 401 rotatably fits into a fitting member counterpart 400S of the attachment part 400.

The receiving part 400A is formed inwardly from the outer periphery edge of the cabinet 300 and the cabinet 300 has sealed space independently from the receiving part 400A. When the attachment part 400 is integrally formed with the cabinet 300, a wall frame is provided to separate the space S of the cabinet 300 where the speaker unit 1U is provided and the receiving part 400A and block out the flow of air. Further, when the attachment part 400 as a separate unit is connected to the cabinet 300, a connecting part is provided at the outer periphery frame of the cabinet 300 to connect the attachment part 400.

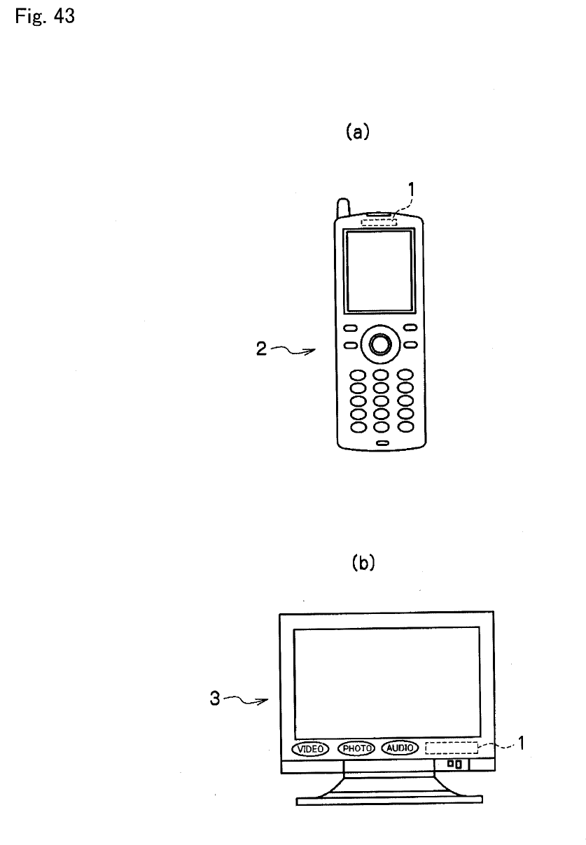

Such a speaker device can be effectively applied to various types of electronic devices and in-car devices. FIG. 43 is a view illustrating electronic devices equipped with a speaker device according to an embodiment of the present invention. In an electronic device 2 such as a portable telephone or a personal digital assistance as shown in FIG. 43(a), or an electronic device 3 such as a flat panel display as shown in FIG. 43(b), even when the speaker device 1 is housed in a cabinet as an attaching counterpart which the electronic device 3 includes, or the speaker device 1 is mounted to the lateral face of the cabinet of an electronic device as an attaching counterpart, the thickness space required for the attachment of the speaker device 1 can be reduced, whereby the total thickness of the electronic device can be reduced. Further, even if the thickness of the electronic device is reduced, a sufficient audio output can be obtained.

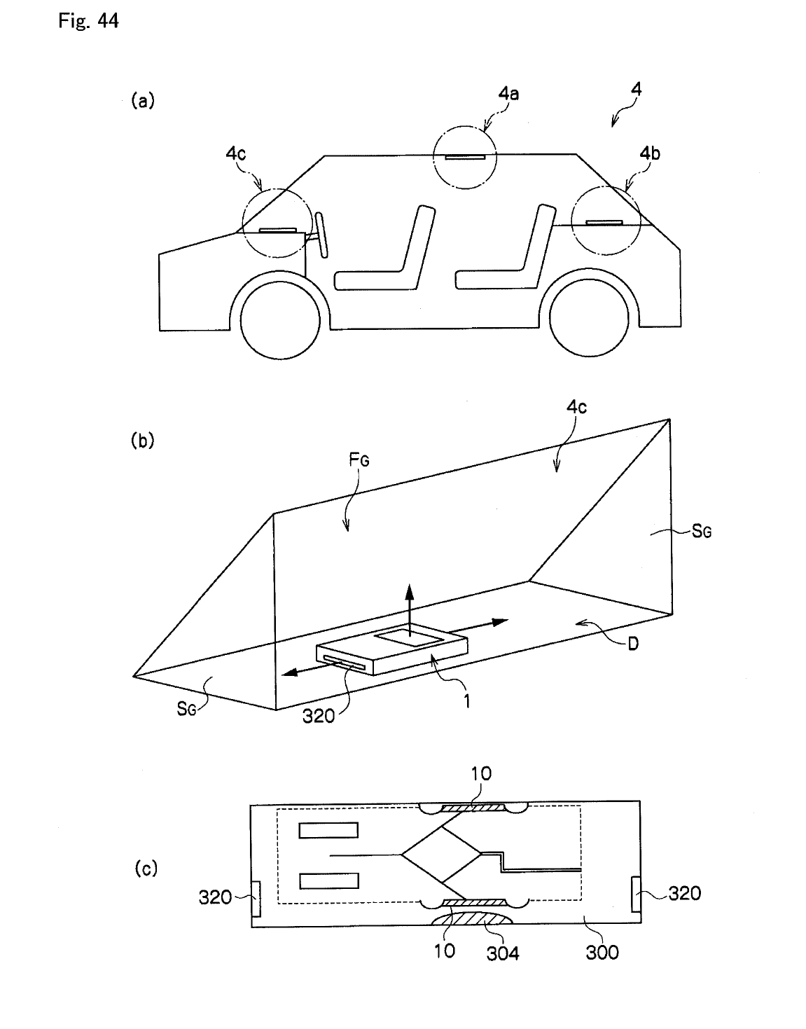

FIG. 44 is a view illustrating a vehicle with a speaker according to an embodiment of the present invention. In a vehicle 4 shown in FIG. 44(a), in-car space can be extended in accordance with the reduction in thickness of the speaker device 1. In particular, even if the speaker device 1 according to an embodiment of the present invention is mounted onto a ceiling 4a, a rear tray 4b, dash board 4c or a door panel as an attaching counterpart, the protrusion into the in-car space can be comparatively reduced, whereby the operation space of a driver or in-car space can be extended. Also, with sufficiently large audio output, one can comfortably enjoy listening to music or radio broadcasts in a vehicle even during noisy high-speed traveling and so forth. When the speaker device 1 is disposed on the upper face D of the dash board 4c in a vehicle as shown in FIG. 44(b), by providing a sound emitting part on the upper face and right and left sides of the speaker device 1, sound is reflected on the side windows S_{G}, S_{G} on both sides of the dash board 4c, a windshield F_{G}, and a rear window B_{G}, whereby effective listening sound can be obtained in a vehicle. Further, in order to efficiently guiding sound wave to the sound emitting parts provided on the right and left sides as shown in FIG. 44(c), an equalizer 304 may be provided on a static part such as the cabinet 300 opposite the diaphragm 10. Further the electronic device such as the embodiment shown in FIG. 27 may be mounted to the attaching counterpart such as the dash board and a desired acoustic field can be formed in a vehicle depending on the number of passengers boarding the vehicle and seat positions in the vehicle. A sound emitting part 320 is provided for the speaker device 1 shown in FIG. 44(c). Without being limited to the above configuration, the sound emitting part 320 may be provided on the side of the windshield S_{G} and on the side opposite the windshield depending on the attachment space of the speaker device 1 and the profile inside the vehicle.

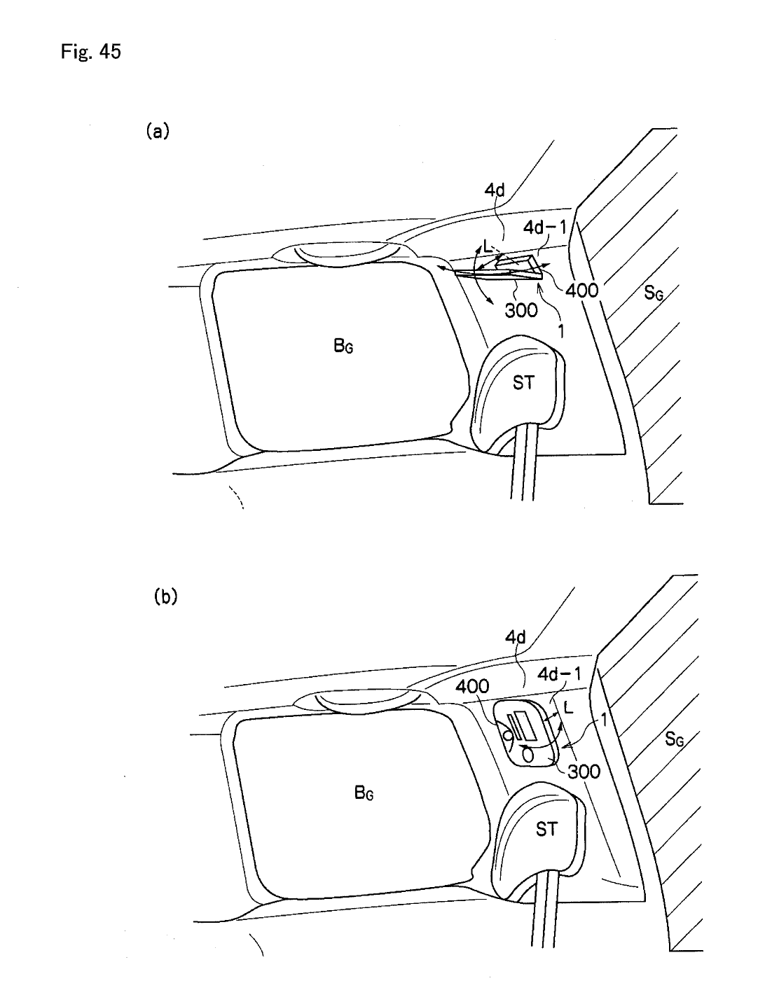

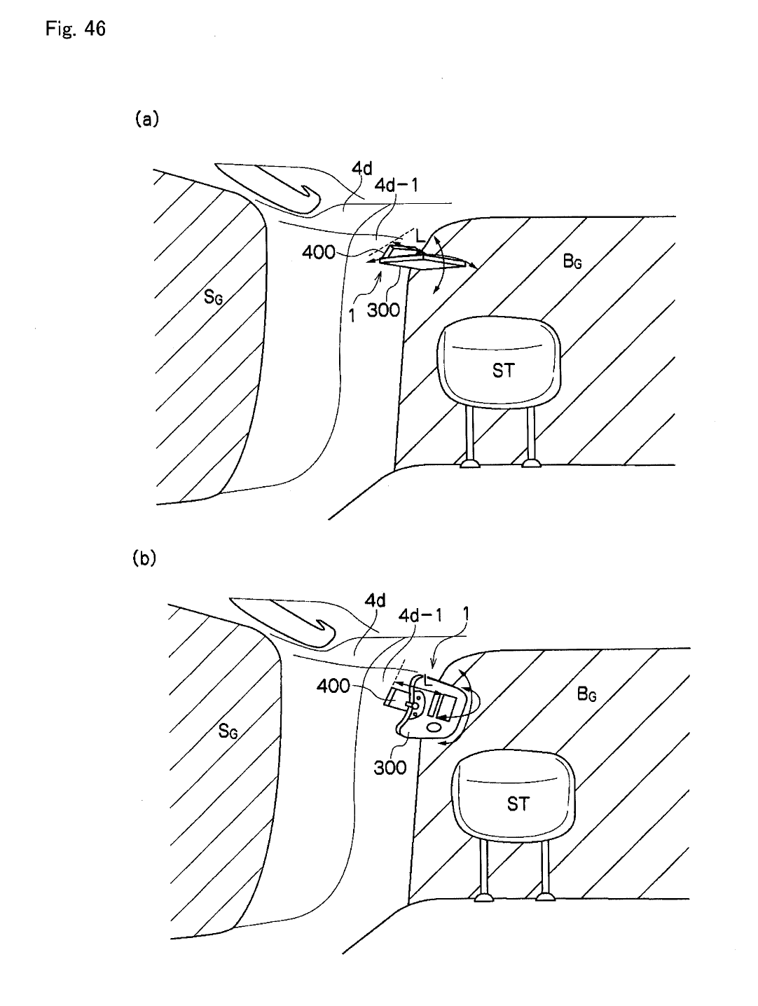

FIGS. 45 to 46 are views illustrating an example of the attachment of a speaker according to an embodiment of the present invention. According to the example shown in the drawing, the attachment part 400 is mounted to the wall part 4d in a vehicle. Further, the speaker device 1 is rotatably supported by the wall part 4d via the attachment part 400. Further, the speaker device 1 can be attached to the wall part 4d to get near or apart from the wall part 4d via the attachment part 400. Specifically, the speaker device 1 shown in FIG. 45(a) is disposed so as to project from the wall part 4d toward a seat (to inner side). The speaker device 1 shown in FIG. 45(b) is disposed in the proximity of the wall part 4d. Particularly, the sound emission face of the speaker device 1 on the side of the wall part 4d faces the wall face 4d-1. At this point a gap of distance L is provided between the sound emission face on the side of the wall part 4d and the wall face 4d-1. The distance L is comparatively small. According to FIGS. 45(a), 45(b), the speaker device 1 is mounted to the wall part 4d while being arranged near a front seat (driver's seat). The speaker device 1 shown in FIG. 46(a) is a view illustrating the speaker device 1 shown in FIG. 45(a) seen from the side of the driver's seat. FIG. 46(b) is a view illustrating an example of the attachment of the speaker device 1 being disposed in the proximity of the wall part 4d similarly to the attachment example of the speaker device 1 shown in FIG. 45(b). According to FIGS. 46(a) and 46(b), the speaker unit 1U is mounted to the wall part 4d while being arranged near the rear window. Further, according to FIGS. 45(a) and 46(a), the speaker device 1 is mounted to the wall part 4d such that the long axis of the speaker unit 1U is directed toward the front seat and the rear seat (ST). Further, according to FIGS. 45(b) and 46(b), the speaker device 1 is mounted to the wall part 4d such that the short axis of the speaker unit 1U is directed toward the front seat and the rear seat.

The speaker device 1 shown in FIGS. 45 and 46 is provided with a plurality of the speaker units 1U and a plurality of the mid-high frequency reproduction speaker units 100T. Further, the plurality of the speaker units 1U and a plurality of the mid-high frequency reproduction speaker units 100T constitute a plurality of the sound emission faces of the speaker device 1. A gap of a given distance L is provided between the sound emission face and the wall face 4d-1 of the wall part 4d disposed in the proximity of the speaker device 1. When the distance L is comparatively large, there may be interference between the sound wave reflected from the wall part 4d and the sound wave the speaker device 1 emits, which may have an adverse effect on the nondirectivity the speaker device 1 presents. Thus, in order to maintain the nondirectivity the speaker device 1 presents, it is desired to comparatively reduce the distance L. In other words, the sound emission face of the speaker device 1 is preferably disposed in the proximity of the wall part 4d.

Further, in the example shown in the drawing, the speaker device 1 is mounted to the wall part 4d via the attachment part 400, however the attachment is not limited to the example. The speaker device 1 may be directly mounted to the wall part 4d. In this case, a part of the speaker device 1 is disposed inside the wall part 4d. Further, the outer periphery part of the speaker device 1 is supported by the wall part 4d. Further, one sound emission face of the speaker device 1 faces the space outside the wall part 4d. Further, the other sound emission face of the speaker device 1 face the space inside the wall part 4d. On such an occasion, the wall part 4d may be provided with a sound guide tube or a duct for guiding the sound wave emitted from the other sound emission face of the speaker device 1 to the space outside the wall part 4d. That is, the wall part 4d may be used as a cabinet shown in FIG. 23.

Further in a resident building, a hotel, an inn or a training facility as a building including a speaker device, when the speaker device 1 is provided on a wall or ceiling as the attaching counterpart, installation space in thickness direction required for the speaker device 1 may be reduced and thus enabling to save space in a room and make effective use of space. The hotel is capable of holding an event and accommodating many guests for conference, meeting, lecture, party, etc. Further, providing a room equipped with audiovisual equipment can be seen in recent years along with prevalence of a projector or a big-screen TV. On the other hand, there is also seen a living room, etc. used as a theater room without room equipped with audiovisual equipment. Also in this case, the living room, etc. can be easily converted to a theater room with the speaker device 1 while making effective use of space in the living room. More particularly, the placement at which the speaker device 1 is arranged may be, for example, ceiling or wall, etc. (attaching counterpart).

Other examples of the application of the speaker device 1 are described hereinafter. The speaker device 1 can be effectively applied to sound reproduction means for announcing to a user operating condition of home appliance such as a refrigerator, washing machine, control panel of water heater in bath room, microwave oven, air conditioner, watch, rice cooker, oil fan heater, etc. It also can be effectively applied to an acoustic generation element for dramatic impact of amusement machine such as a pachinko, slot panel or entertainment device, and a headphone, earphone, hearing aid, music instrument speaker, speaker for amplifying a sound, speaker for studio, speaker for a hall, speaker for karaoke, etc.

Further, the speaker device 1, used in road noise reduction system as shutting off body of shutting off external sound, also can be mounted to the predetermined attaching counterpart such as wall face of roads. Moreover, the speaker device 1 may be effectively used as a vibration generation device and a body sensory actuator (body sonic, etc.).

Although the embodiments according to the present invention are described with reference to the drawings, specific configurations are not limited to these embodiments, and modifications not departing from the subject matter of the present invention are included in the scope of the present invention. Further, the technology of each embodiment described above can be used by each other, unless specific contradictions or problems are found in their objects, the configurations, etc. In addition, PCT/JP2008/051197 filed on Jan. 28, 2008, PCT/JP2008/068580 filed on Oct. 14, 2008, PCT/JP2008/069480 filed on Oct. 27, 2008, PCT/JP2008/069269 filed on Oct. 23, 2008, PCT/JP2009/053752 filed on Feb. 27, 2009, PCT/JP2009/053592 filed on Feb. 26, 2009, PCT/JP2009/050764 filed on Jan. 20, 2009, PCT/JP2009/055533 filed on Mar. 19, 2009, PCT/JP2009/055496 filed on Mar. 19, 2009, PCT/JP2009/055497 filed on Mar. 19, 2009, PCT/JP2009/055498 filed on Mar. 19, 2009, PCT/JP2009/055534 filed on Mar. 19, 2009, PCT/JP2009/055523 filed on Mar. 19, 2009, PCT/JP2009/055524 filed on Mar. 19, 2009, PCT/JP2009/055525 filed on Mar. 19, 2009, PCT/JP2009/055526 filed on Mar. 19, 2009, PCT/JP2009/055527 filed on Mar. 19, 2009, PCT/JP2009/055528 filed on Mar. 19, 2009, PCT/JP2009/62482 filed on Jul. 9, 2009, PCT/JP2009/62483 filed on Jul. 9, 2009, PCT/JP2009/62484 filed on Jul. 9, 2009, PCT/JP2009/62477 filed on Jul. 9, 2009, PCT/JP2009/62478 filed on Jul. 9, 2009, PCT/JP2009/62479 filed on Jul. 9, 2009, PCT/JP2009/62480 filed on Jul. 9, 2009, PCT/JP2009/62481 filed on Jul. 9, 2009, PCT/JP2009/63525 filed on Jul. 29, 2009, PCT/JP2009/63526 filed on Jul. 29, 2009 and PCT/JP2009/63527 filed on Jul. 29, 2009 are incorporated by reference into the present application.

1-46. (canceled)

47. A speaker device comprising a static part, a driving part and a vibrating body, wherein
said vibrating body includes a plurality of diaphragms supported by said static part, and a vibration direction converter part, wherein
said vibration direction converter part is provided between a first diaphragm and a second diaphragm facing each other in the plurality of said diaphragms, and connects said first diaphragm with said second diaphragm such that said first diaphragm and said second diaphragm synchronously move toward and away from each other,
a part of said vibration direction converter part disposed in the proximity of said static part is supported by said static part, and
a part of said vibration direction converter part disposed in the proximity of said driving part is supported by said driving part.

48. The speaker device according to claim 47, wherein
said static part includes a connecting part connecting said frame and a part of said vibration direction converter part,
said connecting part extends in a direction toward said vibration direction converter part from said frame.

49. The speaker device according to claim 48, wherein said connecting part has rigidity in said vibration direction of said diaphragm.

50. The speaker device according to claim 49, wherein said driving part includes a magnetic circuit having a magnetic gap in a direction different from said vibration direction of said diaphragm and a voice coil,
said vibration direction converter part includes a first link part disposed between said voice coil and said diaphragm, and a second link part angle-converting said first link part,
said connecting part is connected to said second link part directly or via other member.

51. The speaker device according to claim 50, wherein said vibration direction converter part includes a voice coil connecting portion connecting said first link part to said voice coil, a first hinge part provided between said first link part and said voice coil connecting portion, a frame connecting portion connecting said second link part to said connecting part, and a second hinge part provided between said second link part and said frame connecting portion
said first hinge part and said second hinge part are disposed substantially at the same height with respect to said voice coil.

52. The speaker device according to claim 51, comprising a pair of said vibration direction converter parts oppositely disposed each other in the vibration direction of said diaphragm, wherein
a pair of said voice coil connecting portions is connected to said voice coil,
a pair of said frame connecting portions is connected to said connecting part of said frame, and
the thickness of the pair of said voice coil connecting portions and the thickness of said voice coil in the vibration direction of said diaphragm are substantially the same as the thickness of the pair of said frame connecting portions.

53. The speaker device according to claim 50, wherein said vibration direction converter part includes a third hinge part connecting said middle part of said first link part and said second link part, and
said second link part includes a curved part in the proximity of said third hinge part.

54. The speaker device according to claim 53, wherein said curved part has a cross-sectional shape projecting in a direction from the first link part toward said diaphragm.

55. The speaker device according to claim 47, comprising a cabinet supporting said static part, wherein
said magnetic circuit and said diaphragm are disposed side by side in the vibration direction of said voice coil, and
said magnetic circuit is disposed in the proximity of said cabinet, and
a heat dissipation member supported by said cabinet is provided, and
said heat dissipation member has a face facing said magnetic circuit and a face facing a space outside said cabinet, and
a connecting portion between said cabinet and said heat dissipation member substantially cuts off the flow of air between a space inside said cabinet and a space outside said cabinet.

56. The speaker device according to claim 55, wherein said heat dissipation member is disposed inside an opening part of said cabinet and is disposed in the proximity of said magnetic circuit.

57. The speaker device according to claim 47, comprising:
a cabinet supporting said static part; and
an attachment part for rotatably mounting said cabinet to an attaching counterpart.

58. The speaker device according to claim 57, wherein said attachment part includes a rotatable supporting member rotatably supporting said cabinet at the attaching counterpart, and
said attachment part includes a receiving part rotatably receiving said rotatable supporting member, and
said rotatable supporting member fits into said receiving part.

59. The speaker device according to claim 58, wherein said receiving part has a shape projecting in a direction toward inside of said cabinet from an outer periphery part of said cabinet, and
said outer periphery part of said cabinet partitions said space inside said cabinet from a space inside said receiving part, and said space inside said cabinet is a sealed space.

60. The speaker device according to claim 47, comprising an edge connecting said diaphragm to said static part, wherein
said edge includes an annular plane shape having four corner parts, and
a part of said edge at said corner part or in the proximity of said corner includes a reinforcing part having a cross-section formed in a projecting shape or in a recessed shape.

61. The speaker device according to claim 51, wherein said frame connecting portion or said voice coil connecting portion includes a vibration controlling member having a projecting shape toward said diaphragm.

62. The speaker device according to claim 47, comprising a cabinet supporting said static part, wherein
said cabinet includes an outer peripheral side face extending in the vibration direction of said diaphragm, and
a sound emitting part having an opening part is provided at said outer peripheral side face of said cabinet.

63. A vehicle wherein the speaker device described in claim 62 is mounted to an attaching counterpart, and
said outer peripheral side face of said cabinet extends in the direction passing through a part of said attaching counterpart, said speaker device is mounted to said attaching counterpart, and
an equalizer is provided at a part of said cabinet in the proximity of said attaching counterpart, and
said equalizer faces said diaphragm disposed on the side of said attaching counterpart.

64. The speaker device according to claim 47, wherein each of said diaphragm, said static part and said driving part is formed with one component member or a plurality of component members for the speaker device,
one component member for the speaker device includes a projecting shaped part, and another component member for the speaker device includes a hole part inserting said projecting shaped part, and
said projecting shaped part projects in a direction crossing the vibration direction of said driving member.

65. An electronic device wherein
said speaker device described in claim 47 is defined as a first speaker device, and
a first panel having said first speaker device and a second panel having a second speaker device are rotatably connected to each other at each lateral portion.

66. The vehicle according to claim 65 wherein said electronic device is mounted to an attaching counterpart.

67. A vehicle wherein said speaker device described in claim 47 is mounted to an attaching counterpart.

68. An electronic device wherein said speaker device described in claim 47 is mounted to an attaching counterpart.

69. A building wherein said speaker device described in claim 47 is mounted to an attaching counterpart.

70. A speaker device comprising a plurality of speaker units, a cabinet mounting said speaker unit, and a space surrounded by said cabinet and said speaker unit, wherein
said speaker unit includes a diaphragm, a static part supporting said diaphragm, and a driving part, and
said driving part includes:
a magnetic circuit having a magnetic gap, and
a voice coil vibrating in the direction different from a vibration direction of said diaphragm, and
a vibration direction convert part, wherein
said vibration direction converter part is connected to said voice coil and said diaphragm directly or via other member,
sound emission faces of said plurality of speaker units face different directions from each other, and
said sound emission faces of said speaker units face the outside.

71. The speaker device according to claim 70, wherein a damping member is disposed between said speaker units.

72. The speaker device according to claim 71, wherein
said vibration direction converter part includes a link body angle-converting a link part between said voice coil and said diaphragm,
said vibration direction converter part includes said link part as a first link part and a second link part as a link body between said first link part and said static part, and
said damping member is mounted to a part of said static part supporting said second link part.

73. The speaker device according to claim 72, wherein
said damping member has the capability of cutting off high frequency vibration in said vibration said voice coil transmits to said diaphragm via said vibration direction converter part.

74. The speaker device according to claim 70, wherein
a face of said cabinet on the sound emission side has a plane shape defined by a long axis and a short axis, and
a distance between an outer periphery part of said cabinet and said speaker unit in the direction of said short axis is smaller or substantially the same as the width of said speaker unit in the direction of said short axis.

75. The speaker device according to claim 71, comprising said speaker unit as a low-frequency reproduction speaker unit, and
a plurality of said low-frequency reproduction speaker units and a plurality of mid-high frequency reproduction speaker units mounted at an outer periphery face of said cabinet, wherein
said plurality of mid-high frequency reproduction speaker units are oppositely disposed with said sound emission faces facing different directions each other, and
said low-frequency reproduction speaker unit and said mid-high frequency reproduction speaker unit disposed on the same sound emission face side are mounted side by side along the long axis of said cabinet.

76. The speaker device according to claim 70, comprising a pair of said diaphragms and a pair of said vibration direction converter parts, wherein
said pair of said vibration direction converter parts is connected to said pair of diaphragm and said pair of voice coil,
said pair of vibration direction converter parts are disposed between said pair of diaphragms,
said pair of vibration direction converter parts connects said diaphragms such that said pair of said diaphragms synchronously moving toward and away from each other,
a part of said vibration direction converter part disposed in the proximity of said static part is supported by said static part, and
a part of said vibration direction converter part disposed in the proximity of said driving part is supported by said driving part.

77. A building wherein said speaker device described in claim 70 is mounted to an attaching counterpart.
